(19) United States
(12) Patent Application Publication
(10) Pub. No.: US 2026/0283144 A1
(43) Pub. Date: Sep. 24, 2026

(54) METHODS AND MATERIALS FOR ORGAN PERFUSION

(71) Applicant: Mayo Foundation for Medical Education and Research, Rochester, MN (US)

(72) Inventors: Ieng Lam Lei, Rochester, MN (US); Paul C. Tang, Rochester, MN (US)

(21) Appl. No.: 19/571,029

(22) Filed: Mar. 18, 2026

Related U.S. Application Data
(60) Provisional application No. 63/774,487, filed on Mar. 19, 2025.

(51) Int. Cl. A01N 1/126

(52) U.S. Cl. CPC A01N 1/126

(57) ABSTRACT

This document relates to methods and materials for a method for extending the viable preservation of a donor organ, comprising perfusing a donor organ with a first solution comprising one or more of a mineralocorticoid receptor antagonist (MRA) and a Brd4-targeting compound; and perfusing the donor organ with a second solution for an amount of time prior to transplant to a recipient subject.

### CROSS-REFERENCE TO RELATED APPLICATIONS

This application claims the benefit of U.S. Provisional Application Serial No. 63/774,487, filed Mar. 19, 2025. The disclosure of the prior application is considered part of (and is incorporated by reference in) the disclosure of this application.

### STATEMENT REGARDING FEDERAL FUNDING

This invention was made with government support under HL164416 and HL166140 awarded by the National Institutes of Health. The government has certain rights in the invention.

### TECHNICAL FIELD

This document relates to methods and materials to support tissue viability during organ perfusion. For example, this document relates to materials for compositions used to decrease tissue damage in a donor organ and methods for performing donor organ perfusion with the compositions.

### BACKGROUND INFORMATION

Organ transplantation is a widely utilized therapy for end-stage organ failure. The availability of donor organs is limited, and post-transplant complications such as primary graft dysfunction (PGD) or delayed graft function (DGF) occur at varying frequencies depending on the organ. These complications are associated with increased morbidity, including, for example, organ failure, organ injury, and mortality. These complications are influenced by the conditions under which donor organs are preserved prior to transplantation. Cold static preservation has a defined time threshold, while cold perfusion can extend the duration that an organ remains viable.

### SUMMARY

Organ transplantation is a widely utilized therapy for end-stage organ failure. For example, heart failure affects about 6.5 million adults in the United States and constitutes a significant health challenge. Heart transplantation is a widely used and effective treatment for end-stage heart failure however the demand for donor hearts far exceeds supply. Donor hearts are under-utilized with less than 50% of potential donors becoming actual heart donors. Inefficient use of this life-saving resource is contributed by the time limit (e.g., four hours) for cold static preservation where the heart is mechanically arrested but still experiences ischemia. This also limits the geographic allocation of hearts due to logistical constraints. Prolonged preservation periods increase the risk for PGD where donor heart function is insufficient for end-organ perfusion. PGD occurs in about 10-20% of heart transplants. Availability can be further limited by the age of the organ donor. Older donor organs (e.g., hearts) are associated with a higher incidence of PGD, and hearts from donors older than 55 years old are often not transplanted.

Organ preservation techniques aim to maintain tissue viability while transporting donor organs to transplant recipients. Warm blood perfusion, also known as ex-vivo normothermic perfusion, can extend the preservation window to approximately 8-9 hours before significant tissue damage occurs. This method involves continuously circulating oxygenated blood through the organ, mimicking physiological conditions to reduce ischemic injury. While effective at maintaining organ function, warm blood perfusion is labor-intensive, requires specialized expertise, and demands constant monitoring. The need for skilled personnel and continuous intervention increases logistical challenges, particularly when transporting organs over long distances. These constraints contribute to limitations in organ availability and exacerbate the existing shortage of transplantable organs.

Cold perfusion, by contrast, is a widely used and cost-effective preservation method that requires less expertise during monitoring. Cold perfusion involves submerging the organ in a hypothermic preservation solution, slowing metabolic activity to reduce oxygen demand and tissue degradation. However, the duration of preservation is limited, as prolonged exposure to cold conditions can still result in cellular injury and ischemia-reperfusion damage upon transplantation.

Damage to donor organs can occur due to preservation periods. For example, mineralocorticoid receptor (MR) phase separation can exacerbate injury to a donor organ during cold preservation (e.g., cold perfusion). This process may contribute to cellular stress, oxidative damage, and endothelial dysfunction, which can compromise graft viability. MR activation during cold storage can promote inflammation and fibrosis, further reducing the organ's ability to recover post-transplantation. Mineralocorticoid receptor antagonists (MRA), such as spironolactone (e.g., canrenone), eplerenone, finerenone, esaxerenone, and balcinrenone, can mitigate these effects. For example, MRAs can stabilize membrane integrity, reduce inflammatory signaling, and improve overall preservation quality, potentially enhancing post-transplant outcomes. In some embodiments, an MRA can be added to a and perfused through the donor organ before transport to the recipient hospital for transplant.

Additionally, Brd4 phase separation can influence transcriptional activity during cold preservation (e.g., cold perfusion), potentially altering chromatin accessibility and gene expression in ways that affect organ viability. This can contribute to cellular stress, impaired recovery, and reduced ischemic tolerance, which can compromise graft function post-transplantation. Pharmacological modulation of Brd4 with Brd4-targeting compounds such as inhibitors JQ1, apabetalone, and AZD5153, or Brd4 degraders like ARV-825 and RNK05047, can regulate these effects. For example, Brd4-targeting compounds can influence chromatin organization, reduce transcriptional dysregulation, and improve overall preservation quality, enhancing post-transplant outcomes. In some embodiments, a Brd4-targeting compound can be incorporated into a solution and perfused through the donor organ prior to transport to a recipient hospital for transplant.

Disclosed herein are compositions that can be added to preservation solutions (e.g., perfusate) to extend the preservation time, mitigate tissue damage, and increase the viability of donor organs for transplantation and methods of perfusion of a donor organ using the composition. By enhancing the protective effects of cold perfusion, the composition and methods disclosed herein can increase organ utilization, improve transplant outcomes, and reduce the strain on transplant logistics.

In one implementation, a method for extending the viable preservation of a donor organ, comprises perfusing a donor organ with a first solution comprising one or more of a mineralocorticoid receptor antagonist (MRA) and a Brd4-targeting compound; perfusing the donor organ with a second solution for an amount of time prior to transplant to a recipient subject. In some embodiments, the donor organ is one or more of a heart, a lung, a liver, a pancreas, a kidney, an intestine, an artery, a vein, or composite tissue. In some embodiments, the donor organ is a heart. In some embodiments, the MRA is one or more of spironolactone, canrenone, eplerenone, finerenone, esaxerenone, and balcinrenone. In some embodiments, the MRA is canrenone. In some embodiments, the Brd4-targeting compound is one or more of JQ1, apabetalone, AZD5153, ARV-825, and RNK05047. In some embodiments, the Brd4-targeting compound is JQ1. In some embodiments, the first solution comprises HTK perfusate and the one or more MRA and the Brd4-targeting compound. In some embodiments, the second solution comprises HTK perfusate. In some embodiments, the amount of time is about 0.5-48 hours.

In another implementation, a method of preserving a donor organ, comprises combining one or more of a mineralocorticoid receptor antagonist (MRA) and a Brd4-targeting compound with HTK solution to generate a first solution; perfusing the donor organ with the first solution using cold perfusion techniques at a temperature of about 2° C. to about 15° C.; perfusing the donor organ with a second solution, wherein the donor organ is continuously perfused with the second solution for an amount of time prior to transplant to a recipient subject; and preparing the donor organ for transplantation to the recipient subject. In some embodiments, the donor organ is one or more of a heart, a lung, a liver, a pancreas, a kidney, an intestine, an artery, a vein, or composite tissue. In some embodiments, the donor organ is a heart. In some embodiments, the MRA is one or more of spironolactone, canrenone, eplerenone, finerenone, esaxerenone, and balcinrenone. In some embodiments, the MRA is canrenone. In some embodiments, the Brd4-targeting compound is one or more of JQ1, apabetalone, AZD5153, ARV-825 and RNK05047. In some embodiments, the Brd4-targeting compound is JQ1. In some embodiments, the second solution is HTK perfusate. In some embodiments, the amount of time is about 0.5-48 hours. In some embodiments, the one or more MRA and Brd4-targeting compound are combined with the HTK solution in a concentration of about 0.5 μM to about 300 μM. In some embodiments, the cold perfusion techniques are at the temperature of about 4° C.

Particular embodiments of the subject matter described in this document can be implemented to realize one or more of the following advantages. The herein described composition extends the viable preservation time of donor organs, increasing the window for transplantation while reducing ischemic damage. This enables better organ allocation and logistics, allowing for improved matching between donors and recipients over greater geographic distances.

The herein described approach reduces reliance on warm blood perfusion, which is labor-intensive, costly, and requires specialized expertise. By enhancing cold perfusion preservation, this composition provides a more accessible and scalable solution for transplant centers, reducing the burden on healthcare providers while maintaining organ viability.

The herein described method lowers the risk of PGD and ischemia-reperfusion injury by improving tissue integrity during the preservation period. This can lead to better post-transplant function, reduced need for immediate medical interventions, and improved long-term outcomes for transplant recipients.

The herein described composition allows for more efficient use of donor organs, potentially increasing the number of transplantable organs that would otherwise be discarded due to time constraints, age of the donor, or concerns over preservation quality. This can help address organ shortages and improve overall transplantation success rates.

The herein described enhancement to cold perfusion is compatible with existing organ preservation protocols, requiring minimal changes to current clinical workflows. This facilitates rapid adoption without the need for significant infrastructure investment, making it a cost-effective improvement to current transplant preservation methods.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIGS. 1A-1K show that MR is preferentially expressed in human cardiomyocytes during cardiac preservation and negatively impacts donor heart function after reperfusion. Data are presented as means±SD. *P<0.05, **P<0.01 by Mann-Whitney test.

FIG. 1A shows a Uniform Manifold Approximation and Projection (UMAP) plot of single-cell transcriptomic analysis from cold (4° C.) preserved human hearts (9,708 cells) showing clustered cell types including endothelial cells (EC), smooth muscle cells (SMC), fibroblasts (FB), leukocytes (LK), neuronal cells (NC) as well as cardiomyocytes (CM) 1 and 2. 3 HTK preserved and 3 HTK+Canr preserved human donor hearts at baseline and 10 hours of storage. FIG. 1B shows a Gene Set Enrichment Analysis (GSEA) showing results of relative Gene Ontogeny (GO) enrichment between the cluster-specific overexpressed genes in CM1 versus CM2 (adjusted p<0.05). FIG. 1C depicts MR (NR3C2) expression embedded in UMAP plot. Murine donor hearts with cardiomyocyte-specific MR deficiency (Myh6^{CreERT2}; MR^{fl/fl}) versus MR^{fl/fl} control. FIG. 1D shows an ex-vivo perfusion model assessing cardiac contractility. FIG. 1E shows relaxation over a 20-minute measurement period (n=8-10/group). A syngeneic heterotopic heart transplant model where donor hearts from Myh6^{CreERT2}; MR^{fl/fl} versus MR^{fl/fl} control are transplanted into wild-type recipient C57BL/6J mice. FIG. 1F shows the assessment of the hearts for contractility after 24 hours, over a 1-minute in vivo measurement period (n=7-8/group). FIG. 1G shows the assessment of the hearts for relaxation after 24 hours, over a 1-minute in vivo measurement period (n=7-8/group). FIG. 1H shows imaging analysis (n=8 per group) of Terminal deoxynucleotidyl transferase dUTP nick end labeling (TUNEL) and 8-OHDG staining in perfused murine hearts quantified with and FIG. 1I shows quantification of Terminal deoxynucleotidyl transferase dUTP nick end labeling (TUNEL) and 8-OHDG. FIG. 1J shows circulating cardiac troponin I (cTnI) quantified with enzyme-linked immunosorbent assay (ELISA, n=7-8/group). FIG. 1K shows tumor necrosis factor (TNF-α) quantified with enzyme-linked immunosorbent assay (ELISA, n=7-8/group).

FIGS. 2A-2K show that MR undergoes liquid-liquid phase separation into nuclear condensates under cold hypoxic preservation conditions. Data are presented as means±SD. **P<0.01 by Mann-Whitney test.

FIG. 2A shows MR expression with DAPI nuclear staining in ex-vivo reperfused murine donor hearts preserved with histidine-tryptophan-ketoglutarate (HTK) solution at baseline (immediately after HTK administration) and after 16 hours of storage. FIG. 2B shows human donor hearts cold (4° C.) preserved with HTK solution without reperfusion at baseline (immediately snap frozen after procurement) and after 10 hours of storage. FIG. 2C shows that neonatal murine cardiomyocytes (NMCM) were transfected with Ad-GFP or Ad-GFP-MR and subjected to culture with DMEM under normoxic conditions (20% O₂) and then underwent hypoxic (1% O₂) 4° C. preservation with HTK solution. FIG. 2D shows MR domains showing N-Terminal Domain (NTD) has a high concordant PONDR score using 2 separate prediction algorithms (VSL2, VLXT) thus identifying it as an Intrinsic Disordered Region (IDR). FIG. 2E shows a turbidity study (A340 absorbance) with increasing concentration of in-vitro GFP only versus GFP-MR in 10% PEG800 (n=4). FIG. 2F shows direct visualization by eye in test tubes of increasing concentration of GFP versus GFP-MR. FIG. 2G depicts a representative droplet imaging of GFP alone (16 μM) compared with GFP-MR (16 M), n=4. FIG. 2H shows fusion of two dynamic GFP MR condensates, each measuring 3 μM in diameter combining to form a single condensate with a diameter=3.8 μM. FIG. 2I shows representative fluorescence recovery after photobleaching (FRAP) where laser bleaching of a condensate region (arrow) is followed by return of GFP fluorescence as unbleached GFP-MR is recruited back into the area. n=4. FIG. 2J shows a representative droplet image of MR condensate formation by full-length GFP-MR (16 M) and GFP-MRΔIDR (16 M) missing the N-terminal intrinsic disordered region (IDR), n=4. FIG. 2K shows a turbidity study (A340 absorbance) comparison of GFP-MR and GFP-MRΔIDR in 10% PEG800 at escalating concentrations shown in graph (n=4).

FIGS. 3A-3K show that the IDR of MR governs the capacity for phase separation and determines cardiac preservation quality. One-way ANOVA followed by Tukey's multiple comparison test was used for comparisons of more than 2 groups.

FIG. 3A shows Adeno-associated virus 9 (AAV) was administered to Myh6CreERT2; MRfl/fl mice 14 days prior to cardiac preservation. AAV9 was used to deliver cardiac-specific constructs containing full-length MR (AAV-MR), MR missing the IDR (AAV-MRΔIDR), and the AAV-Luciferase (AAV-Luc) control. FIG. 3B shows that after 16 hours of preservation followed by ex-vivo perfusion, construct expression in-vivo was verified by PCR for transcription. FIG. 3C shows that after 16 hours of preservation followed by ex-vivo perfusion, construct expression in-vivo was verified by a western blot for protein expression. FIG. 3D shows immunostaining of MR condensates (red) with DAPI (blue). FIG. 3E shows quantitation of MR condensates loci per cell with comparison by the Mann-Whitney test. FIG. 3F shows an ex-vivo perfusion model assessing cardiac contractility. FIG. 3G shows an ex-vivo perfusion model assessing cardiac relaxation over a 20-minute measurement period in AAV9 treated Myh6^{CreERT2}; MR^{fl/fl} hearts (n=8/group). FIG. 3H shows a western blot of cleaved caspase 3 and Bax with tubulin control as well as phospho- and total JNK and Erk2 in ex-vivo perfused AAV-Luc, AAV-MR, and AAV-MRΔIDR expressing Myh6^{CreERT2}; M^{fl/fl} hearts. FIG. 3I depicts the associated quantification (n=5/group). FIG. 3J shows 8-OHDG staining (green) as a marker of DNA oxidative stress shown in AAV-Luc, AAV-MR, and AAV-MRΔIDR expressing Myh6^{CreERT2}; M^{fl/fl} hearts. FIG. 3K depicts the quantification of fluorescent intensity shown in FIG. 3J. Representative fluorescence images of n=8/group. Data are presented as means±SD. *P<0.05, **P<0.01.

FIGS. 4A-4N show that canrenone treatment significantly improved porcine and human donor heart function after prolonged preservation and reduced cardiac injury. An ex-vivo assessment of pig hearts preserved with HTK±Canrenone (Canr) treatment for 10 hours was used. Hemodynamic and coronary measurements were recorded in working mode after 1 hour of perfusion.

FIG. 4A shows contractility (max dP/dt) after 1 hour of perfusion.

FIG. 4B shows relaxation (minutes dP/dt) after 1 hour of perfusion.

FIG. 4C shows cardiac output (ml/min/g) after 1 hour of perfusion.

FIG. 4D shows coronary blood flow (n=8 per group) after 1 hour of perfusion.

FIG. 4E shows that cardiac troponin I (cTnI) was quantified in ex-vivo perfusate for porcine hearts (n=8 per group).

FIG. 4F shows oxidative DNA damage in porcine hearts was visualized with 8-OHDG staining. FIG. 4G shows the quantified data of FIG. 4F with imaging analysis (n=4 per group).

FIG. 4H shows that cell death in porcine hearts was visualized by staining with TUNEL.

FIG. 4I depicts the quantification of a percentage of TUNEL-positive cells (n=8 per group) of FIG. 4H.

FIG. 4J shows ex-vivo analysis of human hearts was preserved with HTK alone (n=5) versus HTK+Canrenone treatment (n=4) for 10 hours and were used to evaluate hemodynamic and coronary measurements recorded in working mode after 1 hour of perfusion including contractility (max dP/dt).

FIG. 4K shows ex-vivo analysis of human hearts was preserved with HTK alone (n=5) versus HTK+Canrenone treatment (n=4) for 10 hours and were used to evaluate hemodynamic and coronary measurements recorded in working mode after 1 hour of perfusion including relaxation (minutes dP/dt).

FIG. 4L shows ex-vivo analysis of human hearts was preserved with HTK alone (n=5) versus HTK+Canrenone treatment (n=4) for 10 hours and were used to evaluate hemodynamic and coronary measurements recorded in working mode after 1 hour of perfusion including cardiac output (ml/min/g).

FIG. 4M shows ex-vivo analysis of human hearts was preserved with HTK alone (n=5) versus HTK+Canrenone treatment (n=4) for 10 hours and were used to evaluate hemodynamic and coronary measurements recorded in working mode after 1 hour of perfusion including coronary blood flow (n=4-5 per group).

FIG. 4N shows cardiac troponin I (cTnI) was quantified in ex-vivo perfusate for the human heart (n=4-5 per group). Data are presented as means±SD. *P<0.05, **P<0.01 by Student's t-test.

FIGS. 5A-5F show that MR phase separation in human hearts was reduced by canrenone treatment and this was associated with reversal of MR genome occupancy patterns as well as increased abundance of metabolites needed for energy production. Cleavage Under Targets and Release Using Nuclease (CUT&RUN) sequencing analysis was used to evaluate human hearts preserved with HTK±Canrenone comparing baseline time versus 10 hours without reperfusion (n=4 per group).

FIG. 5A depicts K-means clustering that was used to analyze the CUT&RUN-seq data on MR occupancy for its genome targets. This revealed 4 distinct clusters (C1-4) on a heat map with the respective signaling pathways displayed and the result for each experimental condition is shown.

FIG. 5B depicts a stacked bar plot showing the distance of MR peaks from the transcription start site (TSS) in the various genomic regions based on the four MR genome binding clusters identified by K-means analysis. Distal intergenic regions are considered genomic regions except for intragenic and promoter regions. Peaks were assigned to each distance category based on their summits.

FIG. 5C shows human hearts cold (4° C.) preserved with HTK±Canrenone HTK without reperfusion were stained for the expression pattern of mineralocorticoid receptors (MR, red) comparing baseline at the time of procurement versus after 10 hours of preservation. Images shown represent n=4 biological replicates.

FIG. 5D shows in-vitro GFP-MR±Canrenone (50 M) was performed with representative droplet imaging of GFP-MR (at 8 μM and 4 μM). Images shown represent n=4 biological replicates. FIG. 5E shows turbidity studies at different GFP-MR titrations Canrenone (50 μM) to quantify condensate formation (n=4 per concentration group).

FIG. 5F shows metabolomic analysis (via mass spectrometry) showing key metabolites with altered abundance in HTK+Canrenone preserved human hearts without reperfusion (n=4-per group). *P<0.05 by Mann-Whitney test.

FIGS. 6A-6D show that death process and cold organ preservation is associated with increased osmolality with molecular phase separation as a shared theme in cold static organ preservation.

FIG. 6A shows osmolality evaluated in the serum of brain (n=8) and cardiac (n=3) death donors as well as in preoperative living patients scheduled to receive left ventricular assist device implants (n=11 per group, non-transplant) serving as control.

FIG. 6B shows measurements of the osmolality of preservation solution samples from human donor hearts preserved at baseline and after 10 hours of storage prior to reperfusion (n=8 per group).

FIG. 6C shows H9C2 cardiomyocytes were transfected using AAV9-GFP-MR and subjected to culture with DMEM (300 mOsm) under normoxic conditions (20% O₂) as control. Sorbitol was added to increase osmolality to 400 mOsm mimicking the serum osmolality of organ donors. Data shown represent n=6 biological replicates.

FIG. 6D shows HTK (for kidneys, livers, hearts) and Perfadex solution (for lungs) were used to preserve murine organs at 4° C. Expression pattern of mineralocorticoid receptors (MR, red), histone deacetylase 1 (HDAC1, red) and bromodomain containing 4 (Brd4, red) were compared at baseline and after 16 hours cold preservation under fluorescence microscopy. Data shown represent n=4 biological replicates. Data are presented as means±SD. *P<0.05, **P<0.01 by Mann-Whitney test (a) or paired t-test (b).

FIGS. 7A-7E show that cardiomyocyte specific Brd4 heterozygous deletion improves ex-vivo donor heart function after preservation. Daily tamoxifen (80 mg/kg) was injected intraperitoneally for 3 days into 3-month-old Brd4^{f/+} control mice and Myh6^{CreErt2}; Brd4^{f/+} mice. Hearts were then isolated and cold preserved in HTK for 16 hours.

FIG. 7A shows Brd4-S and Brd4-L protein expression in control and heterozygous Brd4 deleted hearts by WB (n=3/group).

FIG. 7B shows protein quantification of Brd4-L expression.

FIG. 7C shows protein quantification of Brd4-S expression.

FIG. 7D shows perfused hearts as assessed for contractility.

FIG. 7E shows perfused hearts as assessed for relaxation.

FIGS. 8A-8C show that cold storage with reperfusion altered the 3D chromatin conformation of the human donor left ventricle (LV).

FIG. 8A shows the percentage of BRD4-associated chromatin loops in the human donor heart at baseline and after reperfusion following 10 hours of cold preservation (n=2/group).

FIG. 8B shows aggregate peak analysis of BRD4-specific loops in baseline and reperfused hearts representing chromatin interaction strength between Brd4-associated anchor sites (n=2/group).

FIG. 8C shows a Hi-C comparison matrix (for reperfused vs. baseline hearts, log-transformed, 5 kb resolution) for the PPARGC1A genomic locus visualized on Juicebox. This showed numerous alterations in long-range interactions between BRD4-specific sites following cardiac preservation with reperfusion. Red dots indicate an increased probability of chromatin interaction while blue dots mean decreased contact probability. Specific chromatin interactions occurring following cardiac preservation and reperfusion are indicated by red rectangles. Chromatin interactions describing the baseline state at the time of cardiac removal from the donor are indicated by blue rectangles. External to the matrix diagram, the blue and red tracks represent BRD4 genome occupancy at baseline and following reperfusion as determined by CUT&RUN analysis. The cardiac cold preservation-reperfusion-induced loops (red rectangles) at the PPARGC1A locus are associated with BRD4 genomic occupancy (red tracks) in the reperfused hearts. The green box indicates a topological associating domain (TAD) at 100 kb resolution. Chi-square analysis **P<0.01.

FIGS. 9A-9G show single-cell transcriptomic expression of cell-type markers and differential cardiomyocyte transcriptomes.

FIG. 9A shows a violin plot constructed from an integrated dataset displaying cell marker genes for the respective cell population clusters including endothelial cells, FB, SMC, neuronal cells (NC), leukocytes (LK) as well as cardiomyocyte (CM) clusters 1 and 2.

FIG. 9B shows UMAP plot of single-cell transcriptomic analysis from cold (4° C.) preserved human hearts showing cell population expression of cardiac muscle action potential pathway genes.

FIG. 9C shows UMAP plot of single-cell transcriptomic analysis from cold (4° C.) preserved human hearts showing cell population expression of autophagy-related pathway transcripts.

FIG. 9D shows UMAP plot of cell population expression of RYR2.

FIG. 9E shows UMAP plot of cell population expression of CACNA1C.

FIG. 9F shows UMAP plot of cell population expression of PINK1.

FIG. 9G shows UMAP plot of cell population expression of FIS1.

FIGS. 10A-10F show donor heart preservation is associated with increased MR protein expression. Increased MR protein expression was shown with normalization to baseline preservation time.

FIG. 10A shows increased MR protein expression in human donor hearts at baseline, 4 and 10 hours of 4° C. static preservation with HTK without reperfusion (n=3/group).

FIG. 10B shows increased MR protein expression in murine donor heart after baseline and 16 hours of 4° C. HTK preservation followed by ex-vivo perfusion (n=4/group).

FIG. 10C shows MR immunostaining (purple) with DAPI (blue) in MR^{fl/fl} versus Myh6^{CreERT2}; MR^{fl/fl} hearts with tamoxifen injection. Representative fluorescence images of n=4/group.

FIG. 10D shows QRT-PCR analysis of cytokine transcript expression in transplanted donor hearts preserved for 16 hours normalized to control MR^{fl/fl} hearts at baseline time. FIG. 10E shows Immunostaining of CD45⁺ (red) and Ly6C⁺ (red) with DAPI (blue) in transplanted hearts. Representative fluorescence images of n=4/group.

FIG. 10F shows quantitation of positive staining cell counts expressed as a percentage of total cells averaged over 4 high-powered (200×) fields. Representative fluorescence images of n=4/group. Data are presented as means±SD. *P<0.05 and **P<0.01 by Mann-Whitney test, Tukey's corrections were used for multiple comparisons using one-way ANOVA.

FIGS. 11A-11D show that MR dynamics in living cells show a propensity for LLPS and condensate formation that is driven by the intrinsically disordered protein region.

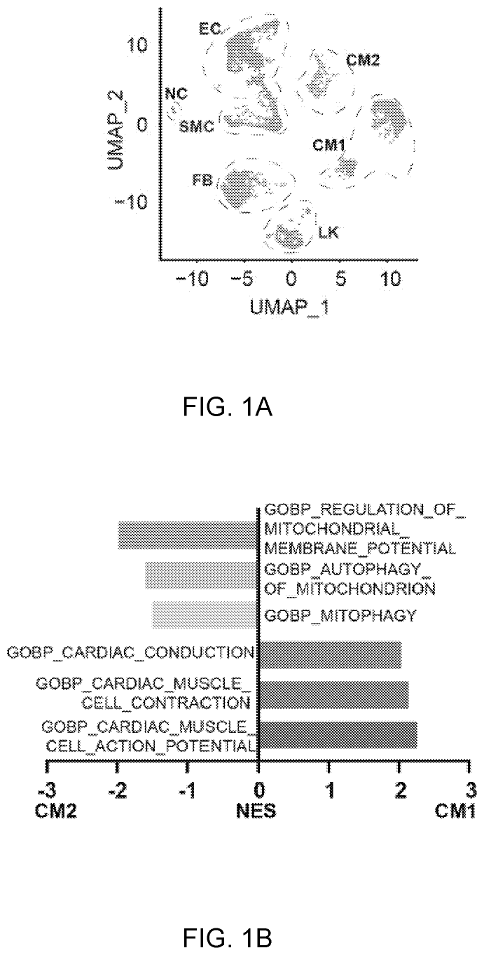

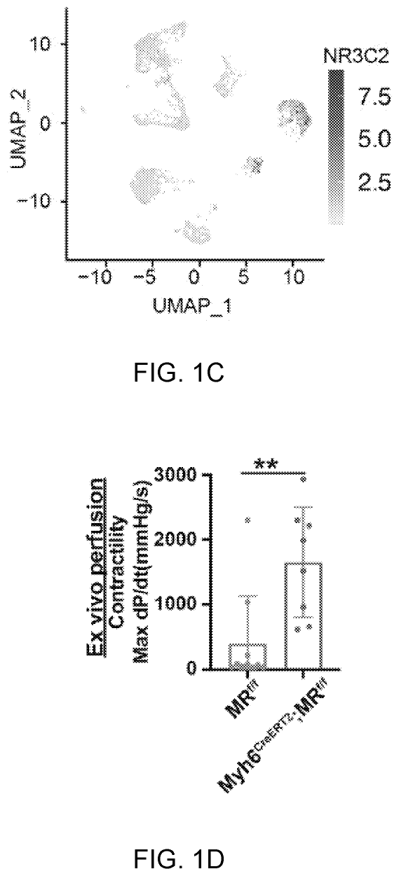

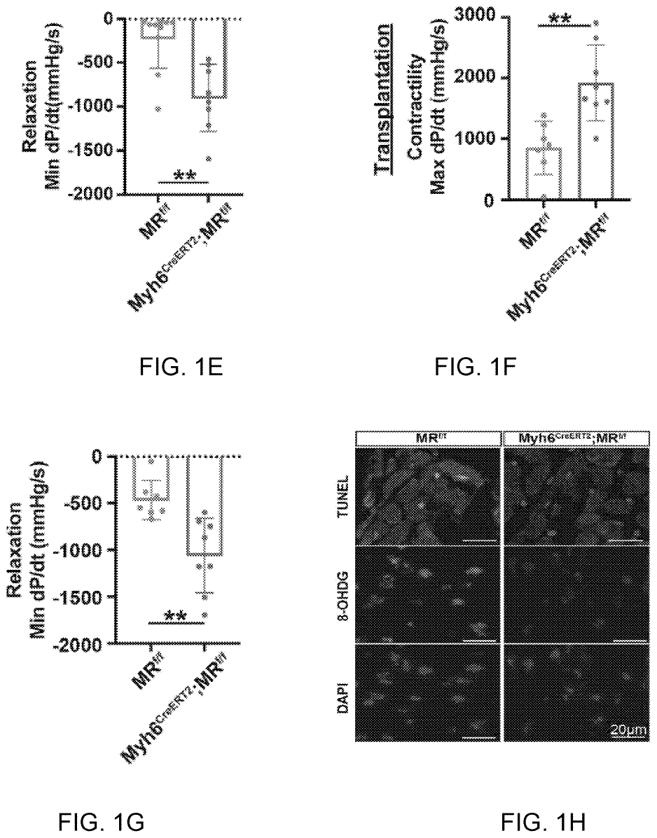

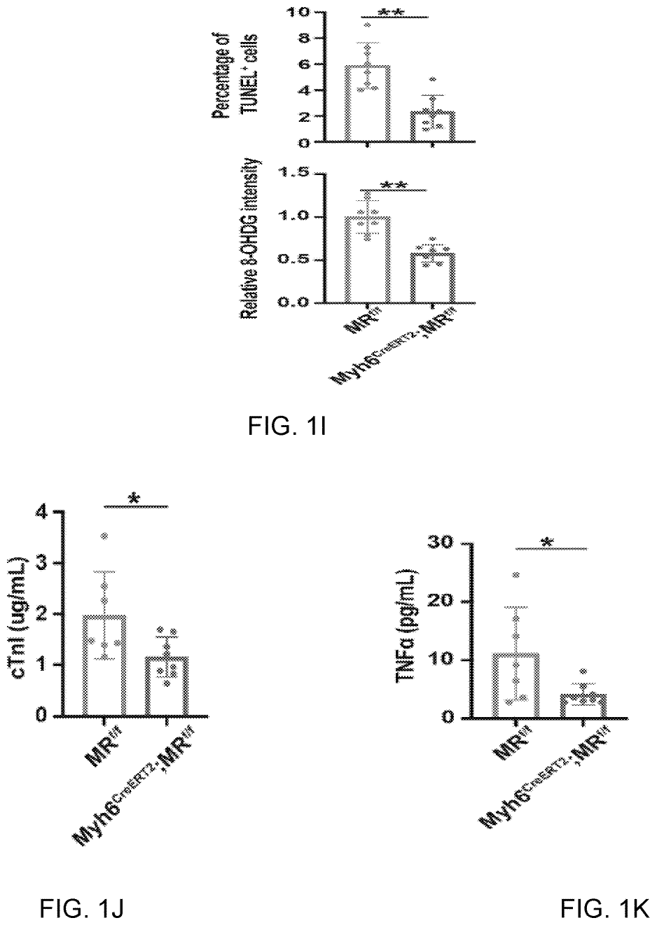

FIG. 1IA shows neonatal rat cardiomyocytes (NRCM) expressing green fluorescent protein (GFP)-MR using adenovirus were bathed in cold (4° C.) HTK preservation solution under hypoxic conditions (1% O₂) for 10 hours. A laser was used to perform fluorescence recovery after photobleaching (FRAP) within the nucleus. The dark region in the middle represents the nucleoli. Photobleached regions are circled, and fluorescence recovery was quantified in the adjoining graph. The data shown represent n=3 biological replicates.

FIG. 1IB shows designed constructs that used lipofectamine to transfect Human Embryonic Kidney (HEK-293) cell cultures to express a mCherry-optoDrop (OptoDroplets) vector with either a full-length MR (MR_FL) protein or a mutant MR without the IDR at the N-terminal domain (MRDIDR).

FIG. 1IC shows the HEK-293 cells were then immersed in histidine-tryptophan-ketoglutarate preservation solution under normoxic conditions and exposed to blue light for up to 60 seconds to induce MR condensate formation (white arrow). MR_FL is seen throughout the entire cell whereas MRΔIDR remained mostly within the cytoplasm thus outlining the nucleus. Data shown represent n=4 biological replicates.

FIG. 1ID shows laser “photobleaching” of MR_FL condensates in live HEK-293 cells followed by fluorescence recovery. Photobleached region is circled. The data shown represent n=4 biological replicates.

FIGS. 12A-12D show that MR phase separation and downstream signaling during cardiac cold preservation is ligand-independent. Adeno-associated virus 9 (AAV) was administered to Myh6^{CreERT2}; MR^{fl/fl} mice 28 days prior to cardiac preservation. AAV9 was used to deliver cardiac specific constructs containing MR with a deleted ligand binding domain (LBD, MRΔLBD).

FIG. 12A shows that after 16 hours of preservation followed by ex-vivo perfusion, construct expression in-vivo was verified by western blot.

FIG. 12B shows that murine donor hearts from wild-type control, Myh6^{CreERT2}; MR^{fl/fl} mice infected with AAV-Luciferase (AAV-Luc) control, and Myh6^{CreERT2}; MR^{fl/fl} mice infected with AAV-MRΔLBD (MR missing the LBD) were cold (4° C.) preserved for 16 hours followed by ex-vivo perfusion with Kreb buffer (n=4-8/group).

FIG. 12C shows immunostaining of MR condensates (red) with DAPI (blue). Representative fluorescence images of n=4/group.

FIG. 12D shows transcript expression of MR target genes ZFP219, CAMK2D, and PER1 in ex-vivo perfused murine hearts cold preserved for 16 hours (n=4 per group).

FIGS. 13A-13F show that canrenone improves donor heart function with ex-vivo perfusion and transplantation after prolonged preservation.

FIG. 13A shows canrenone dose titration with murine donor hearts cold (4° C.) preserved for 16 hours followed by ex-vivo perfusion with Kreb buffer (n=6/group). Canrenone dosage is shown in a logarithmic scale.

FIG. 13B shows preservation time titration of canrenone (50 mM) versus vehicle control (n=5/group) with ex-vivo perfusion and conductance catheter assessment of cardiac contractility.

FIG. 13C shows preservation time titration of canrenone (50 mM) versus vehicle control (n=5/group) with ex-vivo perfusion and conductance catheter assessment of cardiac relaxation.

FIG. 13D shows preservation time titration of canrenone (50 mM) versus vehicle control (n=5/group) with ex-vivo perfusion and conductance catheter assessment of cardiac transplanted donor heart contractility.

FIG. 13E shows preservation time titration of canrenone (50 mM) versus vehicle control (n=5/group) with ex-vivo perfusion and conductance catheter assessment of cardiac relaxation (n=8-9/group).

FIG. 13F shows preservation time titration of canrenone (50 mM) versus vehicle control (n=5/group) with ex-vivo perfusion and conductance catheter assessment of cardiac circulating cardiac troponin I levels were compared following 16 hours of cardiac preservation with canrenone versus vehicle control (n=8/group). Data are presented as means±SD. *P<0.05 and **P<0.01 by Mann-Whitney test.

FIGS. 14A-14G show that canrenone treatment improved porcine donor heart function after 4 hours of preservation. Ex-vivo assessment of pig hearts preserved with HTK±canrenone treatment for 10 hours.

FIG. 14A shows hemodynamic and coronary measurements recorded in working mode after 1 hour of perfusion contractility (max dP/dt).

FIG. 14B shows hemodynamic and coronary measurements recorded in working mode after 1 hour of perfusion relaxation (minutes dP/dt).

FIG. 14C shows hemodynamic and coronary measurements recorded in working mode after 1 hour of perfusion cardiac output (ml/min/g).

FIG. 14D shows hemodynamic and coronary measurements recorded in working mode after 1 hour of perfusion coronary blood flow.

FIG. 14E shows hemodynamic and coronary measurements recorded in working mode after 1 hour of perfusion cardiac troponin I (cTnI) was quantified in ex-vivo perfusate for porcine heart (n=8 per group).

FIG. 14F. shows western blot of BAX, Cleaved CASPASE 3 and BCL2 in ex-vivo perfused human heart.

FIG. 14G. shows the quantification of western blots (n=4) of FIG. 14F. Data are presented as means±SD. *P<0.05 and **P<0.01 by Mann-Whitney test.

FIGS. 15A-15B show that canrenone reverses cold (4° C.) preservation-induced transcriptomic changes in Cardiomyocytes Cluster 1 (CM1) within human donor hearts during storage.

FIG. 15A shows cold preservation-induced gene expression was identified by comparing a human donor heart with 10 hours of preservation compared to baseline. Red dots indicate upregulated genes in the CM1 population during cold storage while blue dots show the effect of canrenone on genes represented by the red dots. Light blue dots indicate downregulated genes in the CM1 population during cold storage while purple dots show the effect of canrenone on genes represented by the light blue dots. The volcano plot demonstrates that Canrenone reverses the cold preservation-induced global up- and downregulated genes in CM1.

FIG. 15B shows a heatmap of gene expression in CM1 of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). The baseline is where samples were collected at the back table immediately following preservation solution administration and removal of the donor's heart from the surgical field.

FIGS. 16A-16B show that canrenone reverses cold (4° C.) preservation-induced transcriptomic changes in cardiomyocytes cluster 2 (CM2) within human donor hearts during storage.

FIG. 16A shows cold preservation-induced gene expression was identified by comparing a human donor heart with 10 hours of preservation compared to baseline. Red dots indicate upregulated genes in CM2 population during cold storage while blue dots show the effect of canrenone on genes represented by the red dots. Light blue dots indicate downregulated genes in CM2 population during cold storage while purple dots show the effect of canrenone on genes represented by the light blue dots. The volcano plot demonstrates that Canrenone reverses the cold preservation-induced global up- and downregulated genes in CM2.

FIG. 16B shows a heatmap of gene expression in CM2 of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). The baseline is where samples were collected at the back table immediately following preservation solution administration and removal of the donor's heart from the surgical field.

FIGS. 17A-17B show that canrenone reverses cold (4° C.) preservation induced transcriptomic changes in FB within human donor hearts during storage.

FIG. 17A shows a cold preservation induced gene expression was identified by comparing human donor heart with 10 hours of preservation compared to baseline. Red dots indicate upregulated genes in FB population during cold storage while blue dots show the effect of canrenone on genes represented by the red dots. Light blue dots indicate downregulated genes in FB population during cold storage while purple dots show the effect of canrenone on genes represented by the light blue dots. Volcano plot demonstrates that Canrenone reverses the cold preservation-induced global up- and downregulated genes in FB.

FIG. 17B shows a heatmap of gene expression in FB of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). Baseline is where samples were collected in the back table immediately following preservation solution administration and removal of the donor heart from the surgical field.

FIGS. 18A-18B show that canrenone reverses cold (4° C.) preservation-induced transcriptomic changes in endothelial cells within human donor hearts during storage.

FIG. 18A shows that cold preservation-induced gene expression was identified by comparing human donor hearts with 10 hours of preservation compared to baseline. Red dots indicate upregulated genes in EC population during cold storage while blue dots show the effect of canrenone on genes represented by the red dots. Light blue dots indicate downregulated genes in EC population during cold storage while purple dots show the effect of canrenone on genes represented by the light blue dots. The volcano plot demonstrates that Canrenone reverses the cold preservation-induced global up- and downregulated genes in EC.

FIG. 18B shows a heatmap of gene expression in EC of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). The baseline is where samples were collected in the back table immediately following preservation solution administration and removal of the donor's heart from the surgical field.

FIGS. 19A-19B show that canrenone reverses cold (4° C.) preservation-induced transcriptomic changes in SMC within human donor hearts during storage.

FIG. 19A shows cold preservation-induced gene expression was identified by comparing human donor hearts with 10 hours of preservation compared to baseline. Red dots indicate upregulated genes in SMC population during cold storage while blue dots show the effect of canrenone on genes represented by the red dots. Light blue dots indicate downregulated genes in SMC population during cold storage while purple dots show the effect of canrenone on genes represented by light blue dots. The volcano plot demonstrates that Canrenone reverses the cold preservation-induced global up- and downregulated genes in SMC.

FIG. 19B shows a heatmap of gene expression in SMC of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). Baseline is where samples were collected in the back table immediately following preservation solution administration and removal of the donor's heart from the surgical field.

FIG. 20A-20B show that canrenone reverses cold (4° C.) preservation-induced transcriptomic changes in leukocytes (LK) within human donor hearts during storage.

FIG. 20A shows cold preservation-induced gene expression was identified by comparing human donor hearts with 10 hours of preservation compared to baseline. Red dots indicate upregulated genes in the LK population during cold storage while blue dots show the effect of canrenone on genes represented by the red dots. Light blue dots indicate downregulated genes in LK population during cold storage while purple dots show the effect of canrenone on genes represented by the light blue dots. The volcano plot demonstrates that Canrenone reverses the cold preservation-induced global up- and downregulated genes in LK.

FIG. 20B shows a heatmap of gene expression in LK of human donor hearts cold (4° C.) preserved for 10 hours versus baseline (n=3/group). Juxtaposed to the right is the HTK+Canr versus HTK+Veh effect on gene expression following 10 hours of cold (4° C.) preservation of human donor hearts (n=3/group). Baseline is where samples were collected in the back table immediately following preservation solution administration and removal of the donor's heart from the surgical field.

FIGS. 21A-21C depict pseudotime analysis showing the modulatory effect of canrenone on cold donor heart preservation-associated gene expression.

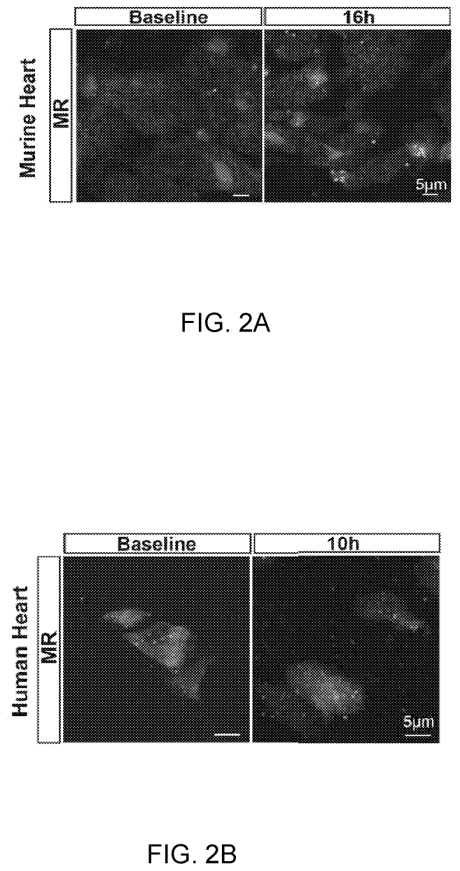

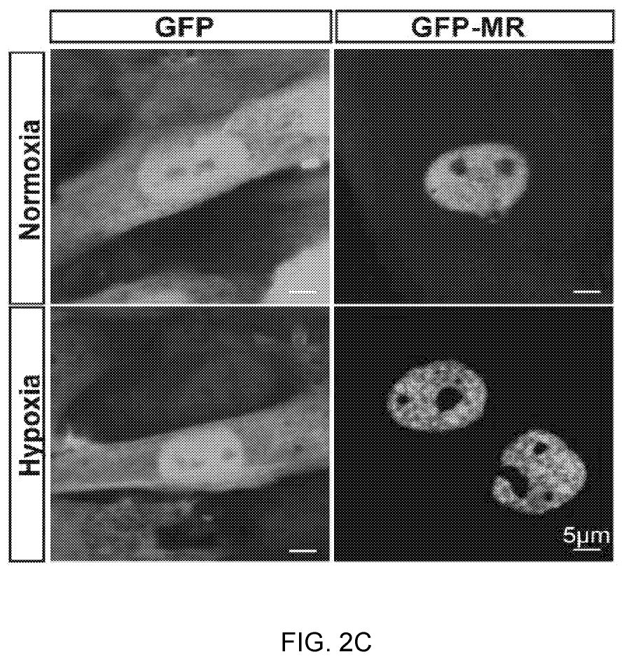

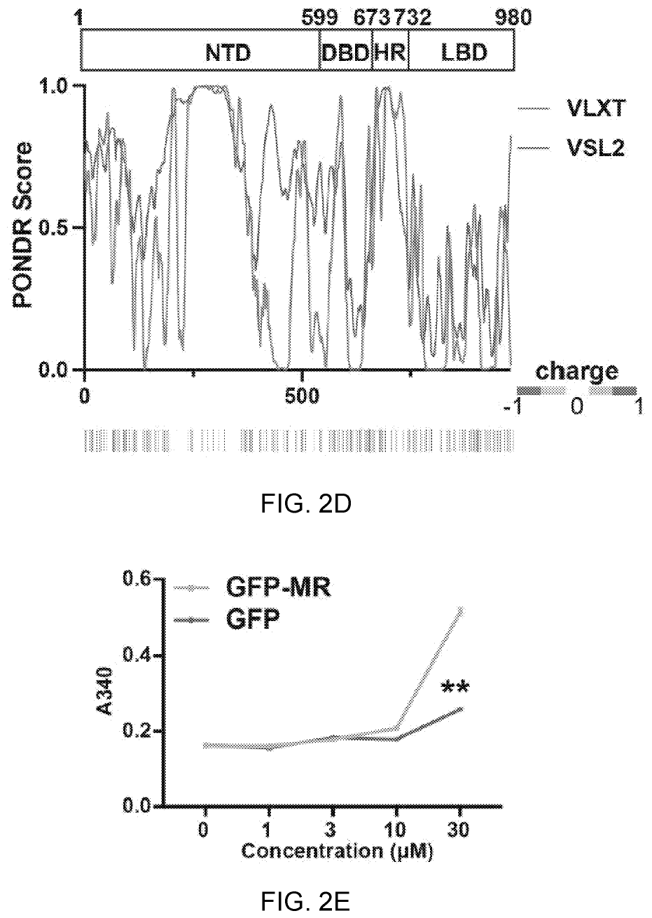

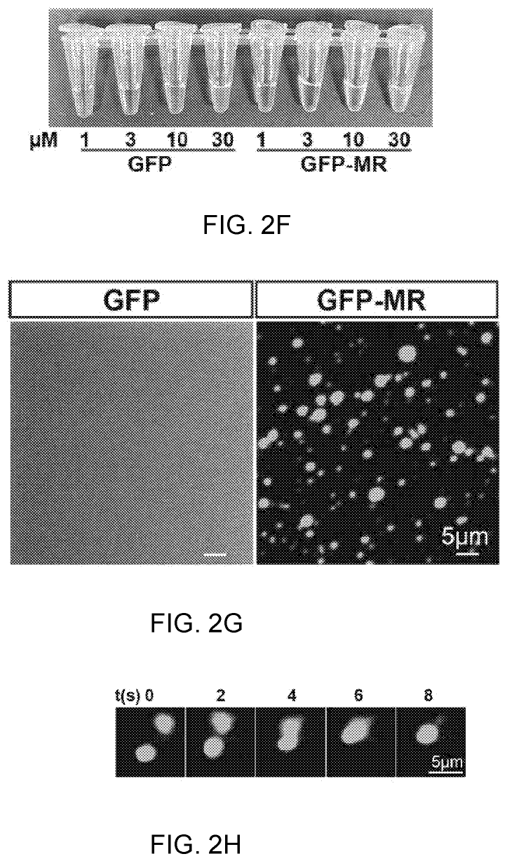

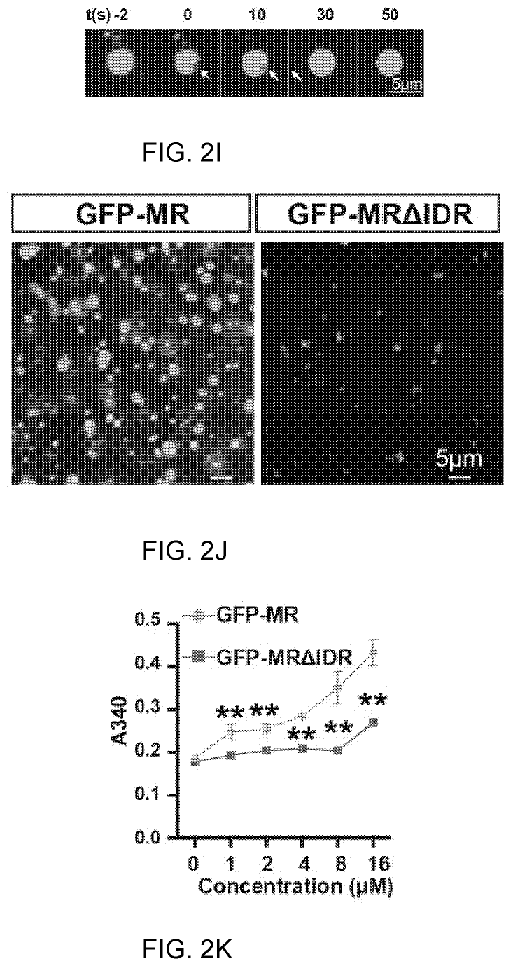

FIG. 2IA shows a density distribution plot showing the distribution of cells having differential transcriptome expression profiles along pseudotime for cold (4° C.) preserved human hearts without reperfusion at baseline versus 10 hours of preservation (n=3/group).

FIG. 2IB shows a density distribution plot showing the distribution of cells having differential transcriptome expression profiles along pseudotime for human hearts cold (4° C.) preserved for 10 hours without reperfusion using HTK alone versus HTK+canrenone (CANR, n=3/group).

FIG. 2IC shows a “Rolling wave” heatmap plot along pseudotime trajectory showing the differentially expressed genes ordered according to hierarchical clustering following 10 hours of human heart preservation without reperfusion using HTK+VEH versus HTK+CANR (n=4/group). P-values for pseudotime dependency using the Kolmogorov-Smirnov test are shown.

FIG. 22 shows canrenone treatment of human donor hearts did not impact the target gene expression of androgen receptors. Hallmark androgen response gene set was used to determine downstream transcript target expression in cardiomyocytes (CM), FB, EC, SMC, and leukocytes (LK).

FIG. 23 shows canrenone treatment of human donor hearts did not impact the target gene expression of estrogen receptors. Hallmark estrogen response early gene set was used to determine downstream transcript target expression in cardiomyocytes (CM), FB, EC, SMC, and leukocytes (LK).

FIG. 24 shows canrenone treatment of human donor hearts did not impact the target gene expression of progesterone receptors. Subtil progestin targets gene set was used to determine downstream transcript target expression in cardiomyocytes (CM), FB, EC, SMC, and leukocytes (LK).

FIG. 25A depicts the mechanism by which Brd4 modulates the epigenetic landscape of old donor hearts during preservation. Using Brd4 gain and loss of function models, Brd4's role in influencing the cardiac function of cold-preserved old donor hearts, and specific epigenetic and chromatin architectural changes mediated by Brd4 during old vs. young donor heart preservation were evaluated.

FIG. 25B depicts increased Brd4 recruitment to the genome of old donor hearts is mediated by increased histone acetylation due to changes in NAD+ availability. NAD+ levels, Sirt6 deacetylase activity, histone acetylation, and Brd4's bromodomain were evaluated for importance for Brd4-mediated changes in the epigenetic and 3D chromosomal landscape during old donor heart preservation.

FIG. 25C depicts an evaluation of pharmacological Brd4 inhibition to improve old human donor heart preservation quality. JQ1 treatment was evaluated to determine the improvement of old human heart function after cold cardiac preservation. Higher serum or myocardial NAD+ levels were tested to predict superior cardiac preservation quality. The epigenetic landscape in human donor hearts will be defined and correlated with function.

FIGS. 26A-26B show aging reduced ex-vivo murine donor heart function after preservation. Young (3 months) and Old (24 months) murine hearts were preserved in HTK for 4 or 20 hours followed by ex-vivo perfusion.

FIG. 26A shows heart contractility (Max dP/dt). These were calculated based on values averaged over a 10-minute period. n=6-7/group, *P<0.05, **P<0.01

FIG. 26B shows relaxation (minutes dP/dt) were assessed. These were calculated based on values averaged over a 10-minute period. n=6-7/group, *P<0.05, **P<0.01

FIGS. 27A-27B show that BRD4 expression is upregulated in the old human hearts.

FIG. 27A shows snRNA analysis of LV showed BRD4 expression in different cells in young and donor hearts. **p<0.01.

FIG. 27B shows CUT&RUN analysis of LV tissues. Average BRD4 occupancy signal at BRD4 binding regions.

FIGS. 28A-28B show old human donor hearts display increased chromatin accessibility. LV tissues from young (n=2, 30, and 22 years old) and old human donor hearts (n=2, 68, and 63 years old) were examined by joint snRNA and snATAC assay.

FIG. 28A shows a metaplot at the transcriptional start site (TSS) regions comparing chromatin accessibility in the cardiomyocytes of old versus young hearts (n=2/group).

FIG. 28B shows chromatin accessibility at the enhancer region of senescence gene CDKN1A (p21) in cardiomyocytes (red dash box). Links indicate potential interaction between two genomic regions.

FIGS. 29A-29C show old human hearts have altered the 3D chromatin conformation compared to young hearts at baseline prior to preservation. Hi-C experiments and CUT&RUN analysis using BRD4 antibody were performed using the LV tissues from old (68 years) and young (30 years) human hearts.

FIG. 29A shows the percentage of BRD4 associated chromatin loops in young and old human donor hearts (**p<0.01, Chi square test).

FIG. 29B shows the aggregate peak analysis of BRD4 specific loops in young and old hearts, demonstrating chromatin interaction strength between BRD4-associated anchor sites.

FIG. 29C shows a Hi-C matrix (log-transformed, 1 kb resolution) comparing old and young hearts at CDKN1A (p21) genomic locus visualized using Juicebox. Red dots indicate an increased probability of chromatin interaction while blue dots mean decreased contact probability. Light blue rectangles indicate specific chromatin interactions (identified by cLoop2) in the old hearts, while dark blue rectangles indicate specific chromatin interactions in the young hearts. In the top and left side of the matrix diagram, the blue tracks represent Brd4 genome occupancy at young and old hearts as determined by CUT & RUN analysis. An increase of BRD4 genomic occupancy in old donor hearts is observed at the CDKN1A promoter region. Aging-induced chromatin loops at the CDKN1A locus were identified between this BRD4 gained occupancy genomic region (vertical green dash line) and two other BRD4 high-occupied regions (horizontal green dash line).

FIGS. 30A-30C show cold preservation-reperfusion increases BRD4-associated chromatin looping.

FIG. 30A shows average BRD4 occupancy signal at BRD4 binding regions by CUT&RUN (n=1/condition, representative of n=2 biological repeats).

FIG. 30B shows the percentage of BRD4-associated chromatin loops in baseline and reperfused donor hearts by Hi-C analysis (n=1/group). **p<0.01, Chi-square test.

FIG. 30C shows the aggregate peak analysis of Hi-C data showing BRD4 specific loop interaction strength at baseline and in preservation-reperfused hearts (n=1/group).

FIGS. 31A-31D show that JQ1 targets Brd4 and restores old murine heart function to the level of young hearts following preservation-reperfusion.

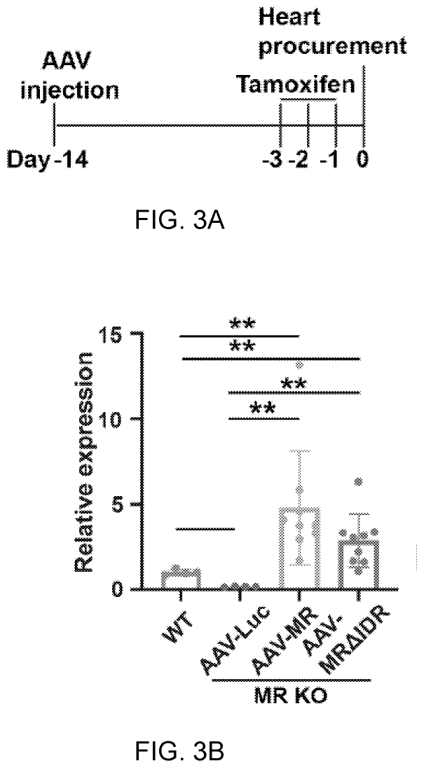

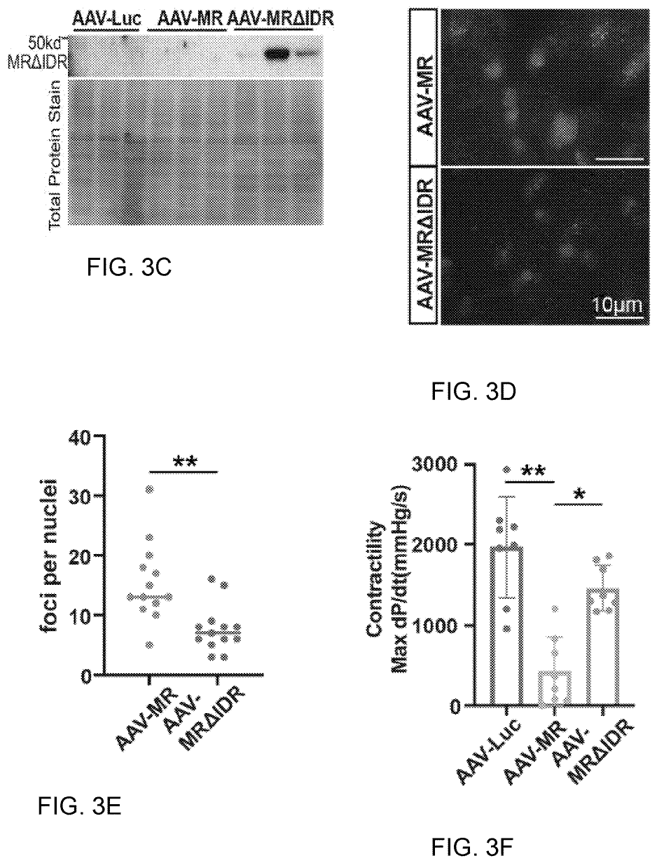

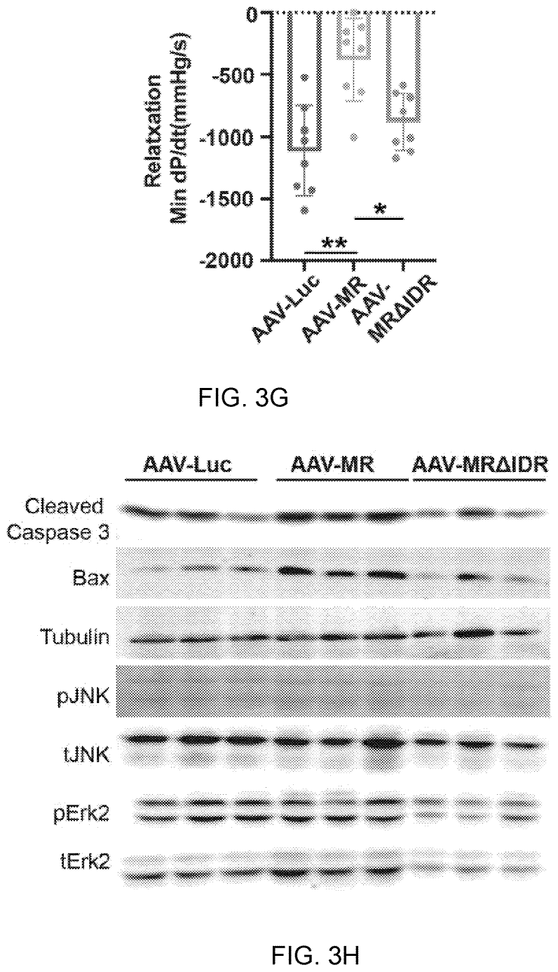

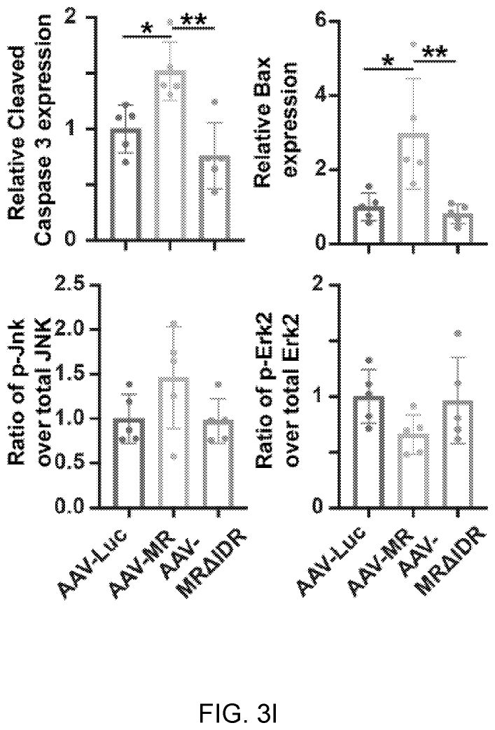

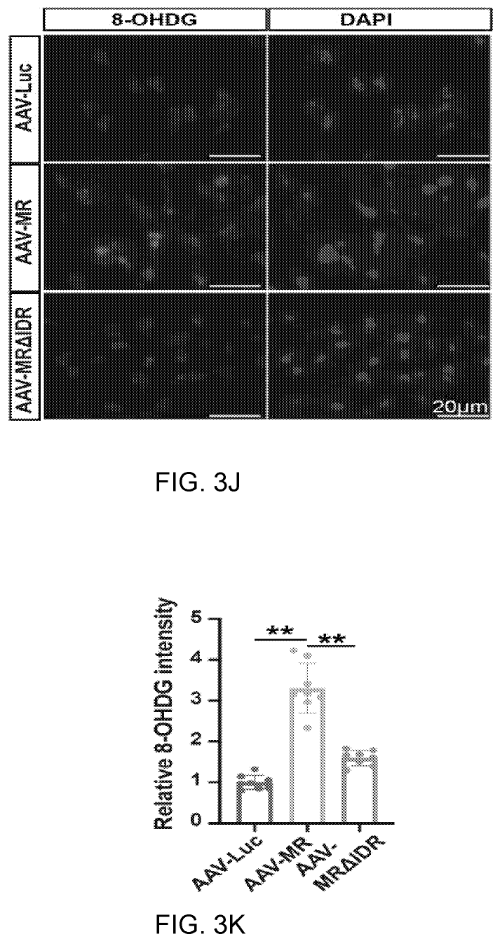

FIG. 3IA shows murine donor hearts were preserved in HTK+biotinylated-JQ1 drug for hours. Coimmunostaining of JQ1-biotin (green) and Brd4 (red) were performed. Scale bar: 5 μM. Representative images from 3 experiments.

FIG. 3IB shows that respective intensity over the span of white rectangle in the merged images were quantified by ImageJ.

FIG. 3IC shows young (3 months old) & (24 months old) hearts were cold preserved for hours with HTK+JQ1 (1 μM) followed by ex-vivo perfusion to assess contractility.

FIG. 3ID shows young (3 months old) & (24 months old) hearts were cold preserved for hours with HTK+JQ1 (1 μM) followed by ex-vivo perfusion to assess relaxation. n=5-8/group, **P<0.01

FIGS. 32A-32D show that cardiomyocyte specific Brd4 heterozygous deletion improves ex-vivo donor heart function after preservation. Daily intraperitoneal tamoxifen (80 mg/kg) for 3 days in 3-month-old Brd4^{f/+} control mice & Myh6^{CreErt2}; Brd4^{f/+} mice. Hearts were isolated and cold static preserved in HTK for 20 hours.

FIG. 32A shows Brd4 protein expression in control and Myh6^{CreErt2}; Brd4+/− hearts by WB (n=3/group).

FIG. 32B shows Brd4 protein quantification (n=3/group).

FIG. 32C shows ex-vivo perfused hearts assessed for contractility.

FIG. 32D shows ex-vivo perfused hearts assessed for relaxation (n=4/group).

FIGS. 33A-33F show that silencing Brd4 improves cardiac function and conduction in old donor hearts. 24-month-old wild-type C57BL6J hearts underwent AAV9-mediated silencing of specific targets and then cold preserved for 20 hours followed by ex-vivo perfusion.

FIG. 33A shows shRNA sequences targeting eGFP and the coding sequence of Brd4 were cloned into the miR30 cassette of the AAV9 vector, which is driven by a cTnT promoter.

FIG. 33B shows PCR quantification of Brd4 transcript expression. FIG. 33C shows hearts assessed for contractility.

FIG. 33D shows hearts assessed for relaxation.

FIG. 33E shows mean electrical conduction velocity in donor hearts with Brd4 knockdown (n=5/group).

FIG. 33F shows representative maps of left ventricular electrical activation using the Electric Mapping Scope System. Arrow indicates the conduction direction. n=5/group, **P<0.01.

FIGS. 34A-34B show Brd4 knockdown reduces mitochondrial turnover in cold static preserved donor hearts followed by reperfusion. AAV9-mediated shRNA was injected into MitoTimer mice. Hearts were isolated 4 weeks later and were either immediately fixed (baseline) or preserved in HTK solution for 20 hours followed by ex-vivo perfusion.

FIG. 34A shows images of perfused MitoTimer donor hearts after prolonged cold storage. Red indicates old protein and green indicates newly synthesized proteins in mitochondria. Representative images of n=3/group.

FIG. 34B shows quantification of Red to Green ratio in control and Brd4 knockdown perfused hearts after prolonged cold storage. *P<0.05,

FIG. 35 shows that co-immunoprecipitation (Co-IP) assays showed BRD4 interaction with G9a and NIBPL in AC16 cardiomyocytes (a human-derived cardiomyocyte cell line). Flag-BRD4 were transiently expressed in AC16 cells. After 48 hours, cells were incubated in cold HTK bath for 6 hours mimicking cold preservation conditions. Co-IP was performed using Flag antibody. Representative blot from 2 biological replicates.

FIGS. 36A-36C show that aging and cold preservation reduces NAD+ levels in human donor hearts. Mass spectrometry was performed to assess metabolites levels from human LV tissue.

FIG. 36A shows NAD+ levels in hearts of varying ages at baseline immediately after procurement were quantified (n=8).

FIG. 36B shows human LV tissue from the same heart were collected after 0 hours and 8 hours of cold preservation with NAD+ levels measured (n=8/group). **p<0.01

FIG. 36C shows a western blot of H4K16ac expression in the young and old donor hearts at baseline (n=2/group).

FIGS. 37A-37C show that FK866 treatment reduced the ex-vivo murine donor heart function after cold preservation. FK866 is a drug that reduces NAD+ availability. Mice were treated with Veh or FK866 i.p. at 10 mg/kg for 1 week, and then their hearts were cold preserved in HTK for 20 hours followed by ex-vivo reperfusion.

FIG. 37A shows that hearts were assessed for contractility.

FIG. 37B shows that hearts were assessed for relaxation.

FIG. 37C shows quantification of acetylated H4K16ac abundance by western blot in reperfused hearts with or without FK-866 treatment. **P<0.01.

FIGS. 38A-38B show that higher BRD4 occupancy at SIRT6 peaks in old human donor hearts after 10 hours of cold preservation with reperfusion.

FIG. 38A shows a metaplot depicting an average BRD4 genomic occupancy at SIRT6 peaks in young hearts at baseline & after preservation followed by reperfusion.

FIG. 38B shows a metaplot depicting an average BRD4 genomic occupancy at SIRT6 peaks in old hearts at baseline & after preservation followed by reperfusion.

FIGS. 39A-39D show that Brd4 inhibition with JQ1 improves pig heart preservation quality. Pig hearts were preserved either with cold static storage on ice for 10 hours following HTK infusion alone or continuously perfused for 18 hours with cold HTK with or without JQ1 (5 μM) treatment followed by ex-vivo perfusion.

FIG. 39A shows cardiac contractility of pig hearts preserved either with cold static storage on ice for 10 hours following HTK infusion alone or continuously perfused for 18 hours with cold HTK with or without JQ1 (5 μM) treatment followed by ex-vivo perfusion. **P<0.01. N=4-5/group.

FIG. 39B shows cardiac relaxation of pig hearts preserved either with cold static storage on ice for 10 hours following HTK infusion alone or continuously perfused for 18 hours with cold HTK with or without JQ1 (5 μM) treatment followed by ex-vivo perfusion. **P<0.01. N=4-5/group.

FIG. 39C shows cardiac output of pig hearts preserved either with cold static storage on ice for 10 hours following HTK infusion alone or continuously perfused for 18 hours with cold HTK with or without JQ1 (5 μM) treatment followed by ex-vivo perfusion. **P<0.01. N=4-5/group.

FIG. 39D shows coronary blood flow of pig hearts preserved either with cold static storage on ice for 10 hours following HTK infusion alone or continuously perfused for 18 hours with cold HTK with or without JQ1 (5 μM) treatment followed by ex-vivo perfusion. **P<0.01. N=4-5/group.

FIGS. 40A-40C show that bromodomain protein 4 (Brd4); Short (-S) vs. Long (-L) Brd4 isoforms; Brd4 drug antagonist (JQ1); Histidine-Tryptophan-Ketoglutarate cardioplegia (HTK).

FIG. 40A shows the mechanisms for divergent Brd4 isoform expression induced by increased ambient osmolality and cold perfusion of donor hearts. The environmental determinants (osmolality, cold organ perfusion) and kinetics of the preferential BRD4-S expression in donor heart preservation and the role of Brd4-S expression in cold perfusion preservation were evaluated.

FIG. 40B shows that co-factors enriched in Brd4 isoform specific condensates were identified during preservation which may regulate gene expression and characterize their effects on downstream signaling. Genome architectural changes induced by Brd4-S during preservation will be assessed with ATAC-Seq and Hi-C. The effects of cold HTK perfusion preservation on genome architecture were examined.

FIG. 40C shows that drug inhibition of Brd4 improves the preservation quality of pig and human hearts in cold perfusion. For clinical translation, JQ1 (Brd4 inhibitor) will be evaluated to determine if it can improve pig and human heart function in the setting of cold perfusion for cardiac preservation.

FIGS. 41A-41B show that BRD4-S was upregulated in human failing hearts. Total RNA sequencing was performed using left ventricle (LV) tissue from human donor hearts and failing hearts.

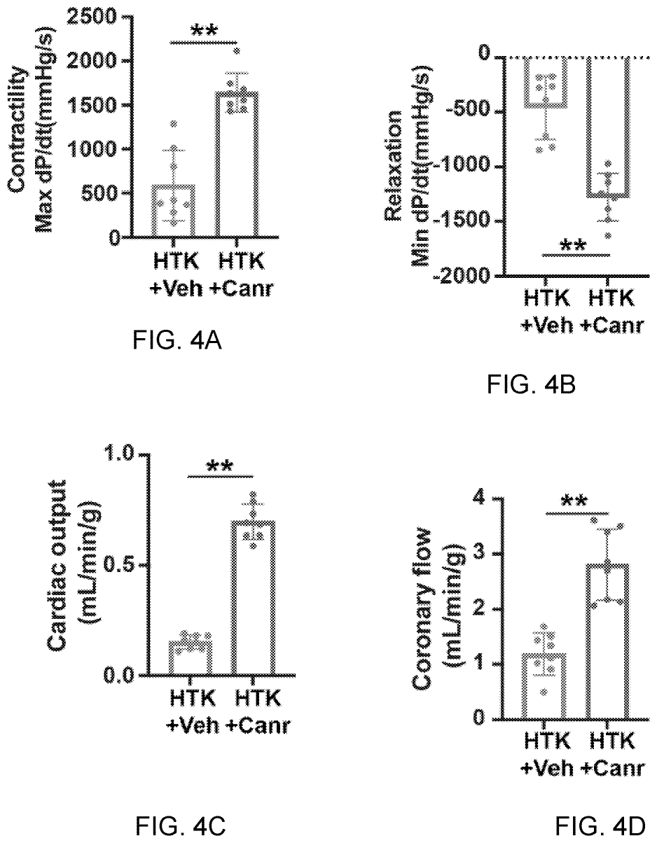

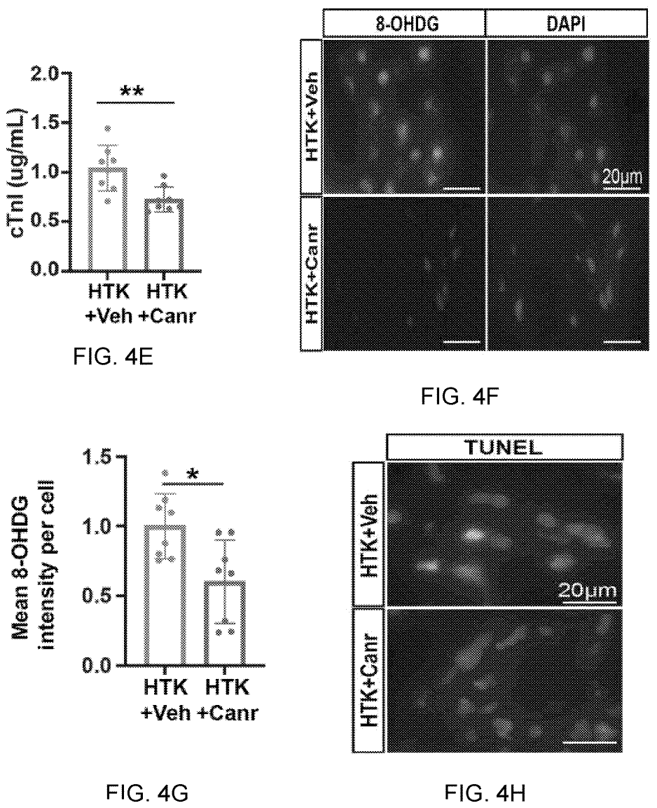

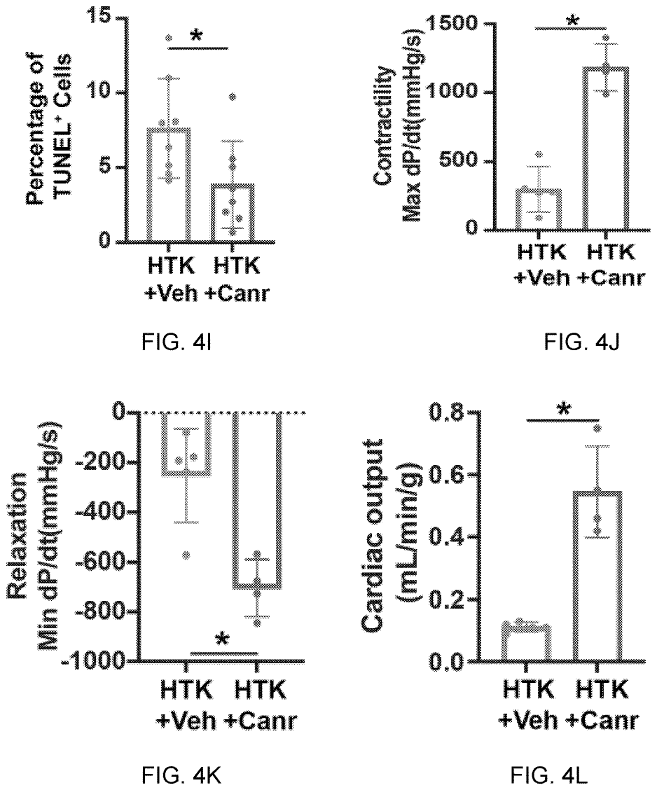

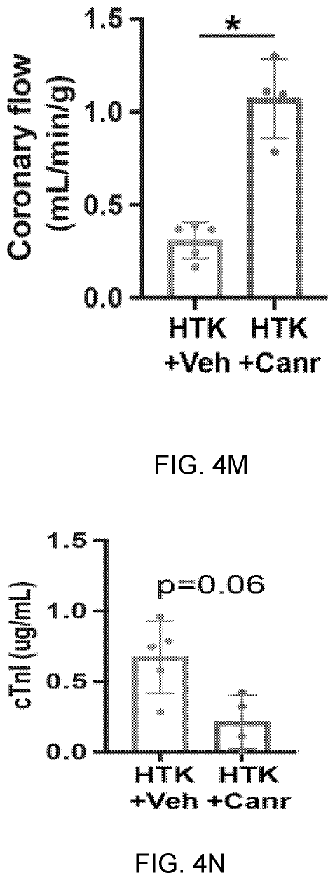

FIG. 4IA shows expression of BRD4 isoforms including Brd4-S and Brd4-L in donor hearts with normal contractility and failing hearts.

FIG. 4IB shows an expression of BRD2, BRD3, BRD4, and BRDT mRNA did not change between human donor hearts and failing hearts. *p-adjust <0.05, **p-adjust <0.01.

FIGS. 42A-42C show an increased BRD4-S isoform expression during cold static preservation of human hearts. Hearts underwent cold (4° C.) static preservation with HTK solution without reperfusion.

FIG. 42A shown normalized BRD4-S/L mRNA ratio at 0, 4, & 10 hours of preservation.

FIG. 42B shows representative western blot of BRD4-S & BRD4-L protein expression during preservation.

FIG. 42C shows quantified BRD4-S/BRD4-L protein ratio (n=4/group). *P<0.05, **P<0.01.

FIGS. 43A-43F show that JQ1 preferentially colocalized with Brd4-S and improved murine donor heart preservation and function as seen in ex-vivo perfusion & syngeneic heterotopic transplantation models.

FIG. 43A shows co-immunostaining of JQ1-biotin (green) and Brd4-S (red) or Brd4-L (red) in murine donor hearts preserved in HTK with JQ1-biotin (5 μM) for 16 hours where the hearts showed colocalization of Brd4-S and JQ1-biotin. Scale bar: 5 μm.

FIG. 43B shows the quantification of respective intensity over the span of white line in the merged images was quantified.

FIG. 43C shows improved donor heart contractility where hearts were cold statically preserved for 16 hours with JQ1 (5 μM) followed by ex-vivo perfusion.

FIG. 43D shows improved donor heart relaxation where hearts were cold statically preserved for 16 hours with JQ1 (5 μM) followed by ex-vivo perfusion.

FIG. 43E shows improved contractility in hearts preserved for 16 hours followed by syngeneic heterotopic transplantation, JQ1 (5 M).

FIG. 43F shows improved relaxation in hearts preserved for 16 hours followed by syngeneic heterotopic transplantation, JQ1 (5 M). n=4-5/group, **P<0.01.

FIGS. 44A-44F show that expression of RNA splicing factors decreased in CMs during human heart preservation.

FIG. 44A shows a violin plot showing that cold static storage decreases the expression of splicing factor RBFOX2 in CM1 cardiomyocytes using the Mann-Whitney test.

FIG. 44B shows a violin plot showing that cold static storage decreases the expression of splicing factor RBFOX1 in CM1 cardiomyocytes using the Mann-Whitney test.

FIG. 44C shows a violin plot showing that cold static storage decreases the expression of splicing factor RBM20 in CM1 cardiomyocytes using the Mann-Whitney test.

FIG. 44D shows a violin plot showing that cold static storage decreases the expression of splicing factor CELE1 in CM1 cardiomyocytes using the Mann-Whitney test.

FIG. 44E shows a violin plot showing that cold static storage decreases the expression of splicing factor TIA1 in CM1 cardiomyocytes using the Mann-Whitney test.

FIG. 44F shows a violin plot showing that cold static storage decreases the expression of splicing factor SRSF1 in CM1 cardiomyocytes using the Mann-Whitney test.

FIGS. 45A-45D show effective results of in-vivo cardiac-specific silencing of Brd4 isoforms.

FIG. 45A shows cardiac-specific miR30-based shRNAs that target the C-terminal of Brd4-L (shBrd4-L), 3′-UTR of Brd4-S (shBrd4-S), common N-terminal of Brd4 L+S (shBrd4-N) as well as targeting the EGFP sequence (control). These were cloned to the C-terminal of AAV-EGFP vector driven by cTnT promoters.

FIG. 45B shows results of expression of Brd4-L following in-vivo silencing are shown. *P<0.05. **P<0.01.

FIG. 45C shows results of expression of Brd4-S following in-vivo silencing are shown. *P<0.05. **P<0.01.

FIG. 45D shows results of expression of Brd4 (L+S) following in-vivo silencing are shown. *P<0.05. **P<0.01.

FIGS. 46A-46D show that silencing Brd4-S improves cardiac function and conduction. Wild-type C57BL6J hearts underwent AAV9-mediated silencing of specific targets and then cold preserved for 16 hours followed by ex-vivo perfusion.

FIG. 46A shows the cardiac function of the heart when assessed for contractility.

FIG. 46B shows the cardiac function of the heart when assessed for relaxation.

FIG. 46C shows the mean electrical conduction velocity in donor hearts with specific Brd4 isoform silencing.

FIG. 46D shows representative maps of left ventricular electrical activation using the Electric Mapping Scope System. The arrow indicates the conduction direction. **P<0.01.

FIGS. 47A-47D show hyperosmolality induces Brd4-S upregulation in cardiomyocytes.

FIG. 47A shows a measurement of the osmolality of preservation solution samples from human donor hearts preserved at baseline and after 10 hours of storage prior to reperfusion (n=8/group).

FIG. 47B shows the expression of BRD4-S and BRD4-L in AC16 human cardiomyocytes that were cultured in basal medium or basal medium with 100 mM sorbitol (increase osmolality by 100 mOsm) in the medium and evaluated by WB.

FIG. 47C shows the quantification of BRD4-S in FIG. 47B. and FIG. 47D shows the quantification of BRD4-L in FIG. 47B. *P<0.05.

FIGS. 48A-48D show that cold perfusion preservation improves murine donor heart preservation and function after ex-vivo perfusion.

FIG. 48A showed that murine donor hearts preserved with continuous cold HTK perfusion (0.01 mL/min) into the donor heart for 16 hours showed improved donor heart function contraction after 16 hours of storage compared to cold static storage.

FIG. 48B showed that murine donor hearts preserved with continuous cold HTK perfusion (0.01 mL/min) into the donor heart for 16 hours showed improved donor heart function relaxation after 16 hours of storage compared to cold static storage.

FIG. 48C shows a western blot of Brd4-S and Brd4-L in preserved hearts with cold static HTK bath and cold HTK perfusion.

FIG. 48D shows a ratio of Brd4-S to Brd4-L protein expression in donor hearts with different preservation conditions. *P<0.05.

FIGS. 49A-49B show that Brd4-S knockdown reduces the mitochondrial turnover in donor hearts during cold static storage followed by reperfusion. AAV9-mediated shRNA was injected into MitoTimer mice. Hearts were isolated after 4 weeks for examination. Hearts were either immediately fixed (baseline) or preserved in HTK solution for 16 hours followed by ex-vivo perfusion.

FIG. 49A shows representative images of perfused MitoTimer donor hearts after prolonged cold storage where red indicates old protein and green indicates newly synthesized proteins in mitochondria.

FIG. 49B shows the quantification of red to green ratio in different Brd4 isoform knockdown hearts after prolonged cold storage. *P<0.05, **P<0.01 FIGS. 50A-50C show that prolonged cold storage of a human donor heart showed an increase of BRD4-S foci.

FIG. 50A shows immunostaining of BRD4-S and BRD4-L using isoform-specific antibodies in human donor hearts at baseline immediately after cardiac procurement or 10 hours of cold static storage. BRD4-S foci were mainly perinuclear at baseline and redistributed to the nucleus after storage.

FIG. 50B shows the quantification of BRD4-S foci per cell in human donor hearts at baseline and preserved in cold HTK for 10 hours (4 hearts/group, 8 nuclei/hearts).

FIG. 50C shows the quantification of BRD4-L foci per cell in human donor hearts at baseline and preserved in cold HTK for 10 hours (4 hearts/group, 8 nuclei/hearts).

FIGS. 51A-51B show that co-immunoprecipitation (Co-IP) assays showed an increased interaction of G9a and NIBPL with BRD4-S compared to BRD4-L in AC16 cells (a human-derived cardiomyocyte cell line). Flag-BRD4-S and Flag-BRD4-L were transiently expressed in AC16 cells. After 48 hours, cells were incubated in a cold HTK bath for 6 hours. Co-IP was performed using Flag antibody.

FIG. 51A shows that Co-IP assays showed the interaction between Flag-BRD4S or Flag-BRD4-L with G9a, NIBPL, and H3K9me3.

FIG. 51B shows the quantification of Flag antibodies pull-down protein over input (n=3). *P<0.01.

FIG. 52 shows BRD4 chromatin occupancy in human donor hearts at baseline and 10 hours of cold static storage. Chromatin occupancy changes of total BRD4 at H3K9me3-occupied and H3K27ac-occupied sites at baseline and 10 hours of storage by CUT&RUN-seq.

FIGS. 53A-53D show that donor pig hearts that were treated with continuous perfusion with cold HTK results in improved function compared to cold static storage. Pig hearts were preserved either with cold static storage on ice for 10 hours following HTK infusion or continuously perfused cold HTK for 18 hours, and then ex-vivo perfused for reanimation.

FIG. 53A shows improved contractility of the donor pig heart following cold HTK perfusion for 18 hours compared to the shorter cold static preservation time of 10 hours. **P<0.01. N=5/group.

FIG. 53B shows improved relaxation of the donor pig heart following cold HTK perfusion for 18 hours compared to the shorter cold static preservation time of 10 hours. **P<0.01.

FIG. 53C shows improved cardiac output of the donor pig heart following cold HTK perfusion for 18 hours compared to the shorter cold static preservation time of 10 hours. **P<0.01.

FIG. 53D shows improved coronary blood flow of the donor pig heart following cold HTK perfusion for 18 hours compared to the shorter cold static preservation time of 10 hours. **P<0.01.

FIGS. 54A-54B show that prolonged cold static storage causes Brd4-S upregulation and cold perfusion of HTK reduces the Brd4-S expression in pig hearts.

FIG. 54A shows a western blot of Brd4-S and Brd4-L with tubulin controls in a pig donor heart preserved in a cold static HTK bath for 4 and 10 hours or continuous perfusion of HTK solution for 18 hours.

FIG. 54B shows the quantification of the Brd4-S/Brd4-L ratio. *P<0.05.

FIGS. 55A-55D show Brd4 antagonism with JQ1 to modulate cardiac preservation.

FIG. 55A shows improved contractility in pig donor hearts treated with JQ1 (n=2) combined with cold HTK perfusion compared to cold HTK perfusion alone (n=5) suggesting that Brd4 antagonism may improve tolerable cold ischemic time for pig hearts.

FIG. 55B shows improved relaxation in pig donor hearts treated with JQ1 (n=2) combined with cold HTK perfusion compared to cold HTK perfusion alone (n=5) suggesting that Brd4 antagonism may improve tolerable cold ischemic time for pig hearts.

FIG. 55C shows improved cardiac output in pig donor hearts treated with JQ1 (n=2) combined with cold HTK perfusion compared to cold HTK perfusion alone (n=5) suggesting that Brd4 antagonism may improve tolerable cold ischemic time for pig hearts.

FIG. 55D shows improved coronary blood flow in pig donor hearts treated with JQ1 (n=2) combined with cold HTK perfusion compared to cold HTK perfusion alone (n=5) suggesting that Brd4 antagonism may improve tolerable cold ischemic time for pig hearts.

FIGS. 56A-56D show the results of perfusion of a donor porcine heart with HTK+Veh, HTK+Canr, and HTK+JQ1.

FIG. 56A shows the results for contractility (max dP/dt mmHg/s).

FIG. 56B shows the results for relaxation (min dP/dt mmHg/s).

FIG. 56C shows the results of cardiac output (mL/min/g).

FIG. 56D shows results for increased coronary flow (mL/minute/g).

### DETAILED DESCRIPTION

This document provides methods and materials to support the tissue viability of a donor organ during cold preservation before transplant to the recipient. In some embodiments, materials include compounds that can be added to a solution (e.g., a perfusate solution) to perfuse a donor organ after removal from the donor mammal (e.g., a human) and prior to cold preservation during transport to the recipient hospital for transplantation. For example, compounds added to a solution can be flushed through a donor organ promptly after removal from a donor mammal (e.g., resulting in a treated donor organ). The treated donor organ can then be transported using cold preservation methods (e.g., cold organ perfusion) to the location of a recipient. Non-limiting examples of perfusate include histidine-tryptophan-ketoglutarate (HTK) solution, University of Wisconsin (UW) solution, celsior solution, and steen solution. Non-limiting examples of types of donor organs include heart, lung, liver, pancreas, kidney, intestine, arteries, veins, and composite tissue (e.g., skin, muscle, nerves). In some embodiments, the methods and materials disclosed herein can include treatment of cells. For example, compounds such as MRAs and/or Brd4-targeting compounds can be added to a solution to enhance preservation of cells (e.g., stem cells).

In some embodiments, MRAs can be added to a solution to enhance donor organ preservation during cold storage and transport. Non-limiting examples of MRAs include spironolactone (e.g., canrenone), eplerenone, finerenone, esaxerenone, and balcinrenone. In certain embodiments, MRAs can be incorporated into HTK perfusate. For example, canrenone, an active metabolite of spironolactone, can be introduced into a solution. In some embodiments, canrenone is added to HTK perfusate.

In some embodiments, Brd4-targeting compounds can be added to a solution to enhance donor organ preservation during cold storage and transport. Non-limiting examples of Brd4-targeting compounds include Brd4 inhibitors such as JQ1, apabetalone, and AZD5153, as well as Brd4 degraders like ARV-825 and RNK05047. In certain embodiments, Brd4-targeting compounds can be incorporated into HTK perfusate. For example, JQ1 can be introduced into a solution to modulate transcriptional activity and chromatin accessibility. In some embodiments, JQ1 is added to HTK perfusate to mitigate Brd4-mediated transcriptional changes and improve donor organ viability.

In some embodiments, MRAs and/or Brd4-targeting compounds can be added to a solution to enhance donor organ preservation during cold storage and transport. In certain embodiments, one or more MRAs and/or Brd4-targeting compounds can be incorporated into HTK perfusate. For example, canrenone, an active metabolite of spironolactone, and JQ1, a Brd4 inhibitor, can be introduced into a solution to reduce inflammation, oxidative stress, and transcriptional dysregulation. In some embodiments, both canrenone and JQ1 are added to HTK perfusate to provide combined MR inhibition and Brd4 modulation, to improve donor organ viability and post-transplant function.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to enhance post-preservation organ function. For example, one or more MRAs and/or Brd4-targeting compounds can be administered to a donor organ to reduce oxidative stress, limit inflammatory cytokine expression, and improve cardiomyocyte contractility and relaxation following cold preservation. This approach can also reduce ischemic injury and increase coronary blood flow, thereby improving functional recovery after transplantation.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to inhibit the formation of MR condensates during cold preservation, thereby mitigating transcriptional dysregulation, oxidative stress, and cellular damage. By targeting MR phase separation, donor organ preservation can be improved, reducing preservation-induced transcriptional alterations and ischemia-reperfusion injury. This approach improves contractility and relaxation post-preservation, decreases apoptosis, and enhances overall transplantation outcomes.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to modulate the genomic architecture of donor organs and reduce preservation-associated stress responses. For example, one or more MRAs and/or Brd4-targeting compounds can be administered to a donor organ to alter MR DNA binding patterns, preventing excessive activation of stress-related genes during prolonged cold storage.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to preserve metabolic homeostasis and improve energy production post-transplant. For example, one or more MRAs and/or Brd4-targeting compounds can be administered to a donor organ to increase the abundance of metabolic substrates necessary for energy production while reducing harmful metabolic byproducts.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to improve the preservation quality of older donor organs. For example, one or more MRAs and/or Brd4-targeting compounds can be administered to an older donor organ to counteract age-related epigenetic and metabolic changes that increase susceptibility to ischemia-reperfusion injury. By modulating chromatin accessibility, reducing oxidative stress, and preserving mitochondrial function the viability of older donor organs and improving functional recovery after transplantation can be enhanced.

In some cases, one or more MRAs and/or Brd4-targeting compounds can be added to a solution and administered to a mammalian (e.g., a human) donor organ in need thereof (e.g., a donor organ in need of cold preservation (e.g., cold perfusion)) to improve preservation and reduce the risk of PGD after transplantation. For example, adding one or more MRAs and/or Brd4-targeting compounds can help mitigate the harmful effects of prolonged cold storage by modulating Brd4 isoform expression, reducing inflammation, and preserving mitochondrial function.

A volume of solution can include one or more MRAs and/or Brd4-targeting compounds that can be administered to a donor organ of a mammal (e.g., a human) in any appropriate amount (e.g., any appropriate dose). An effective amount of the one or more MRAs and/or Brd4-targeting compounds can be any amount that can improve donor organ viability and post-transplant function as described herein. In some embodiments, an effective amount of the one or more MRAs and/or Brd4-targeting compounds in a solution (e.g., HTK solution) is about 1 μM to about 300 μM. For example, the concentration of the of one or more Brd4-targeting compounds in the solution is about 1 μM to about 10 μM. In some embodiments, the concentration of the of one or more Brd4-targeting compounds in the solution is about 5 μM. In another example, the concentration of the of one or more MRAs in the solution is about 20 μM to about 300 μM. In some embodiments, the concentration of the of one or more MRAs in the solution is about 50 μM. The effective amount can remain constant or can be adjusted as a sliding scale or variable dose depending on, for example, the type of donor organ or the amount of time needed for preservation prior to transplant. Various factors can influence the actual effective amount used for a particular application. For example, the type of organ, condition of organ, age or organ, duration of preservation, and/or condition of recipient.

### Methods

The methods described herein include treating a donor organ prior to preservation (e.g., perfusion). In some embodiments, treating the donor organ comprises administering one or more MRAs and/or Brd4-targeting compounds in a solution to the donor organ before transplantation to a recipient mammal. For example, the donor organ can be treated with a solution (e.g., HTK solution) comprising one or more MRAs and/or Brd4-targeting compounds prior to donor organ preservation using cold perfusion techniques. In some embodiments, the administration of one or more MRAs and/or Brd4-targeting compounds in a solution prior to preservation enhances donor organ preservation and viability during cold storage and transport to a recipient subject.

In an example method, a donor organ (e.g., a heart) is surgically removed from a mammalian donor subject (e.g., a human) using any acceptable clinical procedure to minimize ischemic injury. For example, while in the donor, an organ such as a heart, can be perfused with about one liter of cold cardioplegia (e.g., HTK cardioplegia) and then excised. In this example, the heart is then removed from the donor subject. A solution comprising one or more of a mineralocorticoid receptor antagonist and a Brd4-targeting compound can be prepared by combining one or more of a mineralocorticoid receptor antagonist and a Brd4-targeting compounds with a solution (e.g., HTK solution). In some embodiments, the solution comprising one or more of a mineralocorticoid receptor antagonist and a Brd4-targeting compound is pre-made.

Following donor organ retrieval, the solution containing one or more MRAs and/or Brd4-targeting compounds in the solution is introduced into the donor organ's vasculature. For example, the solution comprising the one or more MRAs and/or Brd4-targeting compounds in HTK solution can be used to perfuse the donor heart. In some embodiments, the process of perfusing the donor organ with the solution comprising the one or more MRAs and/or Brd4-targeting compounds in HTK solution can take about 5 minutes to about 30 minutes. In some embodiments, the process of perfusing the donor organ with the solution comprising the one or more MRAs and/or Brd4-targeting compounds in HTK solution can take about 10 minutes to about 15 minutes. This can initiate molecular-level preservation by preventing MR phase separation, reducing oxidative stress, limiting inflammatory signaling, and improving cardiac function (e.g., contractility, relaxation, cardiac output, and/or coronary flow) after transplant. After treating the donor organ with the solution containing one or more MRAs and/or Brd4-targeting compounds in a solution, the treated donor organ can be preserved (e.g., for transportation) using continuous cold perfusion techniques and fresh perfusate that does not include one or more MRAs and/or Brd4-targeting compounds. Once the donor organ has been preserved and transported under cold perfusion conditions, it can be transplanted into a recipient subject following any acceptable transplantation protocols. For example, the treated donor organ can be gradually warmed to physiological temperature and transplanted to the recipient subject. The administration (e.g., via perfusion) of a solution containing one or more MRAs and/or Brd4-targeting compounds prior to transport using cold perfusion techniques can increase the duration of time that a donor organ can be transported using cold perfusion methods and can result in improved graft function, reduced ischemia-reperfusion injury, and enhanced long-term transplant viability.

In another example method, a donor organ (e.g., a heart) is surgically removed from a mammalian donor subject (e.g., a human) using any acceptable clinical procedure to minimize ischemic injury. Following donor organ retrieval, a solution containing one or more Brd4-targeting compounds is introduced into the donor organ's vasculature. For example, the solution comprising the one or more Brd4-targeting compounds in HTK solution can be used to perfuse the donor heart. In some embodiments, the process of perfusing the donor organ with the solution comprising the one or more Brd4-targeting compounds in HTK solution can take about 5 minutes to about 30 minutes. In some embodiments, the process of perfusing the donor organ with the solution comprising the one or more Brd4-targeting compounds in HTK solution can take about 10 minutes to about 15 minutes. This initiates molecular-level preservation by preventing MR phase separation, reducing oxidative stress, and limiting inflammatory signaling. After treating the donor organ with the solution containing one or more Brd4-targeting compounds, the treated donor organ can be transported using continuous cold perfusion techniques and fresh perfusate that does not include one or more Brd4-targeting compounds. Once the treated donor organ has been preserved and/or transported under cold perfusion conditions, it can be transplanted into a recipient subject following any acceptable transplantation protocols. For example, the treated donor organ can be gradually warmed to physiological temperature and transplanted into the recipient subject. The administration of solution containing one or more Brd4-targeting compounds prior to preservation (e.g., transport) using cold perfusion can increase the duration of time that a donor organ can be transported using cold perfusion methods and can result in improved graft function, reduced ischemia-reperfusion injury, and enhanced long-term transplant viability.

In an example method, a donor organ (e.g., a heart) is surgically removed from a mammalian donor subject (e.g., a human) using any acceptable clinical procedure to minimize ischemic injury. For example, the donor organ can be in a receptacle and coupled to a perfusion system. Following donor organ retrieval, a solution containing one or more MRAs is introduced into the donor organ's vasculature. For example, the solution comprising the one or more MRAs in HTK solution can be used to perfuse the donor heart. In some embodiments, the process of perfusing the donor organ with the solution comprising the one or more MRAs in HTK solution can take about 5 minutes to about 30 minutes. In some embodiments, the process of perfusing the donor organ with the solution comprising the one or more MRAs in HTK solution can take about 10 minutes to about 15 minutes. This initiates molecular-level preservation by preventing MR phase separation, reducing oxidative stress, and limiting inflammatory signaling. After treating the donor organ with the solution containing one or more MRAs, the treated donor organ can be preserved (e.g., transported) using cold perfusion techniques (e.g., continuous cold perfusion) and fresh perfusate that does not include one or more MRAs. Once the treated donor organ has been preserved and/or transported under cold perfusion conditions, it can be transplanted into a recipient subject following any acceptable transplantation protocol. For example, the treated donor organ can be gradually warmed to physiological temperature and transplanted to the recipient subject. The administration of solution containing one or more MRAs prior to transport using cold perfusion can increase the duration of time that a donor organ can be transported using cold perfusion methods and can result in improved graft function, reduced ischemia-reperfusion injury, and enhanced long-term transplant viability.

In some embodiments, the treated donor organ is placed in an ex-vivo normothermic perfusion system for transport. In such embodiments, the treated donor organ (e.g., treated donor heart) is mechanically arrested (i.e., stopped) using a cold preservation solution before being connected to the normothermic perfusion system for transport. In some embodiments, the donor organ is arrested mechanically and the solution containing one or more MRAs and/or Brd4-targeting compounds is administered prior to being connected to the normothermic perfusion system for transport.

In some embodiments, the donor organ is rapidly flushed with a solution to remove residual blood and metabolic waste prior to perfusion with one or more MRAs and/or Brd4-targeting compounds. In some embodiments, the donor organ is rapidly flushed with a hypothermic organ preservation solution to remove residual blood and metabolic waste. This initial flush can help reduce oxidative stress and inflammation while preparing the organ for perfusion with a therapeutic perfusate containing one or more MRAs and/or Brd4-targeting compounds.

In some embodiments, the amount of elapsed time between removal of the donor organ from the subject to the treatment of the donor organ by perfusion with one or more MRAs and/or Brd4-targeting compounds is about 5 minutes to about 30 minutes.

In some embodiments, the hypothermic temperature is about 2° C. to about 15° C. In some embodiments, the hypothermic temperature is about 4° C. In some embodiments, the duration of time that the donor organ is transported under continuous cold perfusion techniques is about 0.5 hours to about 48 hours. In some embodiments, the duration of time that the donor organ is transported under continuous cold perfusion techniques is about 10 hours. In some embodiments, the duration of time that the donor organ is transported under continuous cold perfusion techniques is about 12 hours. In some embodiments, the duration of time that the donor organ is transported under continuous cold perfusion techniques is about 14 hours. In some embodiments, the duration of time that the donor organ is transported under continuous cold perfusion techniques is about 16 hours.

The invention will be further described in the following examples, which do not limit the scope of the invention described in the claims.

### EXAMPLES

### Example 1. Mineralocorticoid Receptor Phase Separation Modulates Cardiac Preservation

Heart transplantation is the gold standard treatment for patients with end-stage heart failure, offering excellent quality of life and survival. However, there is a shortage of donor hearts available relative to the number of patients who need a transplant. One reason for this shortage is the short tolerable cold ischemic time for delivering donor hearts to matching recipients. MR phase separation exacerbates injury to the donor's heart during cold storage and can be modulated with pharmacological inhibition to improve preservation quality. MR is highly expressed in donor cardiomyocytes, and transcriptomic responses of different donor cell types to cold preservation are shown. This study shows the occurrence of molecular phase separation and condensate formation is not limited to the heart or MR during preservation. Cold preservation of the lung, liver, and kidney is associated with phase separation of other transcriptional regulators including, histone deacetylase 1 (HDAC1), Brd4, as well as MR. This study shows an understudied area of preservation biology that may be further exploited to improve the preservation of multiple solid organs.

### Materials and Methods

### Research Ethics for Donor Tissues

Human donor heart studies were approved by the University of Michigan Institutional Review Board (HUM00131275) and Mayo Clinic Institutional Review Board (23-006893).

### Animals

Mice: All rodent experiments were approved by the Institutional Animal Care and Use Committee at the University of Michigan-Ann Arbor (PR000010630) and at Mayo Clinic (A00007364-23). Both male and female wild-type C57BL/6J (stock number 000664) were obtained from the Jackson Laboratories. Cardiomyocyte-specific deletion of MR was achieved by breeding Myh6^{CreErt2} mice (stock number 005657) and MR^{f/f} mice.

Pigs: All the pig experiments were approved by the Institutional Animal Care and Use Committee at the University of Michigan-Ann Arbor (PR000009611) and Mayo Clinic (A00007365-23). Male and female Yorkshire pigs weighing 40-50 kg were purchased from the South Campus Animal Farms of the Michigan State University.

### Procurement and Preparation of Human and Pig Heart Tissue

Heart procurement for both human and pigs was performed as a clinical standard. A sternotomy is performed under general anesthesia. The pericardium is then opened to create a pericardial cradle for the heart. Heparin (300 U/kg) is administered through the right atrium (for pigs) or in a peripheral vein (for humans). After waiting 3 minutes for adequate anticoagulation from heparin, a 9 Fr antegrade plegia infusion catheter is placed in the ascending aorta. Approximately 1 liter of autologous donor arterial blood is then collected into a collection bottle containing heparin. The human or pig donor heart is then retrieved per clinical protocol by incising the inferior vena cava to drain the right heart and then the left atrial appendage is incised to drain the left heart. Subsequently, the ascending aorta is cross-clamped distal to the cardioplegia catheter and 1 liter of cold (4° C.) HTK solution is infused into the coronaries at a perfusion pressure of ~100 mmHg to induce mechanical arrest. After excising the heart completely, it is transported to the back table for infusion of 2 liters of HTK+Canrenone solution. After completion, the heart is stored in a solution identical to the perfusate at 4° C. on ice.

Pig hearts underwent ex-vivo perfusion after preservation for 4 or 10 hours. Human heart underwent ex-vivo perfusion after preservation of 10 hours. Heart tissue was sampled from the basal portion of the left ventricular free wall and were either fixed in formalin or snap frozen in liquid nitrogen for later analysis.

Donor hearts with LVEF >50% and from donors <70 years of age were utilized for our experiments. There were no differences between human donor hearts preserved with HTK only (n=5) versus HTK+Canrenone (n=4) in terms of average age (57.8+8.9 years and 52.8+10.0 years respectively, P=0.523 by Mann-Whitney test), left ventricular ejection fraction (60.0+0.7% versus 65.0+4.1% respectively, P=0.404 by Mann-Whitney test) and female sex distribution (60% (3/5) versus 75% (3/4) respectively, P >0.999 by Fisher's exact test). There were no differences in past medical history between the HTK only versus HTK+canrenone group for hypertension (60% (3/5) versus 50% (2/4) respectively, P >0.999), hypercholesterolemia (20% (1/5) versus 0% (0/5) respectively, P >0.999), diabetes (20% (1/5) versus 25% (1/4) respectively, P >0.999), and intravenous drug use (0% (0/5) versus 25% (1/4) respectively, P=0.444) by Fisher's exact test. There were no differences in the cause of death in the HTK only versus HTK+canrenone groups which were intracranial hemorrhage (40% (2/5) versus 25% (1/4) respectively, P=0.206), anoxic brain injury (40% (2/5) versus 50% (2/4) respectively, P=0.167), and trauma (20% (1/5) versus 20% (1/5), P >0.999) by Fisher's exact test.

### Murine Ex-Vivo Heart Perfusion

Male and female WT and Myh6-CreErt2; MR^{f/f} mice were i.p. injected with tamoxifen (80 mg/kg) for 3 constituted days. The mice were then anesthetized with i.p. injection of 100 mg/kg ketamine and 5 mg/kg xylazine, and heparin (2000 U/kg). The mouse heart was rapidly exposed through a sternal incision. The aorta was cannulated and retrograde perfused with 5 mL HTK with/without Canrenone. The heart was stored in HTK with/without Canrenone for 16 hours at 4° C. and then mounted to a Radnotic mouse Langendorff apparatus (ADInstruments inc., Colorado Springs, CO) in constant-pressure mode (~70 mmHg) with a modified Krebs-Henseleit buffer (KHB; in mM: 118 NaCl, 4.7 KCl, 1.25 CaCl₂, 1.66 MgSO₄, 24.88 NaHCO₃, 1.18 KH₂PO₄, 5.55 glucose, and 2.0 Na-pyruvate). A balloon was placed in the LV through the left atrium and left ventricular diastolic pressure was set to ~8 mmHg at initiation. The heart was perfused with modified Krebs-Henseleit buffer for 30 minutes to stabilize and then hemodynamics measurements were recorded. Myocardial temperature was maintained at 37° C. LabChart software (ADInstruments inc., Colorado Springs, CO) was used to record ventricular function, perfusion pressures, cardiac chamber temperature and myocardial temperature. After perfusing the heart for 60 minutes, the heart was removed from the ex-vivo perfusion apparatus for specimen collection. The entire left ventricular free wall tissue was also subsequently snap frozen in liquid nitrogen for analysis. No visual differences in the size or outward appearance of the C57BL/6J control and the MR knock out or AAV infected murine hearts was observed.

Sex-based differences in ex-vivo murine cardiac function was examined outlined in FIGS. 1D-1E There were no female (n=4) versus male (n=4) differences in MR^{f/f} hearts preserved with HTK in terms of ex-vivo max dP/dt (344.4±575.3 vs. 4293±1280.0 mmHg/s respectively, P=0.48) or minutes dP/dt (~240.6±300.0 vs. −216.1±31.9 mmHg/s respectively, P=0.48). Additionally, no sex difference was seen with Myh6^{CreErt2}; MR^{f/f} hearts for max dP/dt (1793.6±764.0 vs. 1510.2±1020.9 mmHg/s respectively, P==0.69) or minutes dP/dt (−948.2±256.8 vs. −855.2±519.5 mmHg/s respectively, P=0.49). Comparisons were performed using the Mann-Whitney test.

### Murine Heterotopic Heart Transplantation

The murine heterotopic heart transplant was performed as previously described. Cardiac grafts procured from WT C57Bl/6J mice following arrest with cold (4° C.) HTK with/without Canrenone were transplanted into the right neck of sex-matched syngeneic C57BL/6J recipient mice following 16 hours of cold (4° C.) preservation in corresponding HTK with/without Canrenone. The donor ascending aorta and pulmonary artery was connected to recipient right common carotid artery and right external jugular vein, respectively. Following reperfusion in the recipient, successful grafts were expected to resume a regular heartbeat. At 24 hours after reperfusion, the surgical incision was reopened and a small conductance catheter was introduced into the LV to measure contractility and relaxation. The entire left ventricular free wall tissue was also subsequently snap frozen in liquid nitrogen for analysis.

Sex-based differences in the function of transplanted syngeneic hearts was examined outlined in FIGS. 1F-1G. There were no female (n=2) versus male (n=5) differences in MR^{f/f} hearts preserved with HTK in terms of ex-vivo max dP/dt (854.8±54.6 vs. 861.2±380.8 mmHg/s respectively, P=0.86) or minutes dP/dt (~492.8±91.1 vs. −455.3±251.1 mmHg/s respectively, P=0.86). Additionally, no sex difference was seen with Myh6^{CreErt2}; MR^{f/f} hearts for max dP/dt (1949.9±838.0 vs. 1642.8±447.6 mmHg/s respectively, P=0.79) or minutes dP/dt (~1047.5±418.2 vs. −1073.6±217.6 mmHg/s respectively, P=0.49). Comparisons were performed using the Mann-Whitney test.

Sex-based differences in the function of transplanted syngeneic hearts was examined outlined in FIG. 12D. There were no female (n=4) versus male (n=4) differences in murine hearts preserved with HTK only in terms of ex-vivo max dP/dt (990.4±849.5 vs. 1041.4±570.0 mmHg/s respectively, P=0.89) or minutes dP/dt (~559.7±455.6 vs. −527.9±314.5 mmHg/s respectively, P=0.89). Furthermore, no sex difference was seen with HTK+canrenone preservation for max dP/dt (2100.4±564.5 vs. 2219.1±411.7 mmHg/s respectively, P=0.56) or minutes dP/dt (~1172.7±82.5 vs. −1072.9±262.1 mmHg/s respectively, P=0.73). Comparisons were performed using the Mann-Whitney test.”

### Porcine and Human Ex-Vivo Heart Perfusion

For ex-vivo pig and human heart perfusion, the ascending aorta is connected to the arterial perfusion cannula and the left atrium is closed by suturing shut the pulmonary veins. A pressure monitoring catheter and left atrial infusion catheter were then placed into the left atrial cavity and secured. The Miller conductance catheter was introduced into the left ventricular cavity for measurement of ventricular performance parameters. The Radnoti constant perfusion pressure apparatus (ADInstruments Inc., Colorado Springs, CO) was used for ex-vivo large animal heart perfusion. Approximately 1 liter of previously collected autologous blood was added to ~3.5 liters of Krebs buffer and this was initially infused at 24° C. with gradual warming to 37° C. After air was removed from the perfusion system, the ascending aorta and coronaries were retrograde perfused through the arterial cannula at physiological pressure ~80 mmHg, leading to cardiac reanimation. The perfusion pressure was kept constant at ~80 mmHg so LV contraction would need to overcome this afterload for cardiac output. Shockable arrhythmias such as ventricular tachycardia, ventricular fibrillation, supraventricular tachycardia was electrically cardioverted to sinus rhythm by delivery of 10 or 20 joules of energy.

Cardiac performance was assessed in “resting” and “working” modes as previously described by our group. The left atrial pressure in resting mode was typically 0-1 mmHg. To assess cardiac hemodynamics in “working mode”, perfusate was infused into the left atrium at 4-mmHg at the 4-hour time point for LV loading and cardiac output assessment. Because cardiac performance was highly impaired as expected at the 10-hour time point, the left atrium was loaded to a pressure of up to 15 mmHg to assess cardiac output. At 1 hour intervals, both arterial perfusate and coronary sinus blood were collected for monitoring and analysis. Oxygen pressure was kept at about pO₂ 150-200 mmHg while pCO₂ was kept at about 35-40 mmHg. Arterial pH was maintained at 7.35-7.40 by buffering with 5% CO₂ during gas exchange. The heart was perfused ex-vivo for 3 hours and then arrested with 4° C. HTK solution for specimen collection in formalin or snap frozen with liquid nitrogen. The heart was weighed at the time of procurement and at the end of perfusion.

Sex-based differences were examined in porcine cardiac function outlined in FIGS. 13A and 13B. There were no female (n=:3) versus male (n=:5) differences following 4 hours porcine heart preservation with HTK only for ex-vivo max dP/dt (1714.3±376.3 vs. 1711.6±150.1 mmHg/s respectively, P=0.57) or minutes dP/dt (~1080.7±120.3 vs. −1099.7±379.6 mmHg/s respectively, P=0.79). Additionally, no sex difference was seen with HTK+canrenone preservation for max dP/dt (2113.7±251.1 vs. 2108.7±410.0 mmHg/s respectively, P>0.99) or minutes dP/dt (~1390.1±52.1 vs. −1360.1±129.2 mmHg/s respectively, P>0.99).

Sex-based differences were examined in porcine cardiac function outlined in FIGS. 4A-4B. There were no female (n=3) versus male (n=:5) differences after 10 hours of porcine heart preservation with HTK only for ex-vivo max dP/dt (552.5±399.5 vs. 611.5±442.1 mmHg/s respectively, P=0.79) or minutes dP/dt (~434.8±359.3 vs. −471.5±282.2 mmHg/s respectively, P>0.99). Furthermore, no sex difference was seen with HTK+canrenone preservation for max dP/dt (1624.8±147.9 vs. v 1648.8±269.0 mmHg/s respectively, P=0.79) or minutes dP/dt (−1352.71253.0 vs. −1232.91213.0 mmHg/s respectively, P=0.57). Comparisons were performed using the Mann-Whitney test.”

### Mouse Serum Assay and Pig Human Perfusate Assay

Blood from recipient mice was centrifuged at 3000 g in 4° C. for 10 minutes. Serum was aliquoted and snap-frozen. Serum cTnI, and TNF-α concentrations were measured using Sigma-Aldrich MILLIPLEX kits (Cat. No.: MCYTMAG, MCVD2MAG). Pig and human arterial perfusate was centrifuged at 3000 g in 4° C. for 10 minutes. The abundance of cTnI was detected using Sigma MILLIPLEX kit (Cat. No.: HCVD1MAG). Blood from mice was obtained during the time of sacrifice at 24 hours after heterotopic syngeneic heart transplantation, Pig and human perfusate samples were collected at 3 hours just prior to end of ex-vivo perfusion.

### Human Blood Collection for Measurement of Serum Osmolality

Human blood was collected in left ventricular assist patients (LVAD) intraoperatively prior to making incision for LVAD implantation surgery. Human donor blood was collected prior to incision for organ procurement. Blood was spun down at 2000 xG for serum collection. Serum osmolality was measured using the Precision Systems™ Touch Micro-Osmette™ Osmometer (Model 6002; Natick, Massachusetts, United States) as per manufacturer instructions. There were no differences between LVAD patients (n=11) and human donor (n=11) in terms of average age (60.9±7.6 years and 54.5±12.6 years respectively, P=0.133 by Mann-Whitney test), and female sex distribution (36.4% (4/11) versus 54.5% (6/11) respectively, P=0.670 by Fisher's exact test). Comorbidities between LVAD patients versus human donors were similar in terms of hypertension (36.4% (4/11) versus 45.5% (5/11) respectively, P=1.000), hypercholesterolemia (27.3% (3/11) versus 9.1% (1/11) respectively, P=0.586), and diabetes (9.1% (1/11) versus 9.1% (1/11) respectively, P=1.000) by Fisher's exact test.

### Preservation Solution Collection for Osmolality Analysis During Human Donor Heart Preservation

Preservation solution at the baseline time point was collected after initial cardioplegic arrest of the donor heart at the baseline time of procurement. After 10 hours of cold storage, preservation solution was again sampled in a pair-wise manner from the same preservation solution bath in which the donor heart lies. Preservation solution osmolality was measured using the Precision Systems™ Touch Micro-Osmette™ Osmometer (Model 6002 Model 6002; Natick, Massachusetts, United States) as per manufacturer instructions. Demographics and comorbidities information for the donors are as follows: Age 55.8±9.2 years; Sex 75% (6/8); Hypertension 50% (4/8); Hyperlipidemia 0% (0/8); Diabetes 12.5% (1/8).

### Plasmid

pET30 expression vector was used as backbone of protein expression plasmids. GFP without stop codon, 14 amino acid linker sequence (GAPGSAGSAAGGSG), full-length MR or MRΔIDR (a.a.1-599 of MR is deleted) was cloned into pET30 using NEB HIFI builder mix. The GFP was in the N-terminal of fused protein and the MR or MRΔIDR was in frame with GFP.

### Protein Purification

The purification of protein is performed as previously described. For protein expression, pET30 plasmids containing the GFP, GFP-MR or GFP-MRΔIDR were transformed into LOBSTR cells. A fresh colony was inoculated into LB media with kanamycin and chloramphenicol for 8 hours. The cells were added to 500 mL LB with 1 mM IPTG for 18 hours of culture at 16° C. Cells pellets were resuspended in 15 mL of denaturing buffer (50 mM Tris pH7.5, 300 mM NaCl, 10 mM imidazole, proteinase inhibitor), and sonicated at 10 cycles of 15 seconds on and 60 seconds off. The lysate was centrifuged at 12000 g for 30 minutes at 4° C. The supernatant was incubated with pre-equilibrate Ni-NTA agarose, and rotate at 4° C. for 1.5 hours. The agarose was centrifuge at 3000 rpm for 10 minutes, and wash with 5 mL of wash buffer (50 mM Tris pH7.5, 300 mM NaCl, 50 mM imidazole, proteinase inhibitor). The protein was eluted with 3 times of elution buffer (50 mM Tris pH7.5, 300 mM NaCl, 250 mM imidazole, proteinase inhibitor). The fusion proteins were concentrated in 50 mM Tris pH7.5, 125 mM NaCl and 1 mM DTT buffer using Amicon Ultra centrifugal filters (30K MWCO, Sigma) with 3 times of centrifuge in the buffer. The purified proteins were then used for further examination.

### Turbidity Measurements

The turbidity of protein solutions was determined as the absorption at 340 nm using a Promega GloMax plate reader. The recombinant proteins were diluted to two times of the final concentration (1,3, 10.30 uM) in 50 mM Tris-HCl pH7.5, 10% Glycerol, and 1 mM DTT. The samples were then diluted with one volume of 20% PEG-8000 and 250 mM NaCl for turbidity measurement.

In Vitro Droplet Imaging and Fluorescence Recovery after Photobleaching (FRAP)

Recombinant GFP, GFP-MR, GFP-MRDIDR proteins were diluted to 20 uM in in 50 mM Tris-HCl pH7.5, 10% Glycerol, and 1 mM DTT on ice. The proteins were then diluted with one volume of 20% PEG-8000 and 250 mM NaCl. The protein solution was added to a glass slide with an imager spacer and sealed with a coverslip. The slide was analyzed using Nikon A1 confocal after 5 minutes of incubation. For FRAP, specific droplets were bleached using 40% intensity, and images were collected every other second for 60 seconds. Fluorescence intensity at the bleached and unbleached spots was measured using the NIS element software. The values were then normalized to the intensity at the initial time before bleaching.

### Fluorescence Immunohistochemistry

The mice, pig or human hearts were embedded with Optimal Cutting Temperature compound at −70° C. and sectioned into 7 m slides using cryostat. For immunofluorescence, the sections fixed in precolded methanol for 10 minutes. Slides were boiled in 10 mM citrate buffer pH6.0 for 10 minutes for antigen retrieval. The slides were blocked with 5% bovine serum albumin, and incubated with the following antibodies at 4° C. overnight: anti-NR₃C₂ antibody (1:100 dilution, Sigma, AV45599; or CST, 58883S), anti-8OHdG (1:100, Santa Cruz, sc393871), anti-HDAC1 (1:100 dilution, CST 34589), anti-Brd4 (Abclonal, A20019). (Sigma MR antibody (catalog number: AV45599) targets the antigen located at the DNA binding domain of MR protein. This targeted sequence consists of: “RRKNCPACRLQKCLQAGMNLGARKSKKLGKLKGIHEEQPQQQQPPPPPPP”, (aa651-691)). After three washes with phosphate buffered saline, a secondary antibody conjugate with Alexa Fluor 488/647 was applied for 1 h. The sections were mounted with anti-fade mounting medium (Thermofisher Scientific, P36930) for image evaluation using the BZ-X800 (Keyence)/LSM 980 microscope. The images were analyzed with ImageJ software for staining intensity quantification and enumeration of positively stained cells.

### Western Blotting

Proteins were extracted in lysis buffer (50 mM pH 7.4 Tris-HCl, 150 mM NaCl, 1% Triton X-100, 1% sodium deoxycholate, 0.1% SDS, 10 mM 2-Mercaptoethanol, 1.0 mM PMSF, 1× complete EDTA free proteinase inhibitor cocktail (Roche)) followed by centrifugation at 4° C. for 15 minutes at 12,000 rpm. Total protein concentration was measured by Bradford assay and g of protein was then separated by SDS-PAGE for transferred to polyvinylidene difluoride (PVDF) membranes. The membranes were blocked with 5% nonfat dry milk and then incubated with primary antibodies overnight at 4° C. After washing with tris-buffered saline and Tween (TBST), the membranes were incubated with secondary antibody (in TBST solution at room temperature. The membranes were then quantified by Azure Image System. Primary antibodies utilized include α-tubulin (Cell Signaling Technology, 3873), Bcl2 (CST, 3498), Cleaved Caspase 3 (Abclonal, A2156), phosphor-JNK (CST, 9251), total JNK (CST, 9252), phosphor-Erk1/2 (CST, 4370), total Erk1/2 (CST, 4696) and MR (Sigma, AV45599). Secondary antibodies include: IRDye® 680RD Donkey anti-Mouse IgG (LI-COR Biosciences, 926-68072), IRDye® 800CW Donkey anti-Rabbit IgG (LI-COR Biosciences, 926-32213), Peroxidase AffiniPure Donkey Anti-Mouse IgG (Jackson ImmunoResearch Laboratories, 715-035-150), Peroxidase AffiniPure Donkey Anti-Rabbit IgG (Jackson ImmunoResearch Laboratories, 715-035-152).

### Adeno-Associated Virus 9 Packaging and Delivery

The full-length MR, MRDIDR (MR lacking a.a.1-599), and MRDLBD (lacking a.a 726-984) coding sequences were amplified from mouse heart cDNA and cloned into the AAV9 plasmid (AAV9:cTNT:3Flag-hYAP S127A, Addgene, 86558). Gene expression was driven by cTnT promoter. The hYAP S127A was replaced by MR and MRDIDR and the 3xFlag was kept for protein identification. Viral particles expressing MR, MRDIDR, MRDLBD and Luciferase were produced by the University of Michigan vector core or VectorBuilder. 1×10¹² viral particles were i.p. injected into 10-weeks-old Myh6^{CreErt2}; MR/mice. After 2 weeks, the mice were treated with tamoxifen (80 mg/kg) for 3 days, and then used ex-vivo perfusion study.

### NMCM and NRCM Isolation

Neonatal mice pups were obtained by crossing C57BL/6J mice in our animal facility, and the neonatal rat pups were from the timed-pregnant rat purchased from Charles River Laboratories. Isolation of NMCM and NRCM followed a similar protocol except for neonates. The neonate was immersed and disinfected with 70% ethanol, the chest of the neonate was opened by tweezer, and then the heart was removed with a sterile tweezer and placed in cold PBS. After gentle squeezing to remove excess blood, the heart was cut into small pieces and incubated with Trypsin Ethylenediaminetetraacetic acid (EDTA) at 4° C. overnight. On the second day, Trypsin was removed, and heart tissues were washed with Hanks' Balanced Salt Solution (HBSS). The heart tissue was then incubated in 15 mL 1 mg/mL collagenase II/HBSS at 37° C. with stirring for 15 minutes. The tissues were transferred into 50 mL tube, and 15 mL of 10% fetal bovine serum (FBS) in Dulbecco's Modified Eagle Medium (DMEM). The tissues were centrifuged and resuspended in a culture medium and passed through a 70 uM cell strainer. Cells were cultured at 37° C. for 45 minutes to allow fibroblast attachment to the plate. Then the supernatant containing cardiomyocytes were then transferred to a new dish for another 45 minutes. After repeating this process twice, purified cardiomyocytes from the third supernatant were then counted and seeded at a density of 1 million cells per 10 cm². Once the cardiomyocytes were attached to the dish, the culture medium was changed to 5% Horse serum in DMEM.

### Single Nuclei RNA-Seq

The human heart tissues were collected from basal free wall of the left ventricle in donor hearts stored at baseline and 10 hours stored in HTK with or without canrenone (n=3 per group). The single nuclei were isolated from these flash-frozen tissues and then followed by chromium 10× library preparation using fix RNA profiling platform in the Advanced Genomic Core at the University of Michigan. Libraries were then sequenced using NovaSeq 6000 (Illumina; San Diego, California, United States). The raw sequencing results were aligned to human genome GRCh 38 and aggregated with CellRanger v7.1.0³. The count matrix was further procession with Seurat v4.4.0. The cells were filtered with RNA count <25000, RNA count >1000, and % of mitochondrial gene <5%. The filtered library was normalized with the freely available open-source R package SCTransform (github.com). UMAP was used to visualize data for dimension reduction. FindClusters function was used for cluster detection with the default resolution (0.8). In addition to the graphical display, using the FindMarkers function in the Seurat package to perform differential expression gene (DEG) analysis among phenotype-associated subpopulations. The Wilcoxon Rank Sum test was implemented in the FindMarkers function to evaluate the statistical significance of DEG. Thus, the top DEGs in each cluster were assessed and statistical significance was defined as Bonferroni adjusted P value <0.05. Cell types were annotated for each cluster based on the highest positive fold changes and correlated with relevant specific cell markers described in the literature. The default parameters for FindMarkers were used which were Wilcoxon rank-sum test (two-sided), 0.25 for the log 2 fold change cutoff, 0.10 for the parameter ‘min.pcf’, and Bonferroni adjusted p-value less than 0.05. DEG changes between conditions including HTK versus HTK+canrenone preservation as well as preservation duration comparing baseline versus 10 hours were also analyzed using FindMarkers function.

### Pseudotime Trajectory Analysis

Slingshot was used to order the pseudotime trajectories of cardiomyocytes and identified gene expression patterns that were altered by canrenone during preservation. Cells isolated from donor hearts at the baseline time point served as the cluster starting point. The cell density was plotted in pseudotime order to compare the progression distribution difference of cardiomyocytes in HTK and HTK+canrenone using Komogorov-Smirnov test. To assess the significant changes in gene expression between HTK and HTK+canrenone alongside the pseudotime, the conditionTest function was used in tradeseq package. The DEG was identified with fold change >2 or <1/2 and fdr <0.05 with Benjamini & Hochberg correction. The significant DEGs was then visualized using the smoothed expression patterns using the heatmap function.

### CUT&RUN Sequencing

The CUT&RUN-seq was performed using Epicypher kit (SKU: 14-1048). The nuclei were isolated from flash-frozen human heart tissues and fixed with 0.1% formaldehyde for 1 minutes. Antibody against MR (Sigma, AV45599) was performed to characterize MR binding sites. The released CUT&RUN DNA was used for sequencing library preparation with NEBNext Ultra II DNA Library Prep Kit (E7103, NEB) and sequencing with 2×150 bp paired-end mode. The sequencing results was trimmed using Trimmomatic and aligned to the human genome using bowtie2 with dovetail function. The peaks were called with MACS3. The heatmaps were generated using Deeptools.

### Metabolomic Analysis

One milligram (+0.1 mg) of each of the HKT or HKT+canrenone swine or human left ventricle tissues was suspended in 500 μL of ice-cold methanol containing internal standards (5 μL Splash Lipidomix (Avanti Polar Lipids), 2 μL of 500 μM NSK-A heavy amino acid mix (Cambridge Isotope), 50 ng acylcarnitine 18:1 d3 (Caymen Chemical), and 10 ng each of C12:0-d23, C14:0-d27, C16:1-d14, C18:1-d17, and C18:0-d35 (Caymen Chemical)). Two 9 mm ceramic beads were added to each sample, which were then homogenized using bead beating (S=0.8, T=5 minutes, D=0 minutes, cycles=1). One milliliter of ice-cold chloroform was added to each sample, vortexed and incubated for 10 minutes on ice. Phase separation was induced by adding 200 μL of water, samples vortexed, and centrifuged at 2000 g for 2 minutes. The organic (containing primarily lipids) and aqueous (containing primarily metabolites) phases were removed and each dried in vacuo.

The organic phase was resuspended in 200 μL 1:5 chloroform:methanol and the aqueous phase was resuspended in 1:1 acetonitrile:water. Both phases were analyzed using an Acuity ultra-performance liquid chromatography (UPLC) system (Waters, Milford, MA, USA) coupled with a MaXis II quadrupole-time-of-flight (Bruker, Bremen, Germany) mass spectrometer. Mass spectral data in both positive and negative modes were collected at 3 Hz within a window ranging from m z 50-1300. Organic phase extracts were separated via reversed-phase chromatography (RPLC) using an ACUITY UPLC HSS T3 (150 mm length, 1 mm inner diameter, 1.8 μm particle size, 100 Å pore size, Waters, Milford, MA, USA) column using a 30 minute gradient (0-10′ 50-82% B, 10-20′ 82-99% B, 20-25′ held at 99% B, 25-25.1′ 99-50% B, 25.1-30′ held at 50% B) at 30 μL/minute flow. In positive mode, mobile phase A was 0.1% formic acid and 10 mM ammonium acetate in 6:4 acetonitrile:water and mobile phase B was 0.1% formic acid and 10 mM ammonium acetate in 9:1 2-propanol:acetonitrile. In negative mode, mobile phase A was 10 mM ammonium acetate in 6:4 acetonitrile:water and mobile phase B was 10 mM ammonium acetate in 9:1 2-propanol:acetonitrile. Aqueous phase extracts were separated via hydrophilic interaction liquid chromatography (HILIC) using an ACUITY UPLC BEH Amide column (150 mm length, 1 mm inner diameter, 1.7 μm particle size, 130 Å pore size, Waters, Milford, MA, USA) operating on a 30 minutes gradient (0-0.5′ held at 99% B, 0.5-25′ 99-30% B, 25-25.1′ 30-99% B, 25.1-30′ held at 99% B) at 30 μL/minute. Mobile phase A was 0.1% formic acid in acetonitrile and mobile phase B was 0.1% formic acid.

Raw mass spectral data was processed in Bruker MetaboScape software (Bruker Daltonics) and deposited into MassIVE server (MSV000096745). Bucket lists were generated using the software's T-ReX 3D algorithm for positive and negative modes individually, then merged after feature table assessment (≤5.0 ppm mass error, 30 sec retention time). Annotations of known metabolites were performed in MetaboScape by search-matching collected tandem MS data with public metabolite databases from MassBank (via the in-program MCube Spectral Library Annotation Method). Positive mode libraries included MoNA-export-LipidBlast_2022, Bruker NIST 2020 MSMS Spectral Library, Bruker MetaboBASE Personal Library 3.0, Bruker HMDB Metabolite Library 2.0, MoNA-export-In-Silico-Spectra, MoNA-export-MassBank, MoNA-export-HMDB, Bruker MetaboBASE 2.0 in-silico, MoNA-export-LC-MS-MS_Positive_Mode, MSMS_Public_ExpBiolnsilico_Pos_VS17, MSMS-Pos-Fiehn HILIC, MSMS-Pos-GNPS. Negative mode libraries included MSMS-Neg-GNPS, MSDial-TandemMassSpectralAtlas-VS69-Neg, MSMS_Public_Biolnsilico Neg_VS17, MoNA-export-LipidBlast_2022, Bruker NIST 2020 MSMS Spectral Library, Bruker MetaboBASE Personal Library, MoNA-export-LC-MS-MS_Negative_Mode, MoNA-export-LC-MS-MS Negative Mode, MSMS-Neg-FiehnHILIC, Bruker HMDB Metabolite Library 2.0, MoNA-export-In-Silico_Spectra, MoNA-export-MassBank, MoNA-export-HMDB, MoNA-export-LC-MS-MS_Negative Mode, Bruker MetaboBASE 2.0_in-silico. Metabolite intensities were normalized using the Probabilistic Quotient Normalization function in MetaboScape after manual identification and annotation of spiked standards. Significantly altered metabolites were determined in MetaboScape using a T-test (adjusted p-value <0.5).

### Statistical Analysis

Statistical evaluation of experimental data was performed using Prism 10.0 (GraphPad Software). Individual data points were used in respective figures. Means comparison between groups was analyzed via Mann-Whitney U test, or analysis of variance (ANOVA) followed by Tukey's multiple comparison test as described in the figure legends. Comparisons for 2 groups will use Mann-Whitney U test while >3 groups will use one-way ANOVA with post hoc analysis. P values of <0.05 were deemed significant. Figure legends provide the exact P values, definition, and number of replicates corresponding to each dataset.

Sample size estimates accounts for the variability in multiple physiological and biomolecular endpoints. Given the parameter variability in human and animal cardiac hemodynamic and biological responses shown by other research groups, and our previous published studies, a sample size of about 7-8 animals per group will allow detection of 10-15% difference with significance (a)=0.05 and power=0.80. For example, our prior studies showed that effective improvement of cardiac performance is expected to demonstrate a >15% difference between control and treatment groups for hemodynamic data (e.g., maximum and minimum dP/dt).

### Results

Clinical use of ex-vivo normothermic human heart perfusion platforms has reduced the period of cold ischemia. However, mechanical arrest induced by cold preservation solutions remains necessary to facilitate the placement of donor hearts onto the perfusion system. Upon arrival at the recipient hospital, the heart must be re-arrested to disengage it from the apparatus before transplantation, introducing an unavoidable period of ischemia.

Ischemic mechanical arrest caused by preservation solution-induced disruption of cardiac action potentials at cold temperatures may lead to alterations in physical molecular interactions. Liquid-liquid phase separation (LLPS) in biological systems is a reversible thermodynamic process in which molecularly dense condensates and dilute liquid phases separate under specific biophysical conditions. These events facilitate more efficient signaling among proteins, nucleic acids, and receptor-ligand pairs, leading to the formation of membraneless organelles. In the context of organ transplantation, protein concentration and ambient temperature are key determinants of molecular condensate formation through LLPS.

LLPS is influenced by intrinsic disordered regions (IDRs) within proteins, which contain polar and charged amino acids interspersed with aromatic residues. These regions enable proteins to coalesce via weak bonds, forming dynamic and flexible conformations without adopting a fixed three-dimensional structure. Multivalent interactions between macromolecules further enhance phase separation. Additionally, increased protein expression can reach a saturation threshold that drives phase separation under specific conditions. These factors collectively contribute to condensate formation.

The NH₂-terminal domains of steroid hormone receptors, including MR, contain IDRs with multivalency, including ligand and DNA-binding domains. Phase separation has been previously demonstrated for glucocorticoid, androgen, estrogen, and progesterone receptors. Biomolecular enrichment within condensates increases spatial proximity, facilitating biochemical processes such as transcription. LLPS has been identified as a biological mechanism that may influence graft quality following preservation.

Clinical and translational studies indicate that MR plays a role in myocardial dysfunction and heart failure. However, its specific function in donor heart preservation remains poorly characterized. Recent findings indicate that MR signaling is amplified through LLPS and condensate formation during cold preservation, contributing to donor heart dysfunction. MR activation promotes oxidative stress, inflammation, cell death, and endothelial dysfunction. Pharmacological inhibition of MR signaling has been shown to improve donor heart function and enhance ischemic tolerance. Single-cell transcriptomic analysis has identified cardiomyocytes as a primary source of detrimental MR signaling. Additionally, LLPS and condensate formation have been observed in the preservation of multiple solid organs, suggesting a fundamental role in determining organ preservation quality.

### MR Mediates Cardiac Preservation Quality

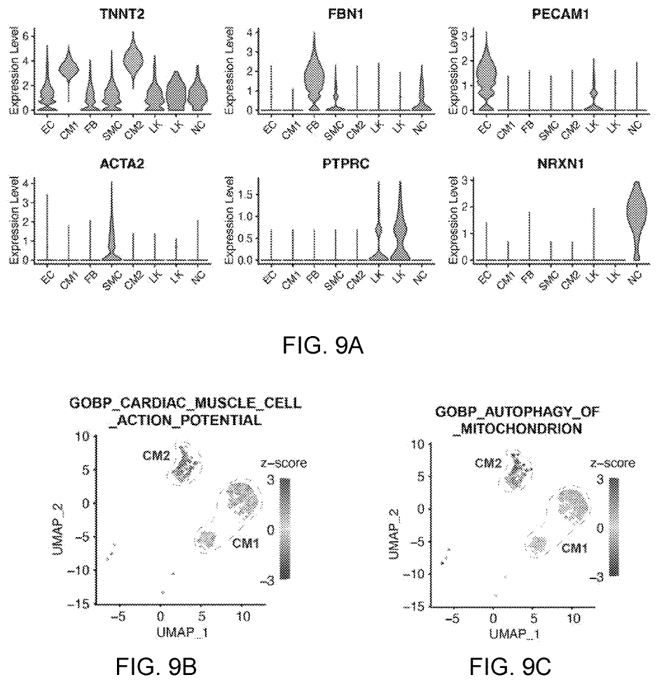

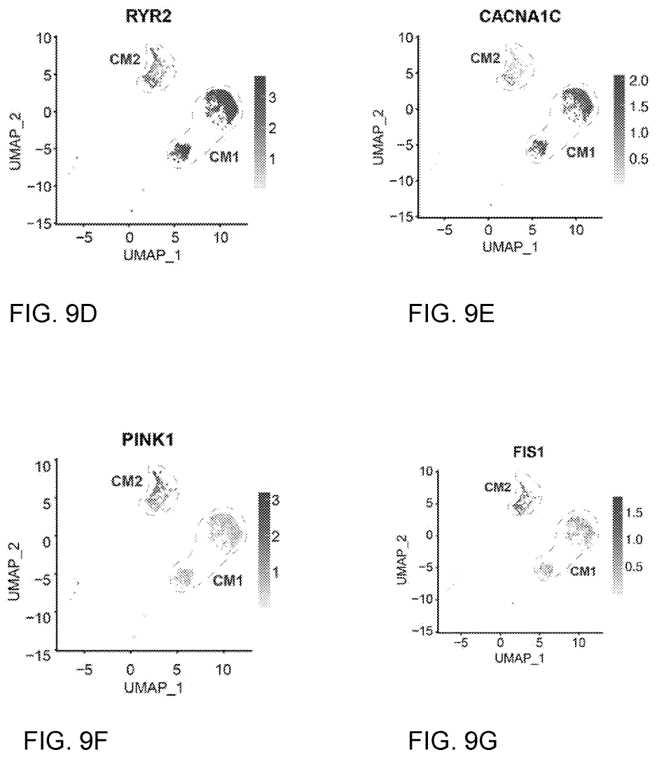

Single-cell transcriptomics on cold preserved human hearts was performed to identify major cell populations based on respective markers such as cardiomyocytes (TNNT2⁺), fibroblast (FBN1⁺), endothelial cells (PECAM1⁺), smooth muscle cells (ACTA2⁺), Leukocytes (PTPRC (CD45⁺)), and neuronal cells (NRNX1⁺, FIG. 9A). Cluster analysis further revealed two distinct cardiomyocyte populations (CM1 and CM2) based on transcriptomic profiles. Gene Set Enrichment Analysis (GSEA) showed that CM1 gene expression profile had a predilection for pathways mediating cardiac contractility while CM2 favored the expression of mediators associated with autophagy and mitochondrial energetics FIG. 1B, FIGS. 9B and 9C). This was exemplified by CM1 having a higher expression of RYR2, a calcium channel protein important for excitation-contraction coupling as well as CACNA1C, a calcium channel component (FIGS. 9D and 9E). Conversely, CM2 is distinguished by a prominent expression of PJNK and FIS1 which are associated with mitophagy (FIGS. 9F and 9G). Interestingly, MR expression was preferentially expressed in the CM1 population (FIG. 1C, pₐdⱼ=1.1×10⁻⁴⁸, log₂FC=1.52).

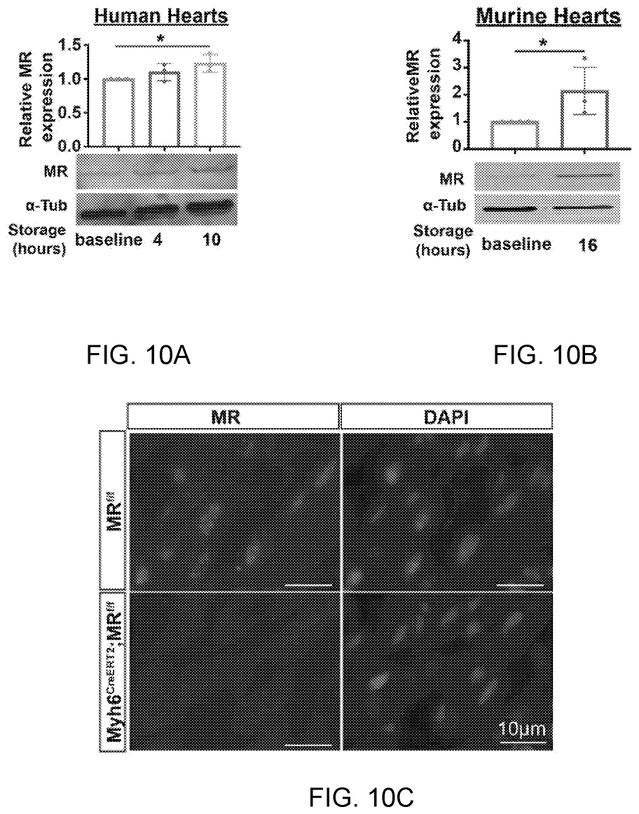

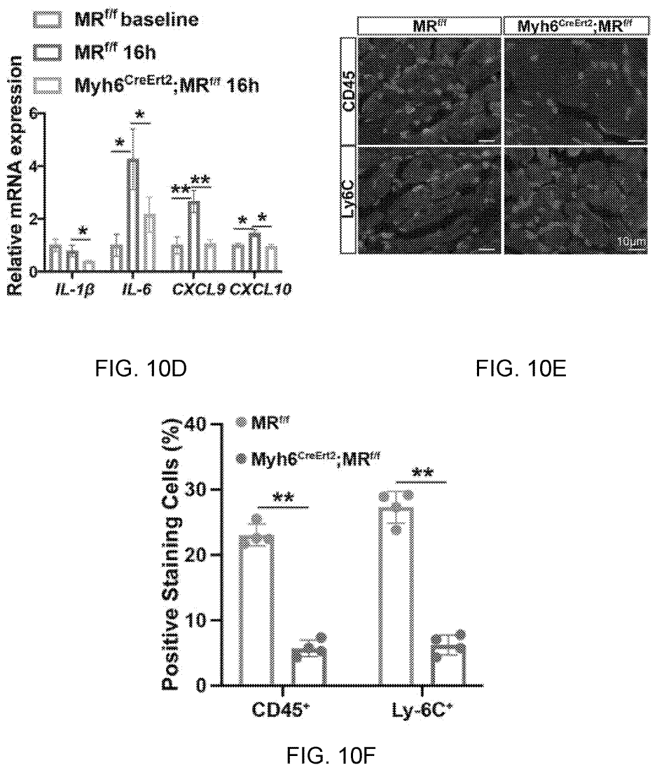

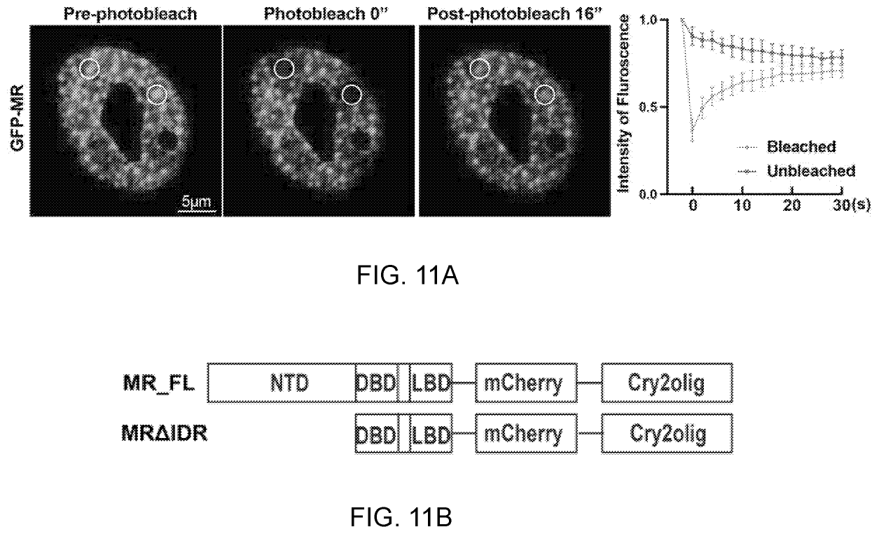

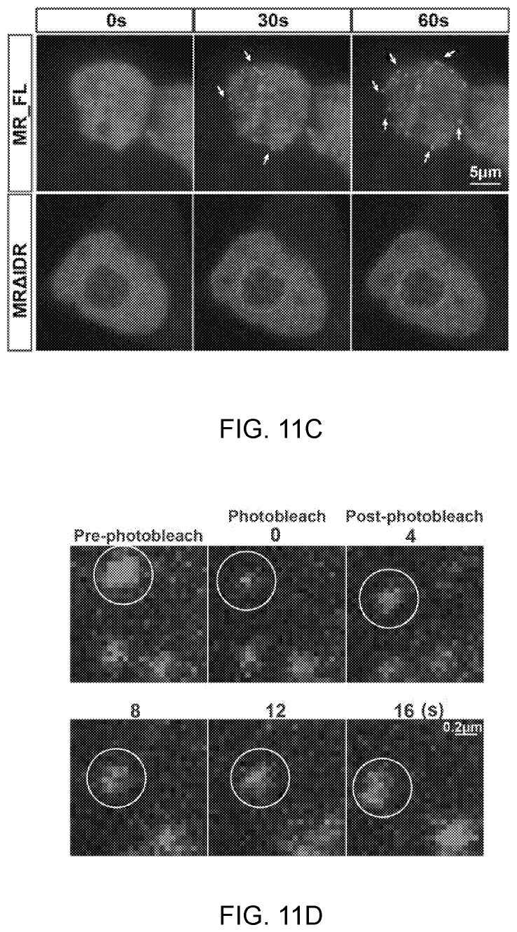

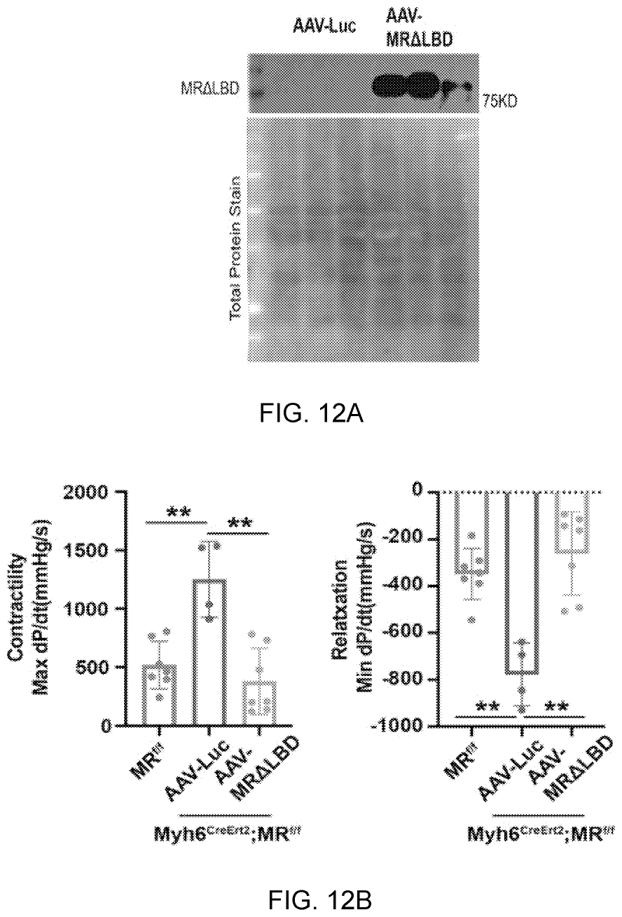

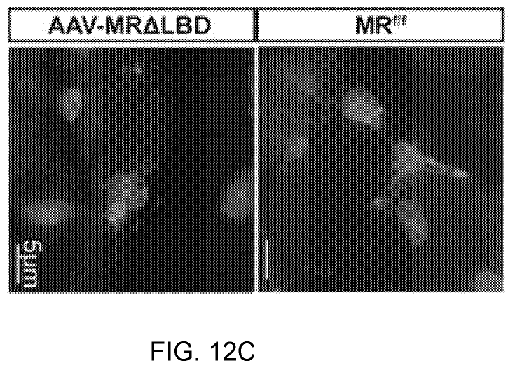

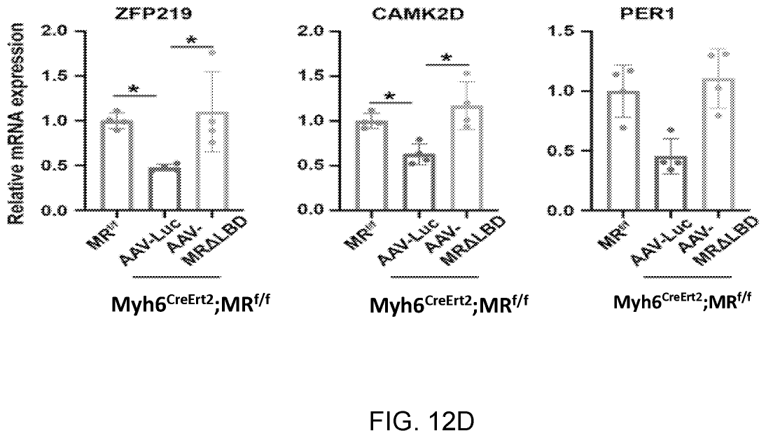

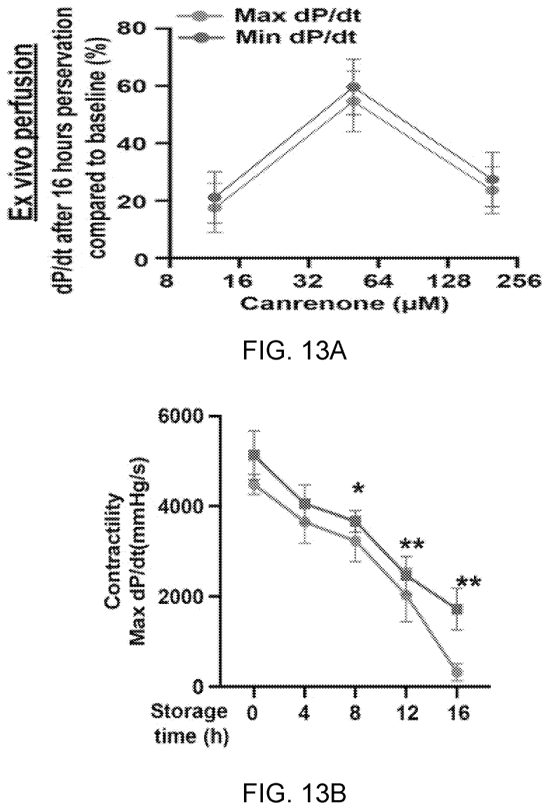

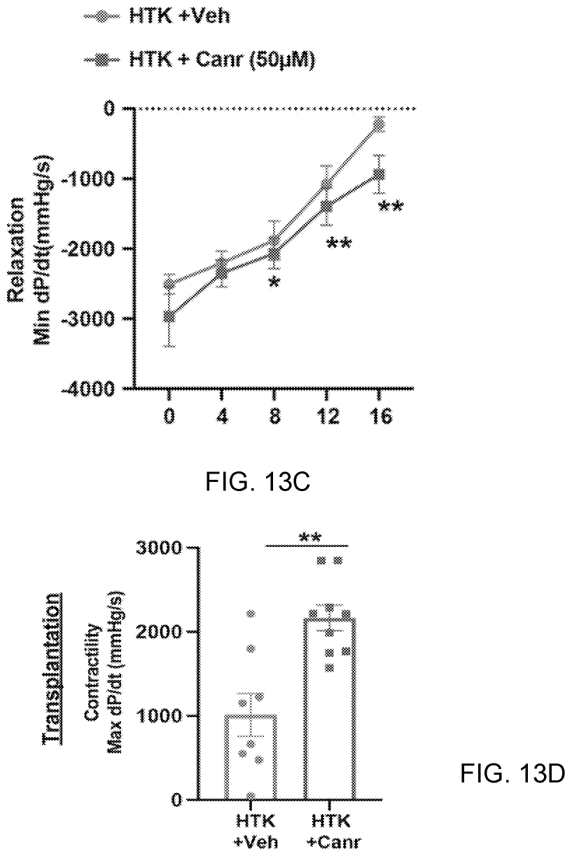

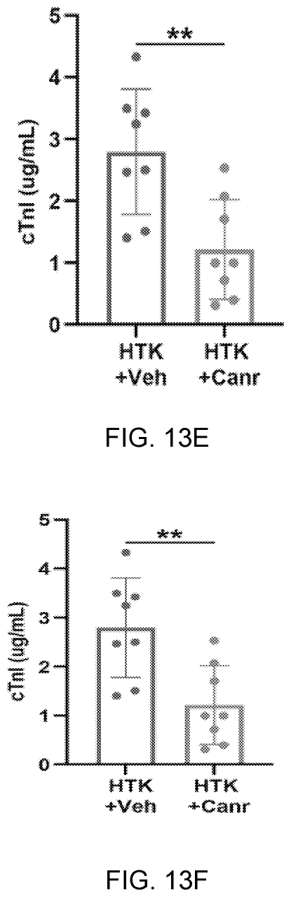

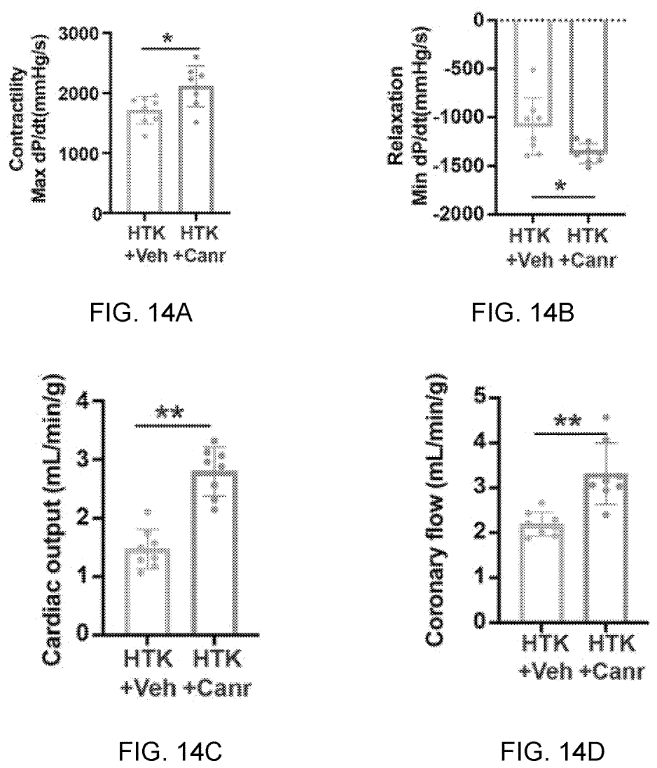

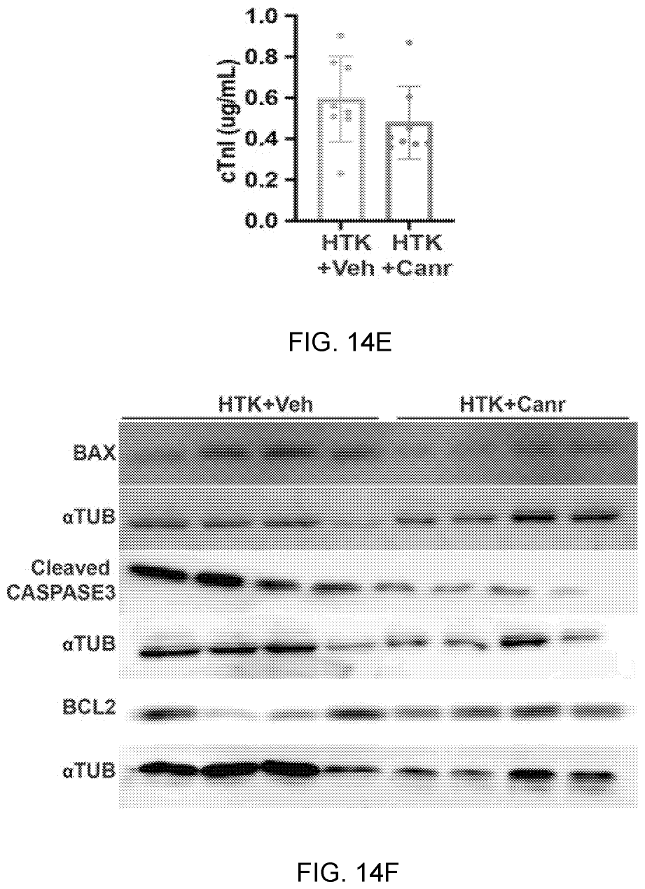

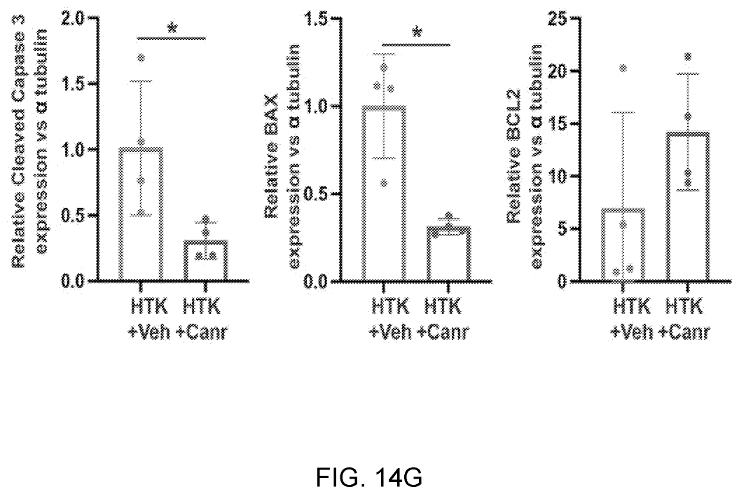

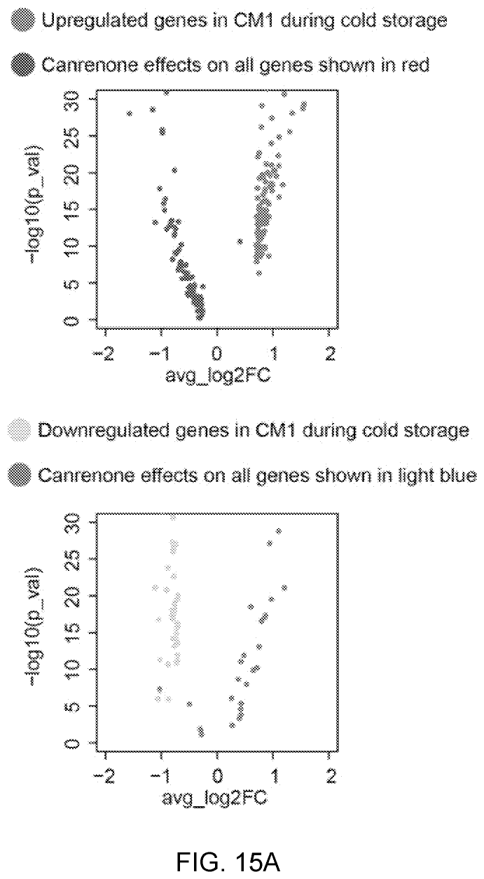

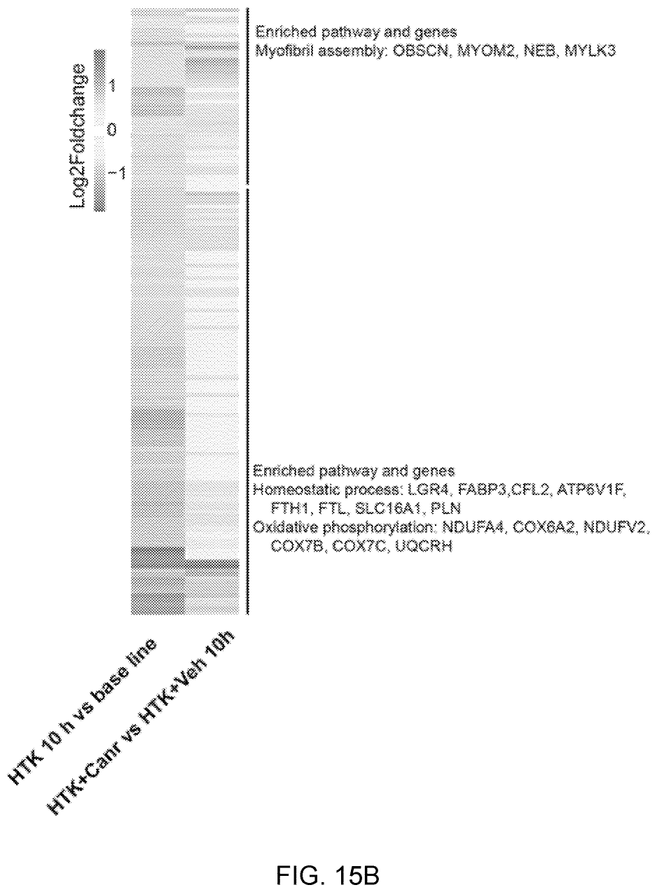

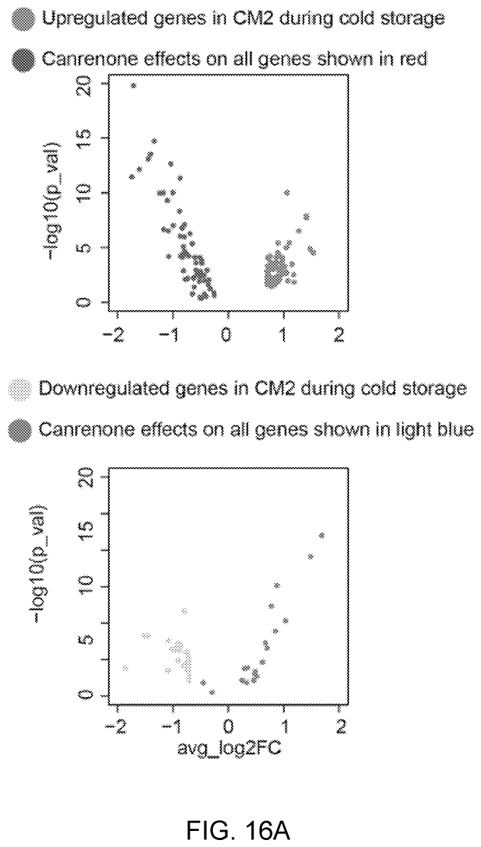

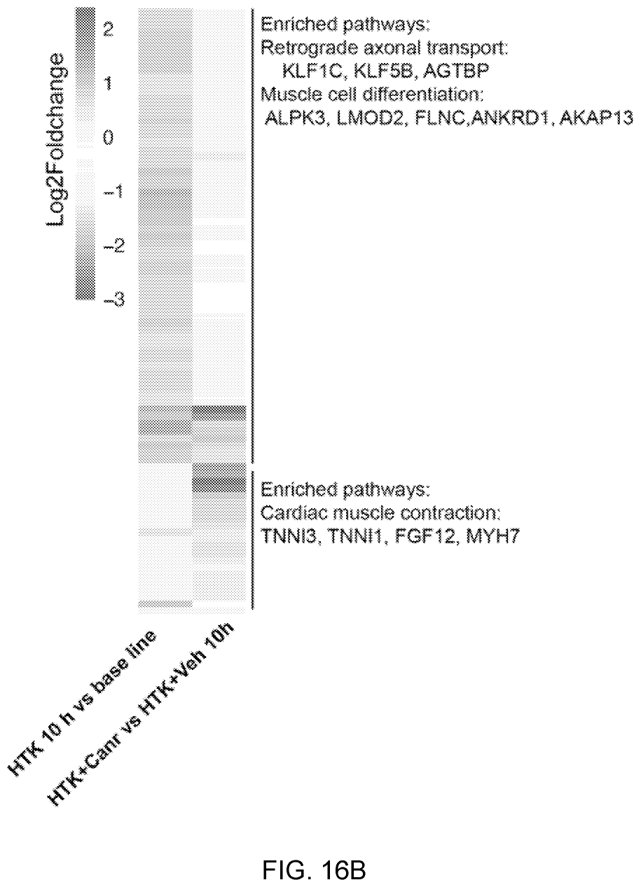

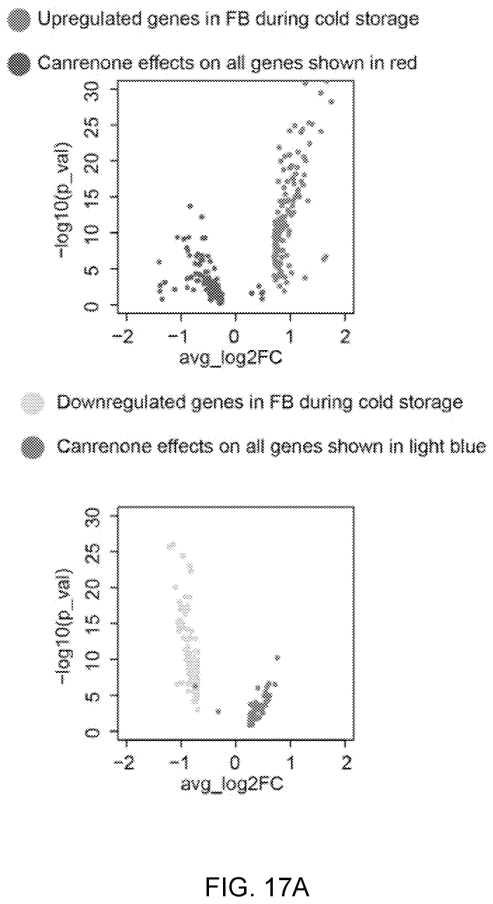

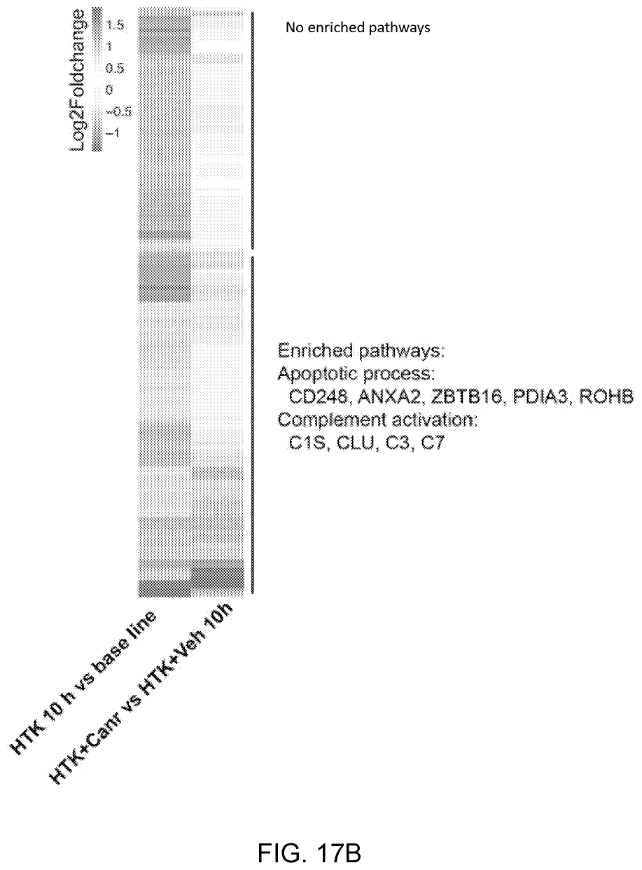

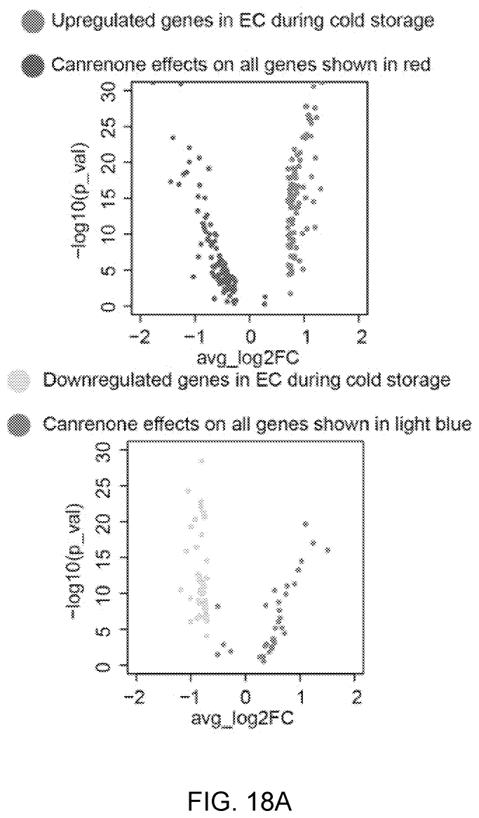

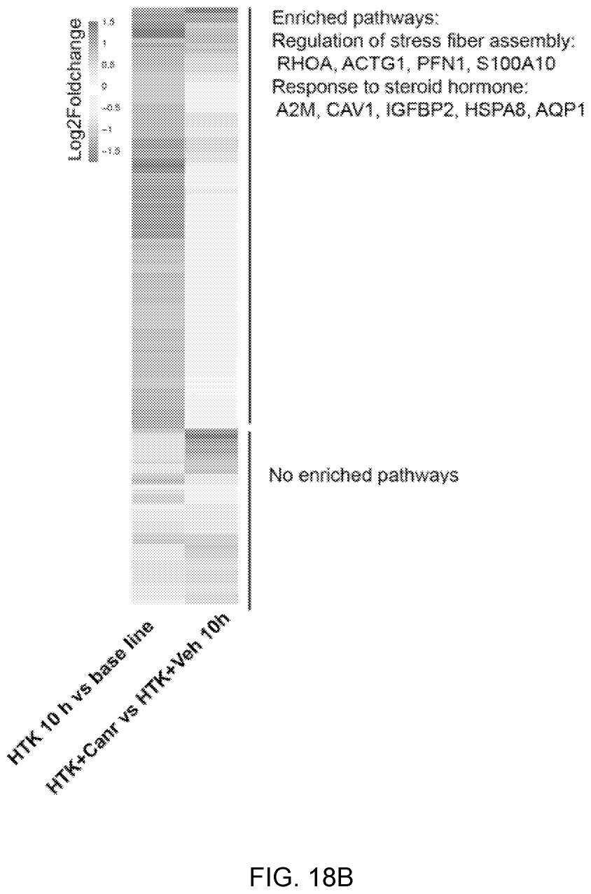

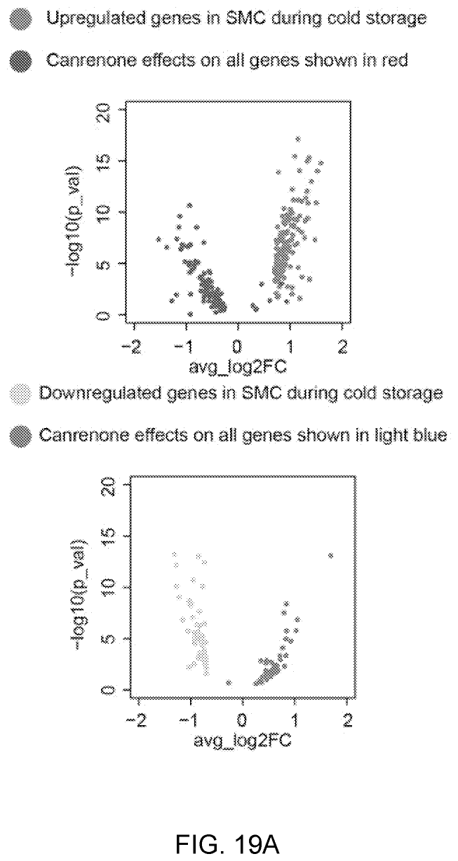

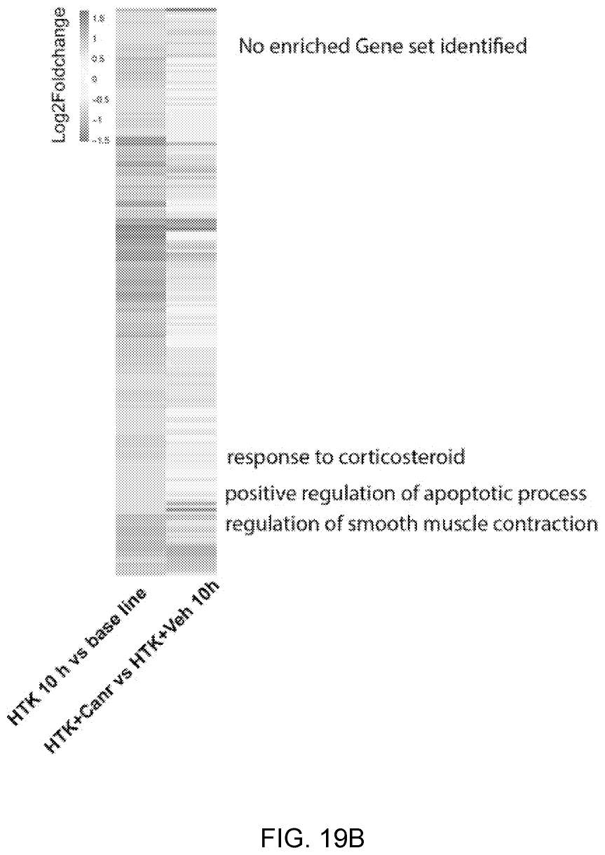

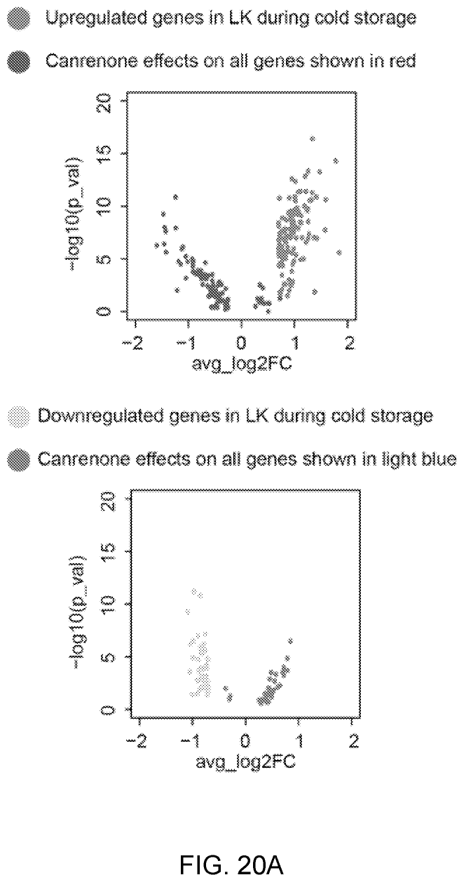

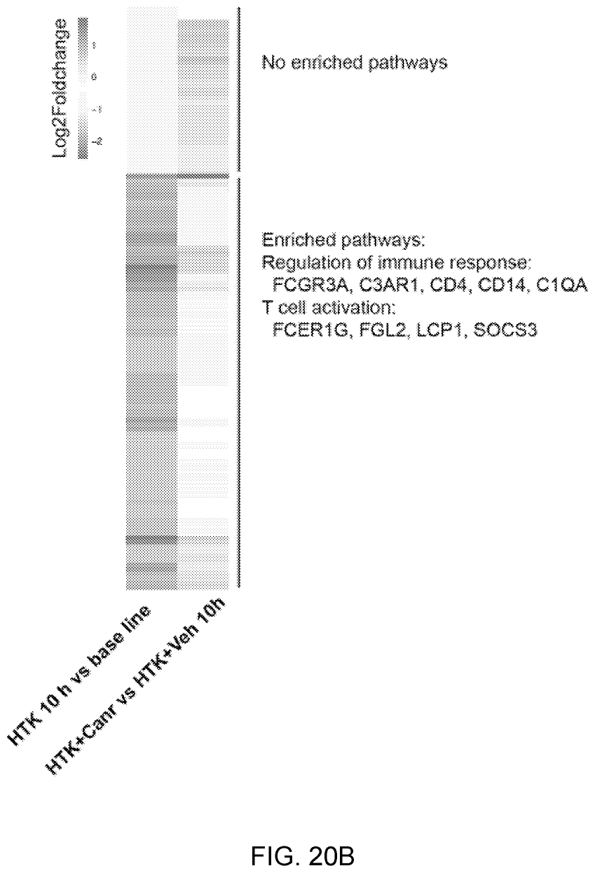

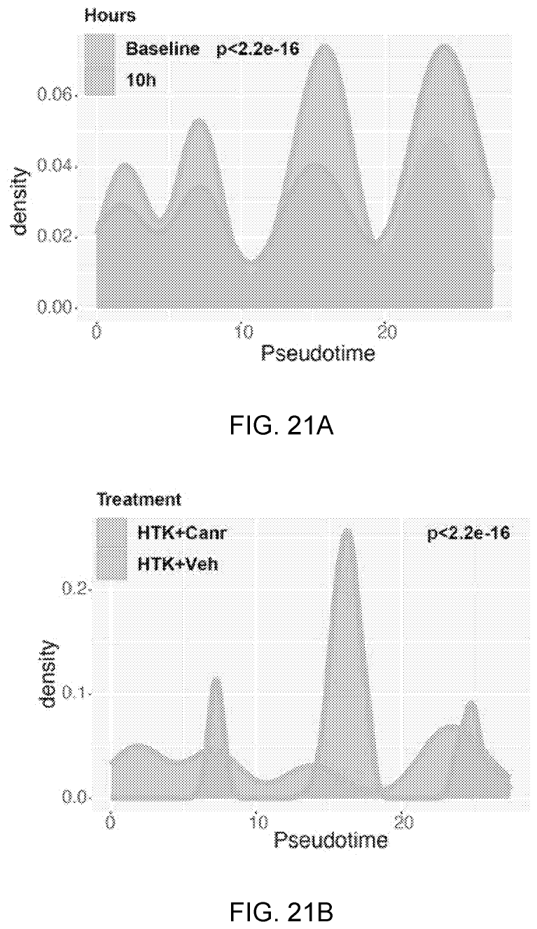

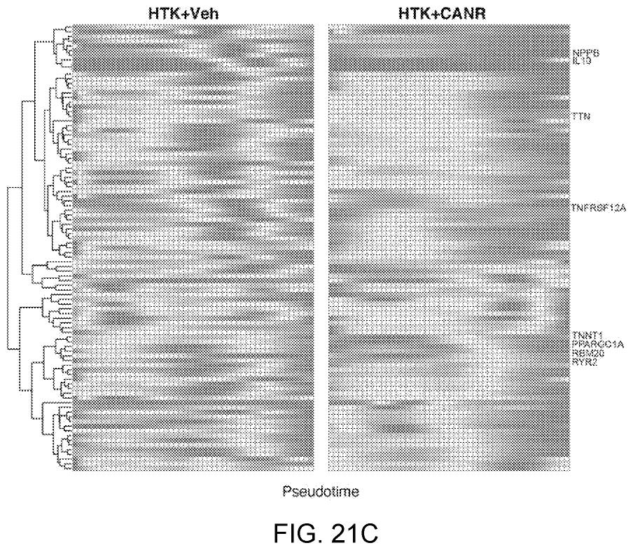

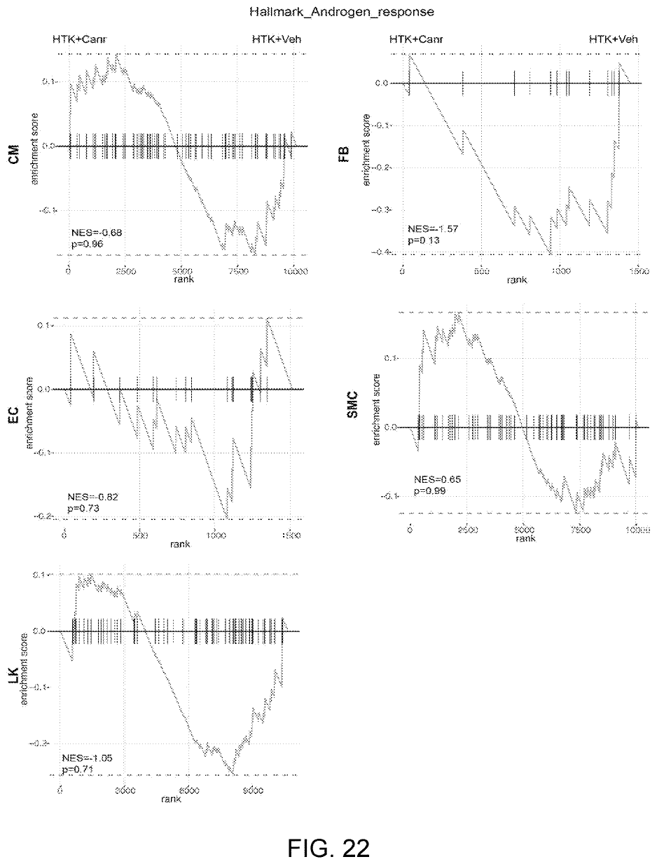

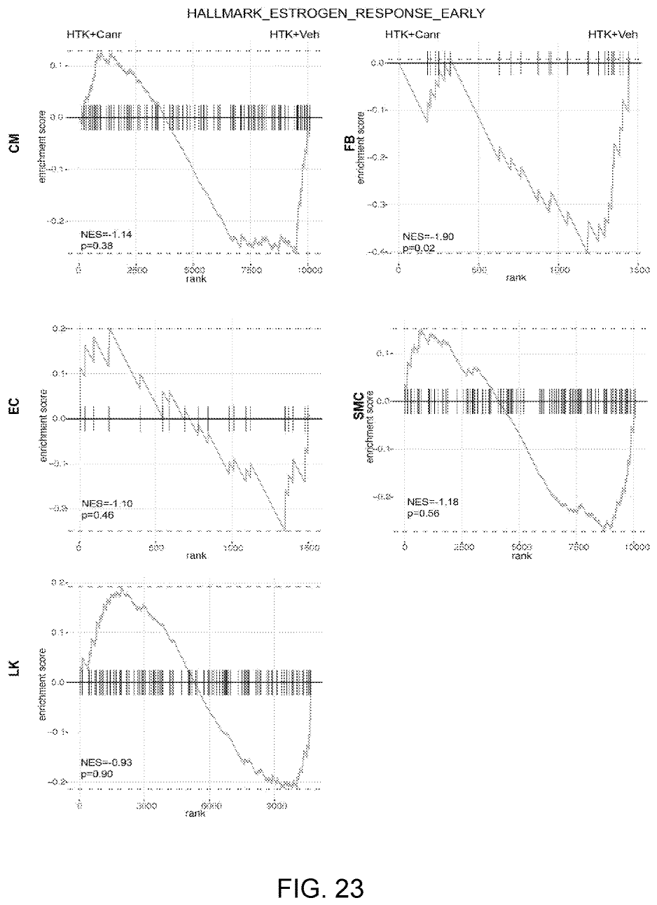

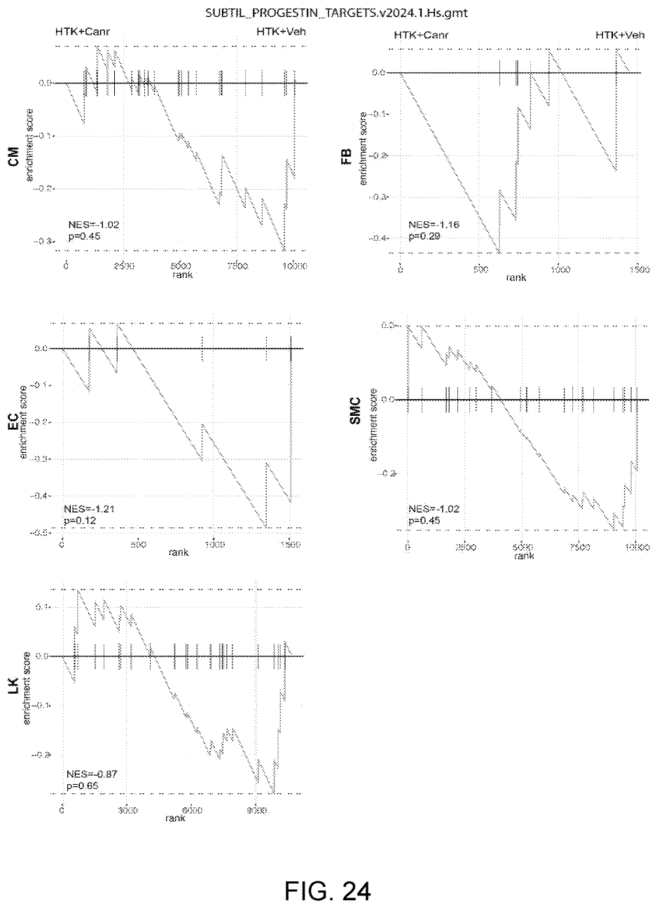

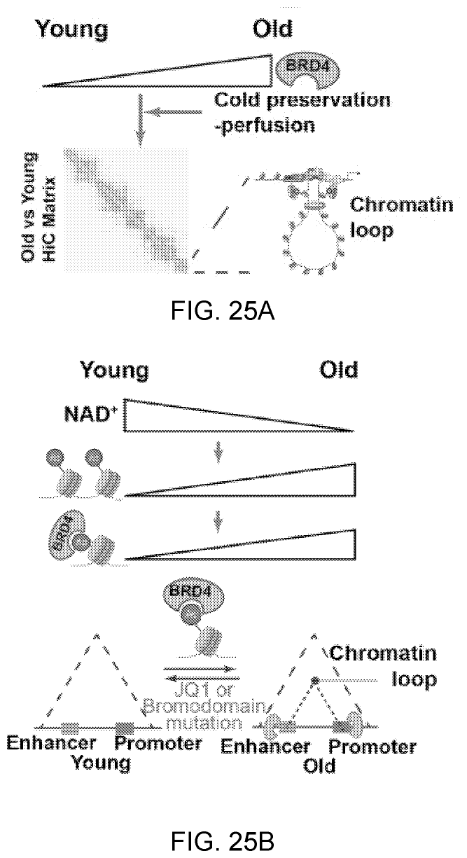

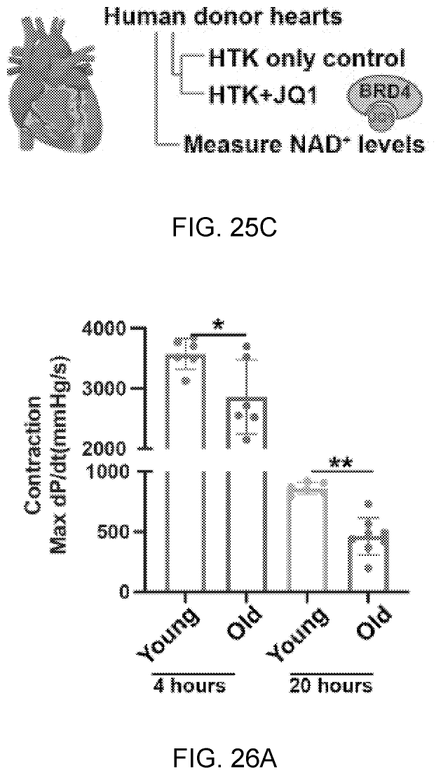

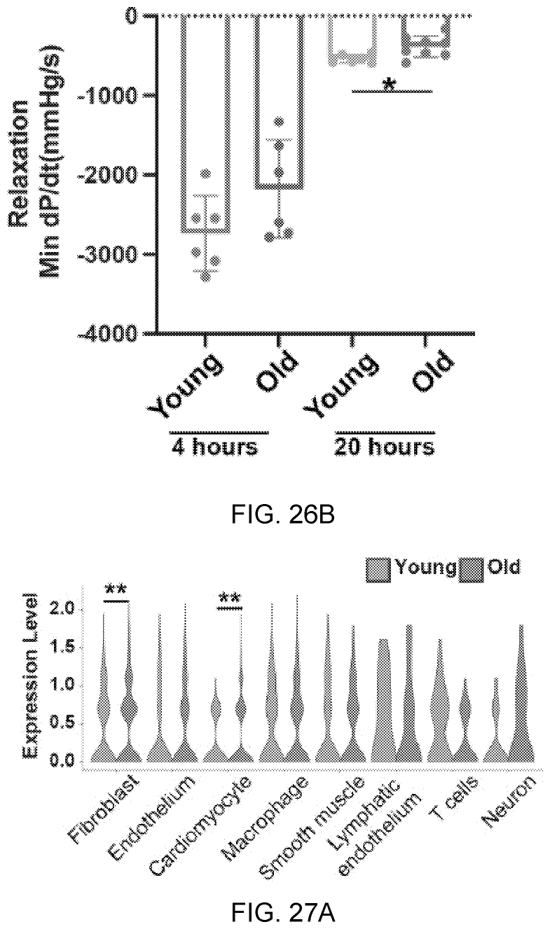

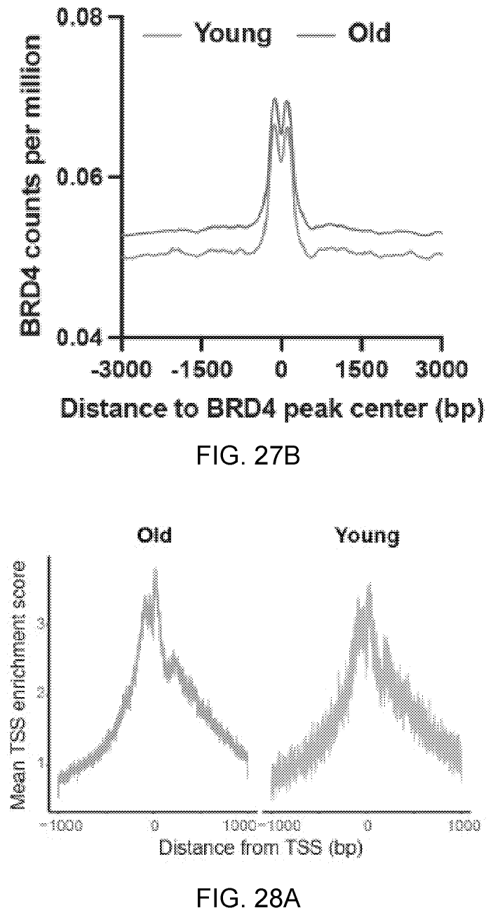

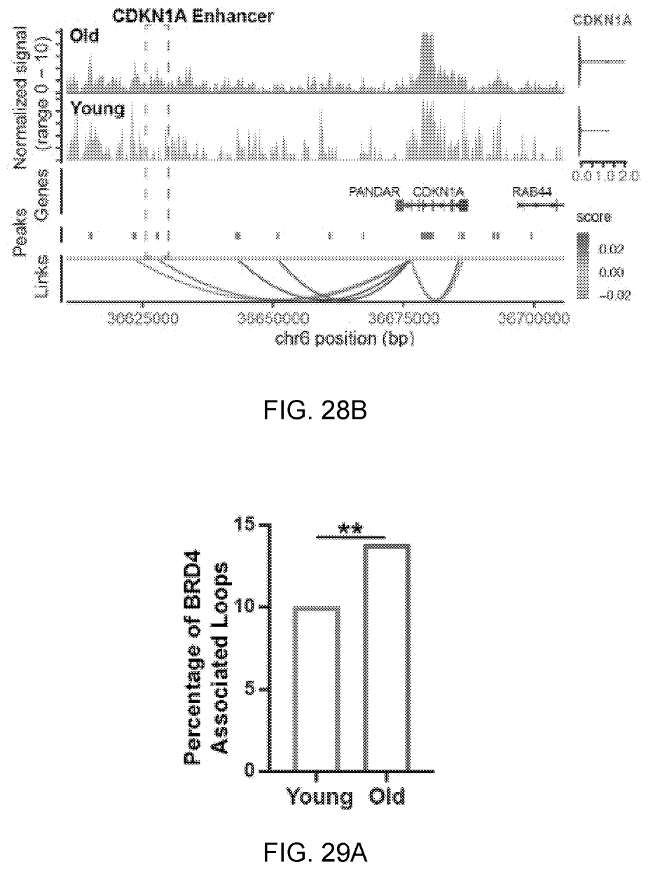

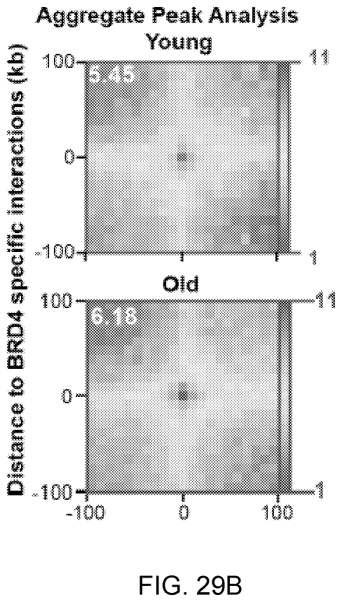

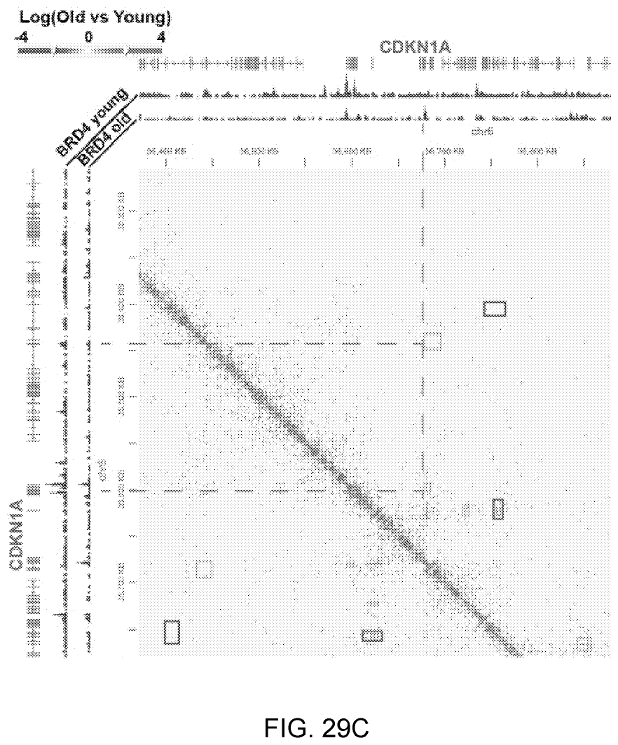

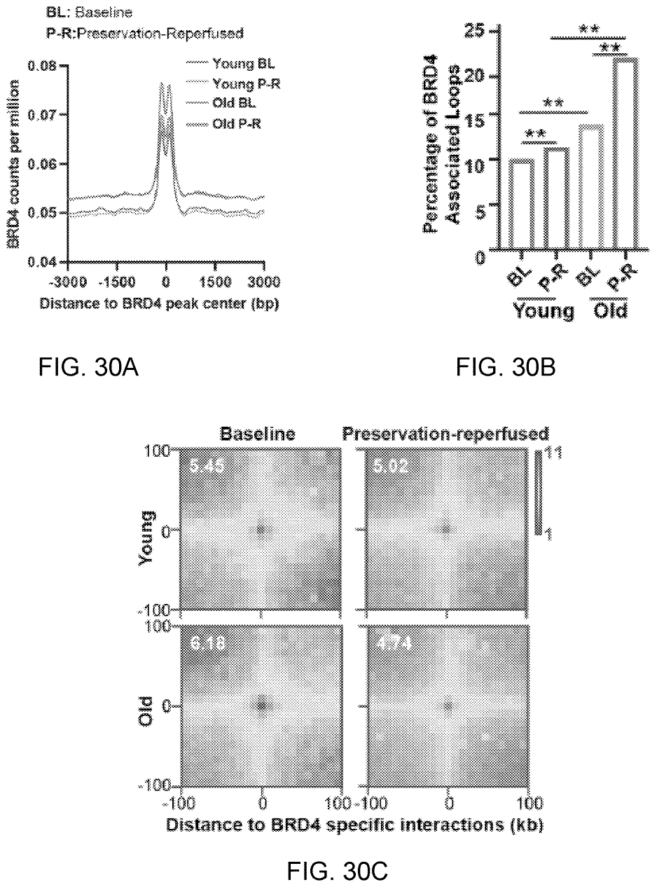

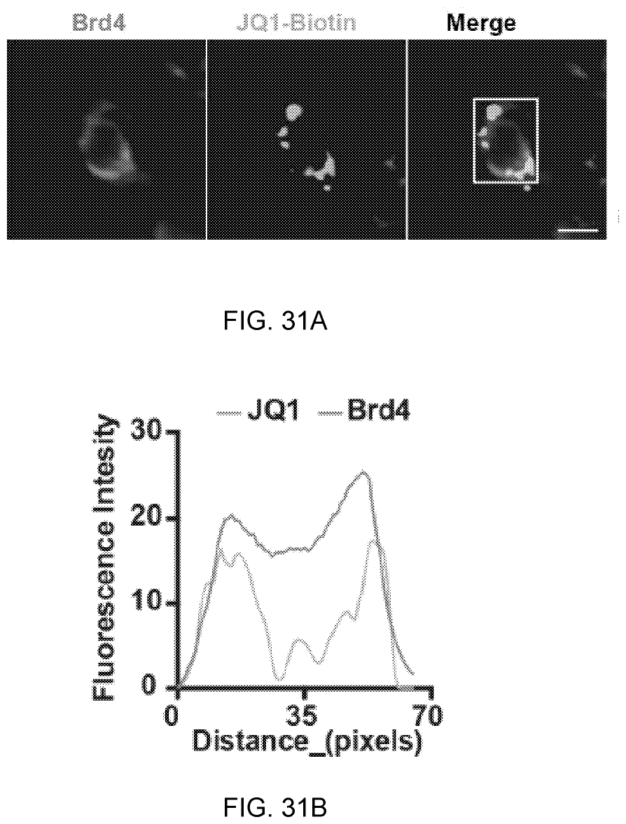

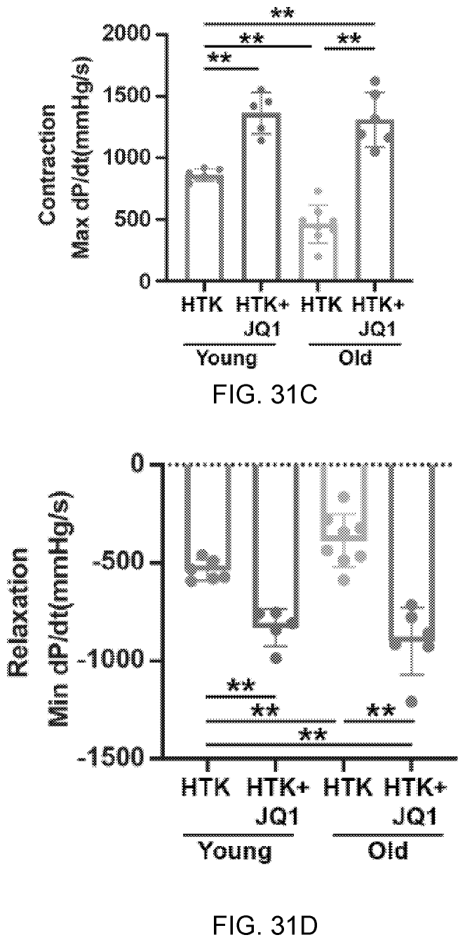

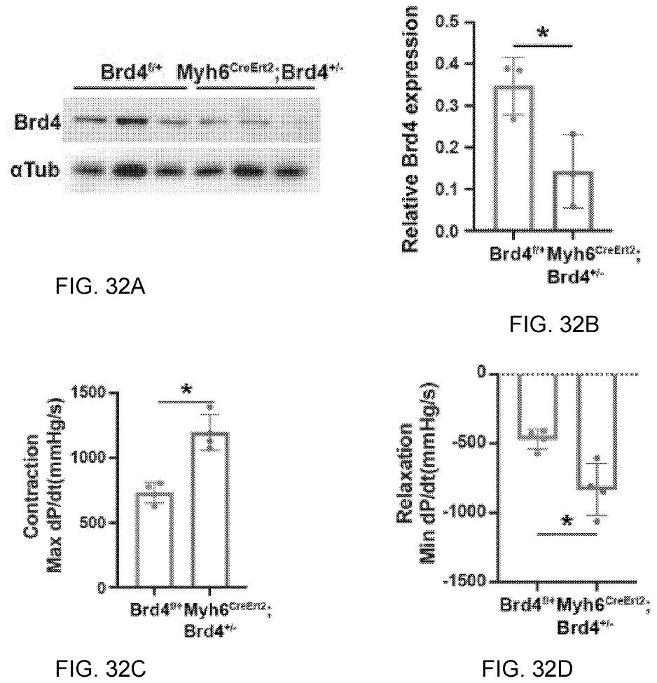

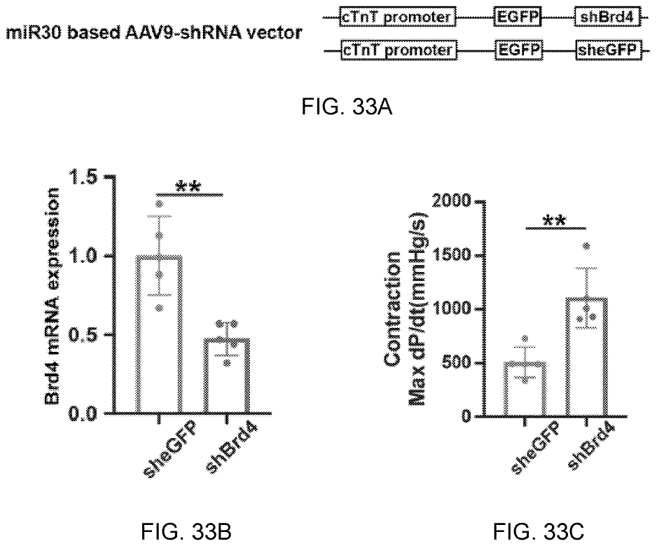

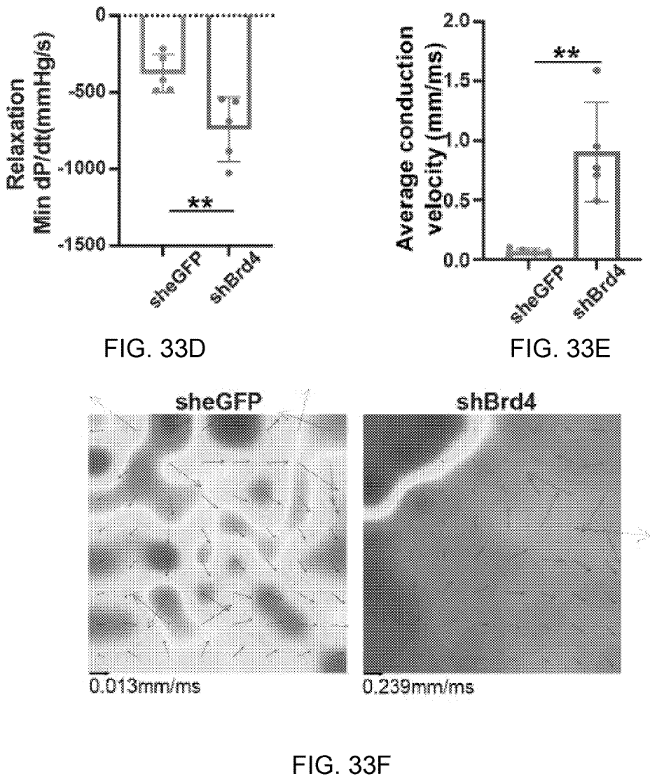

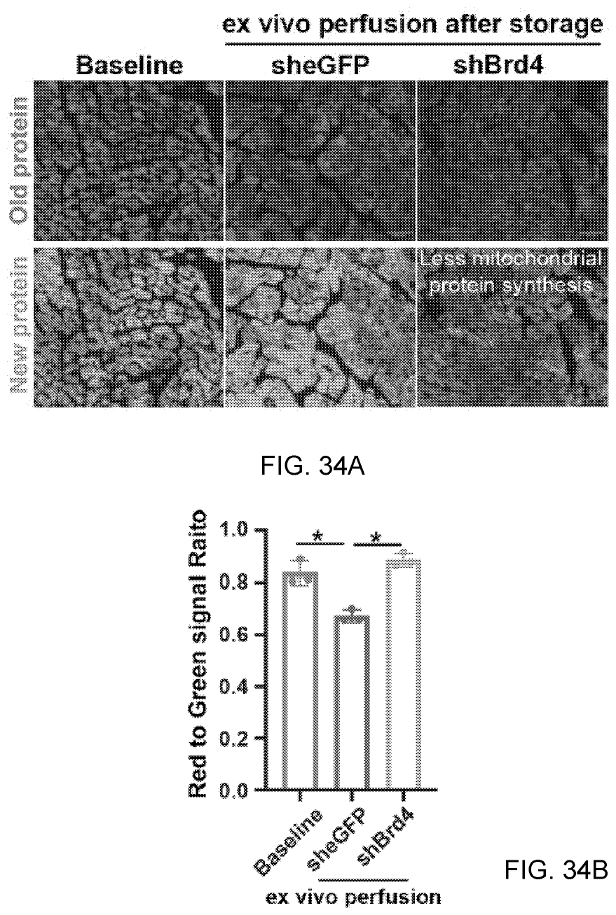

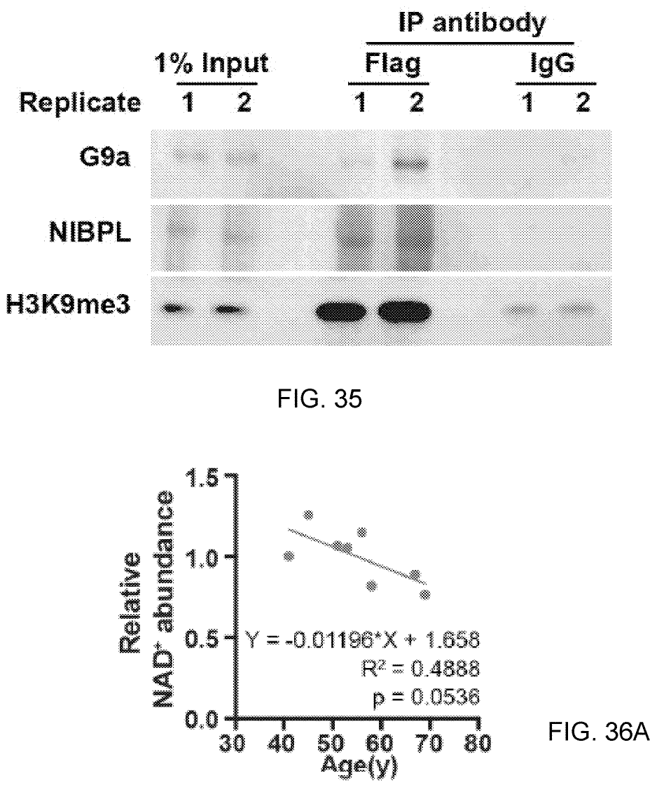

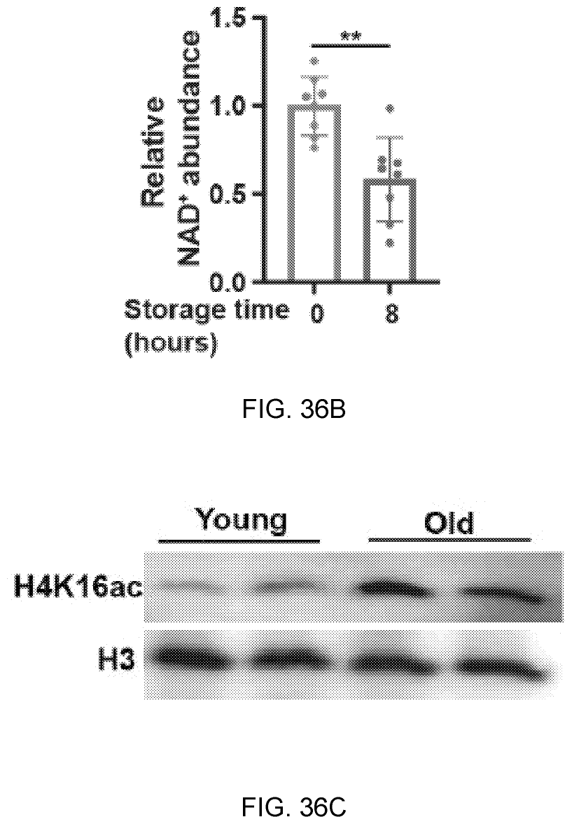

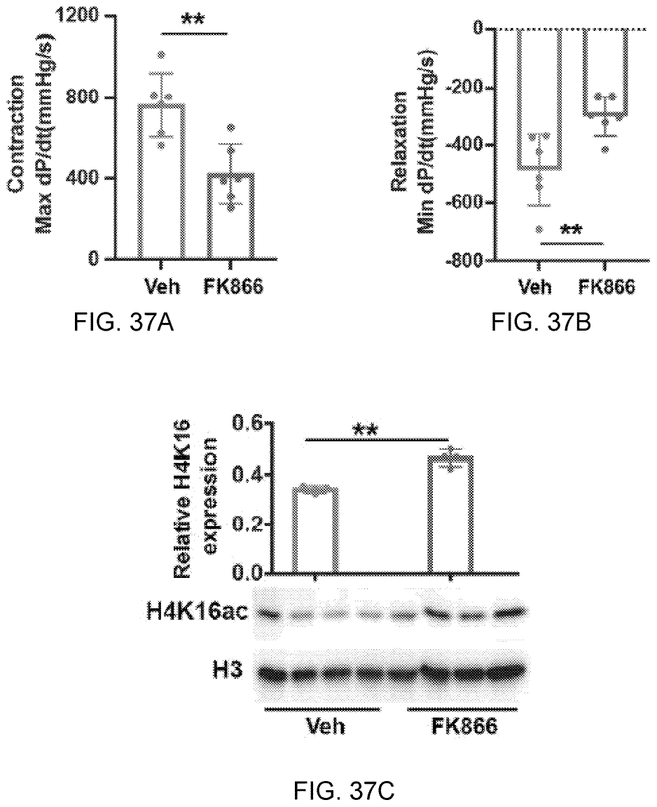

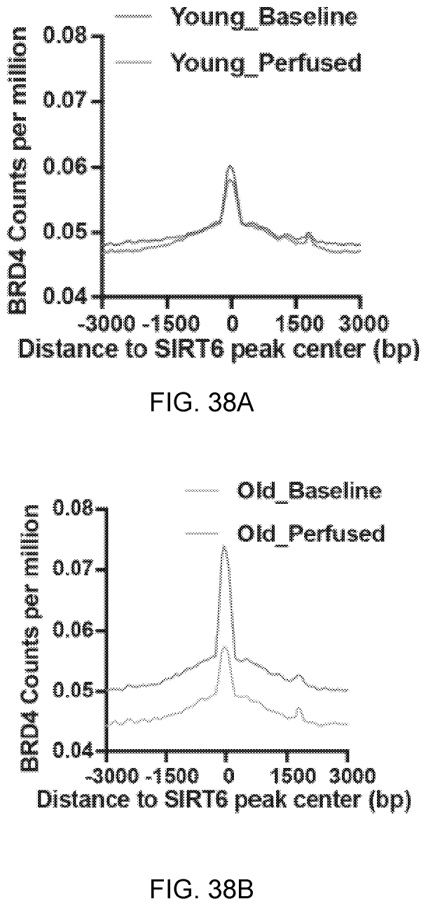

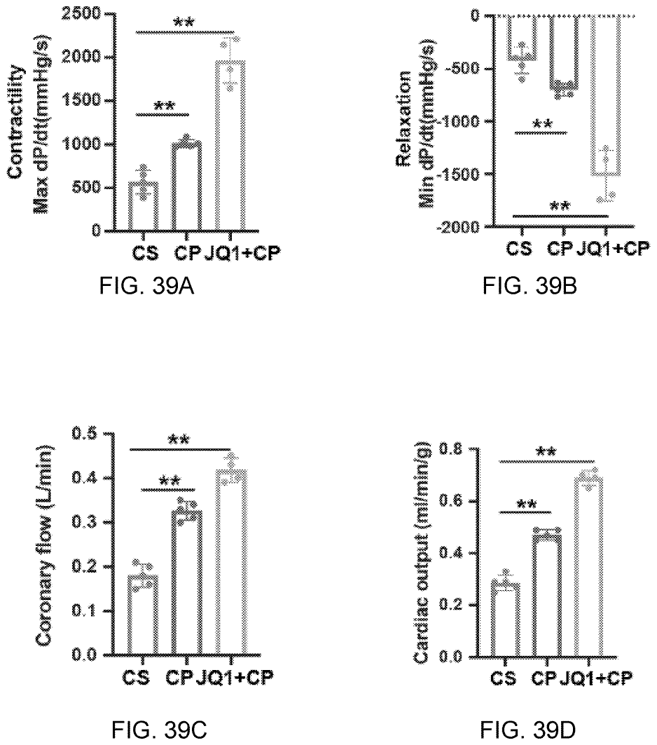

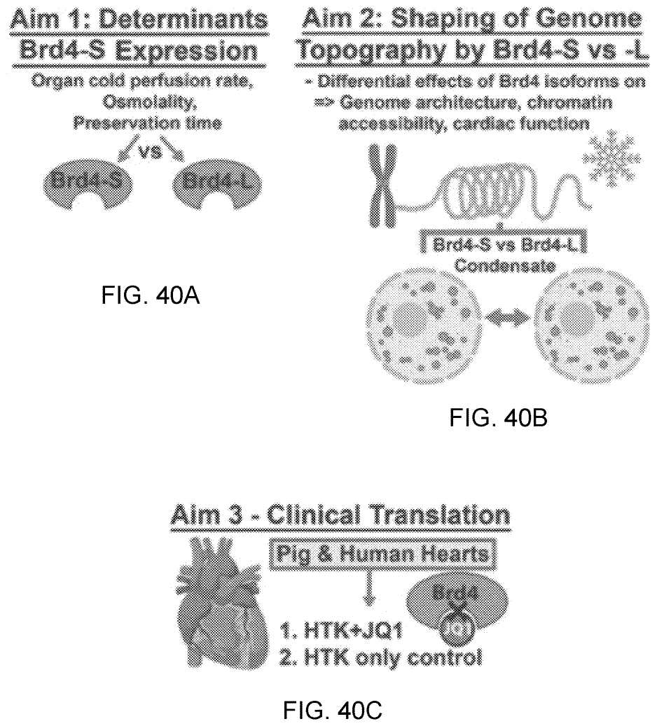

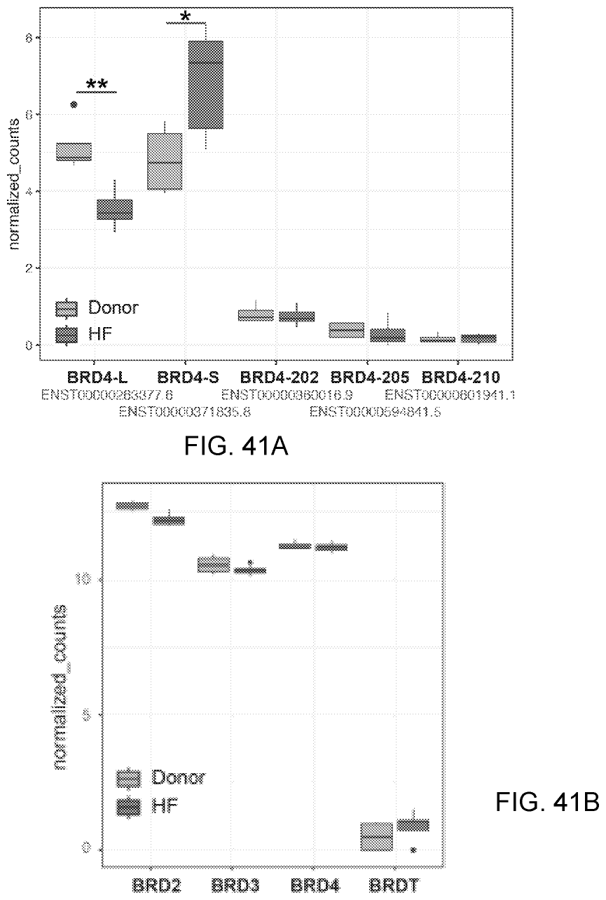

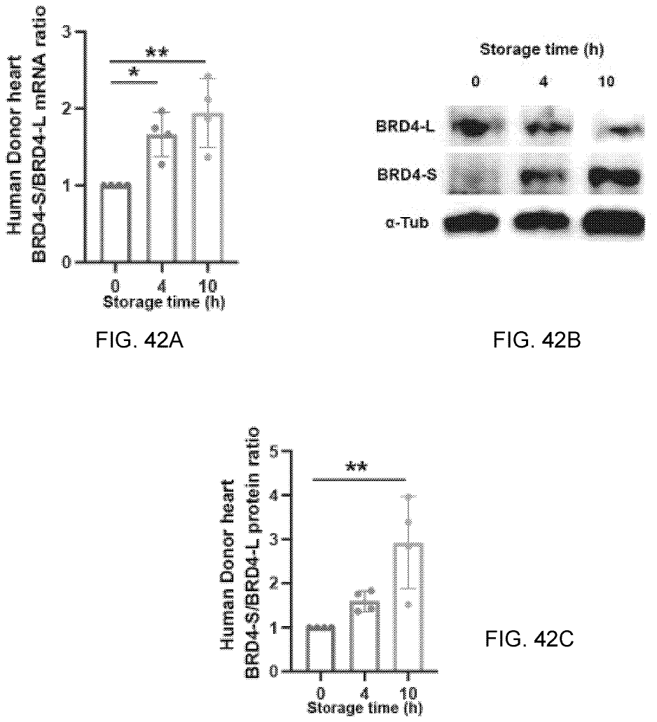

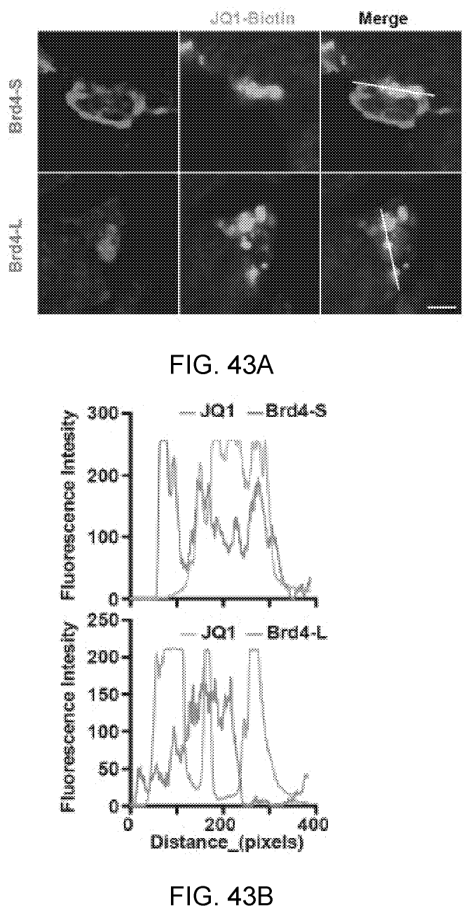

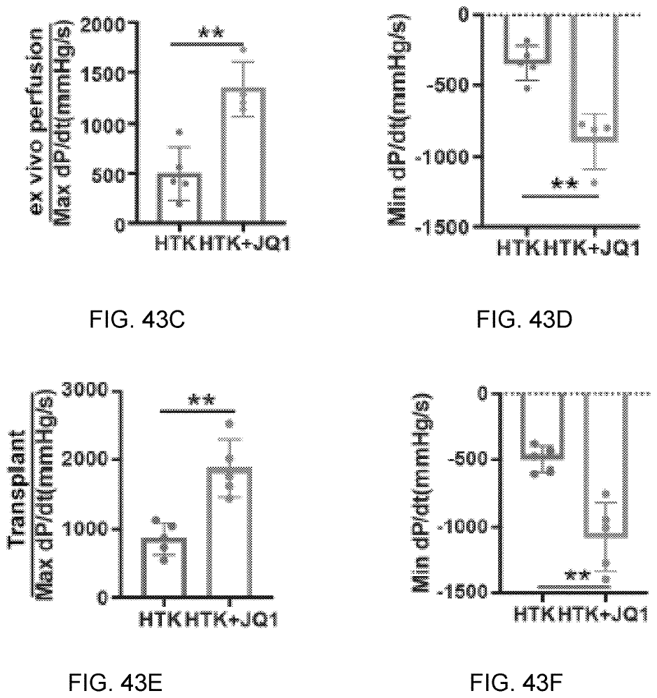

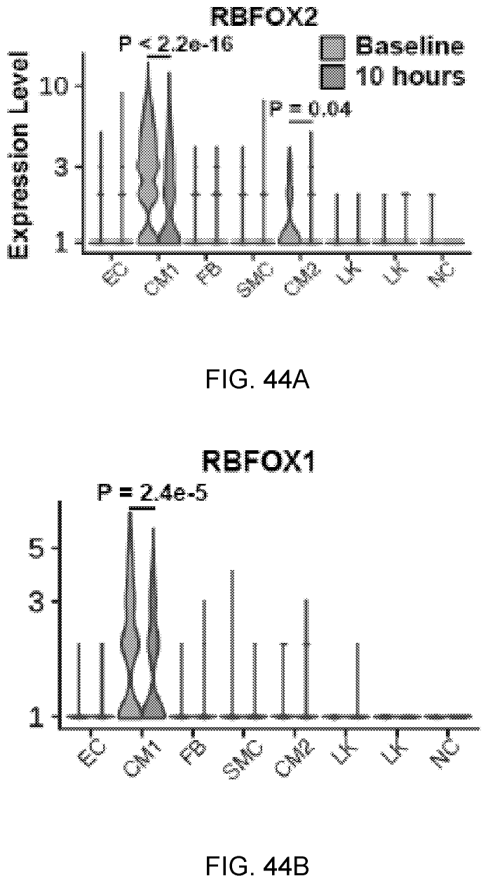

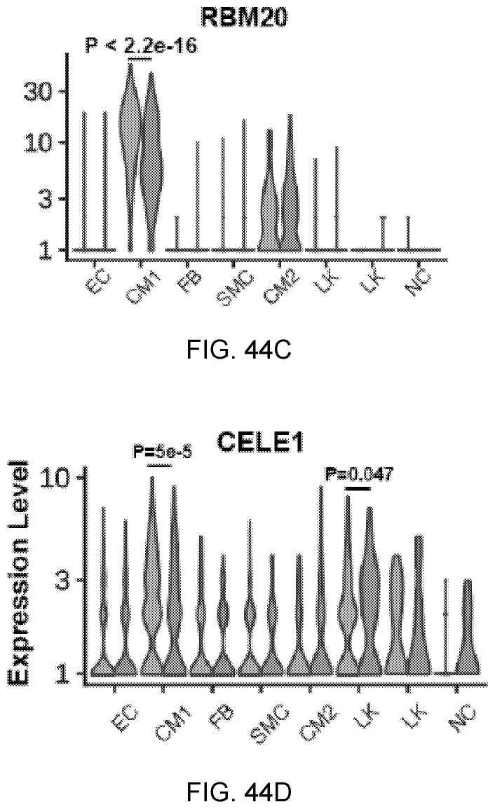

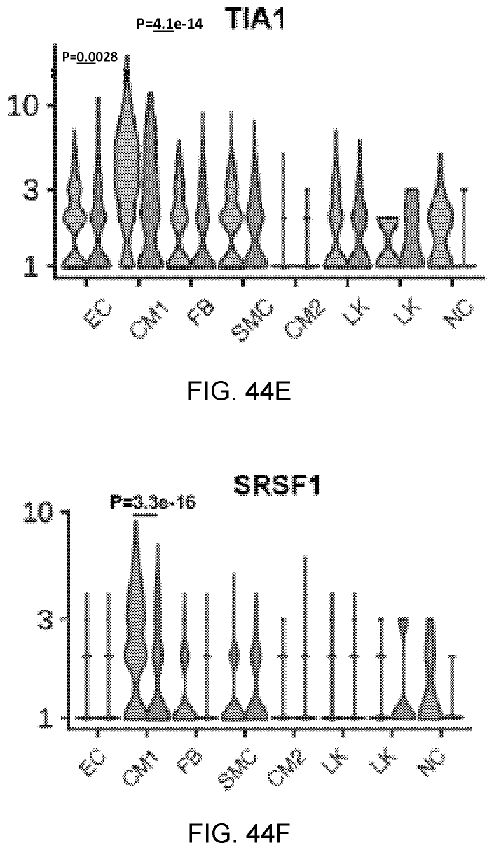

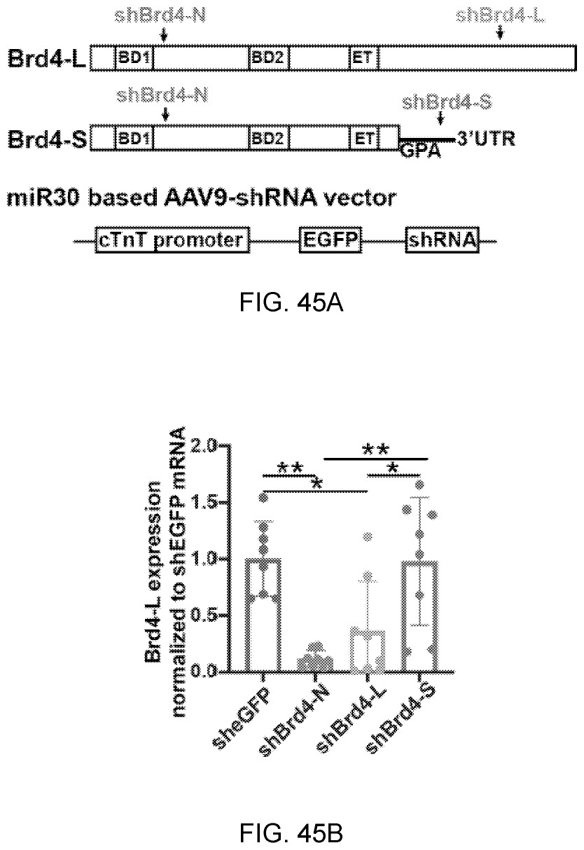

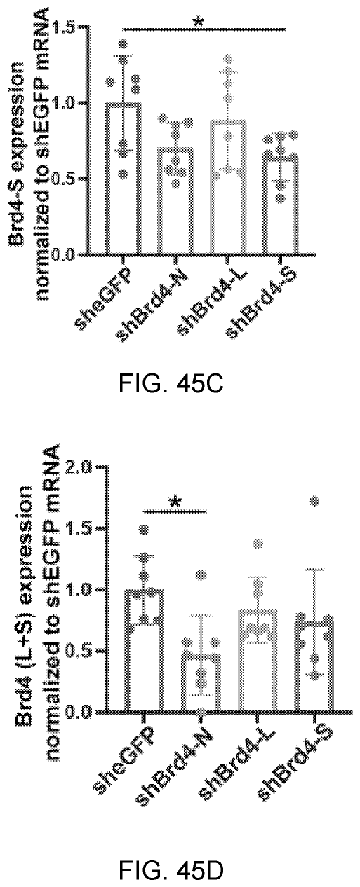

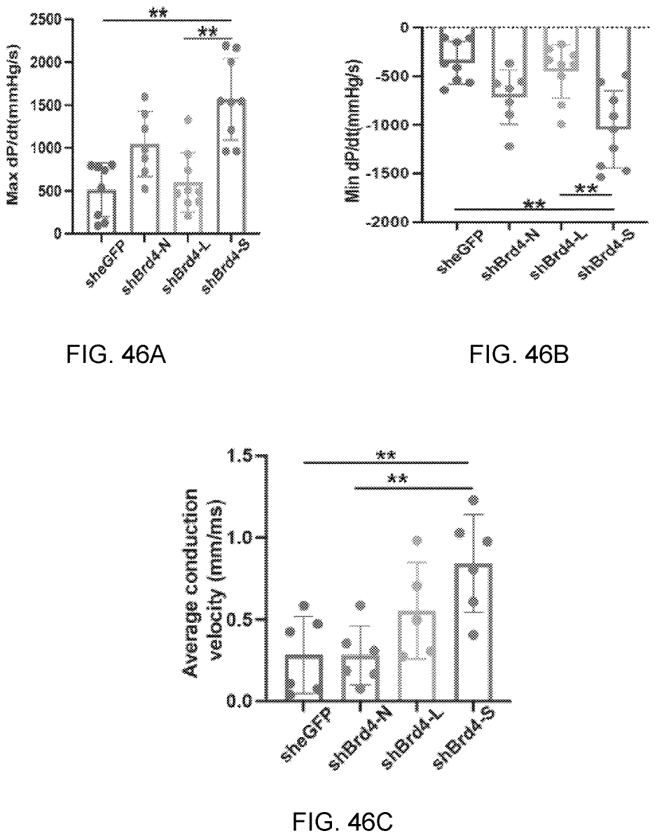

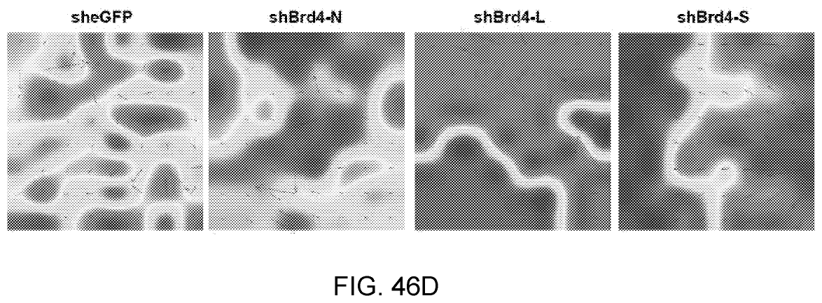

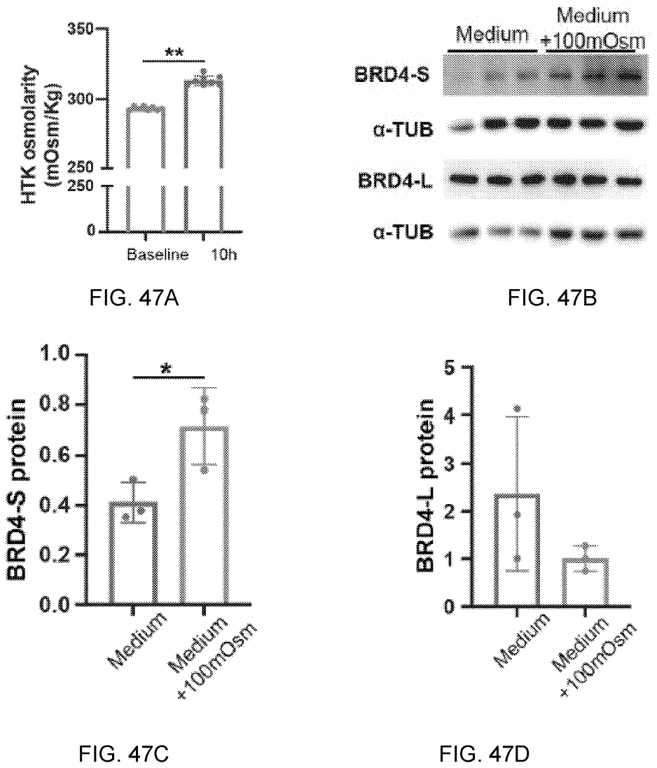

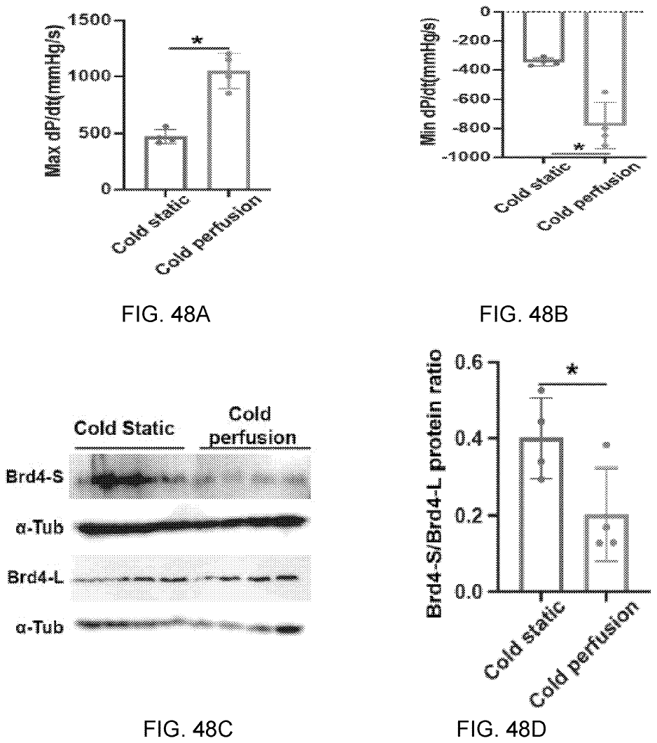

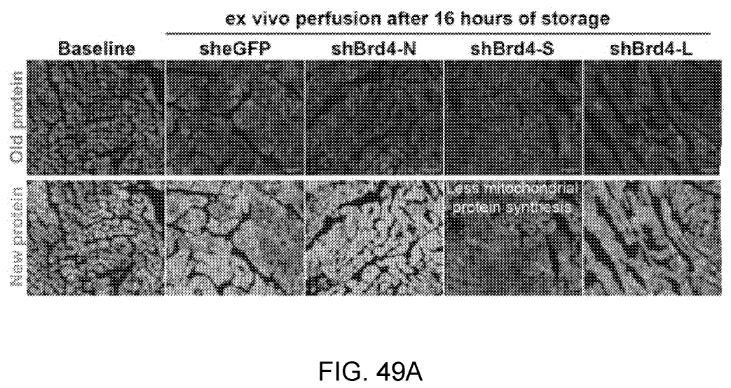

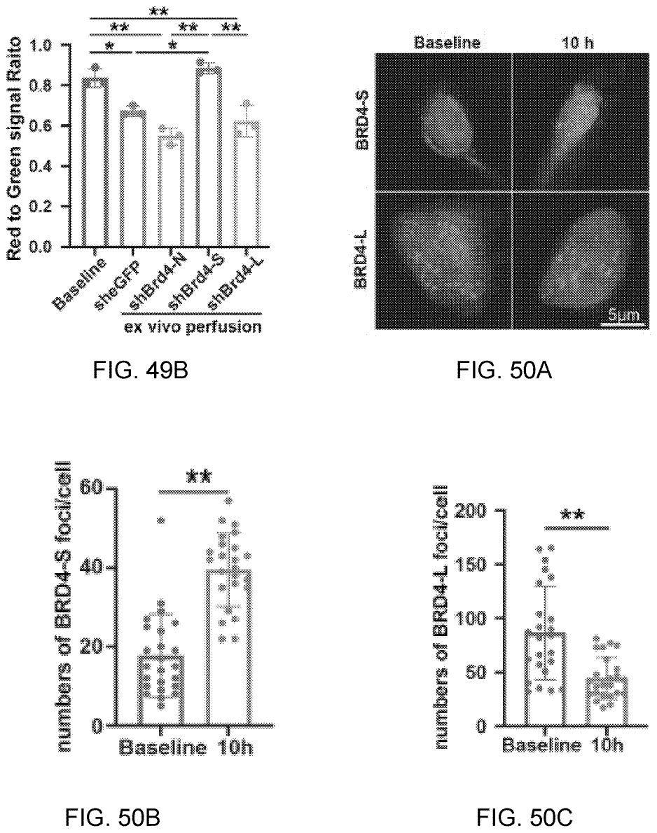

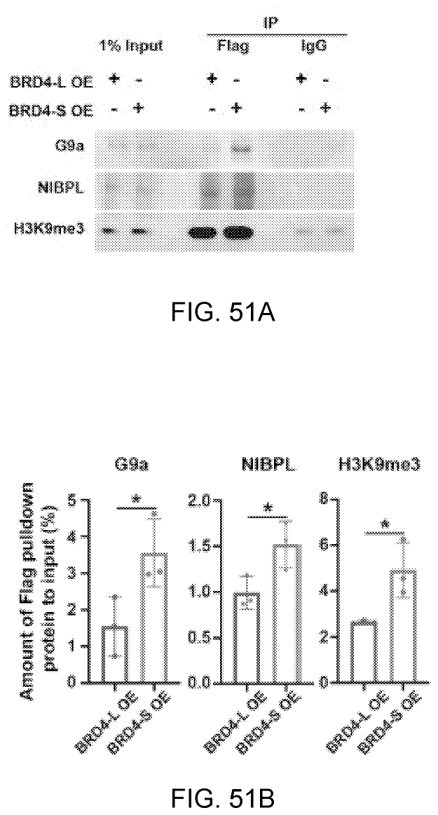

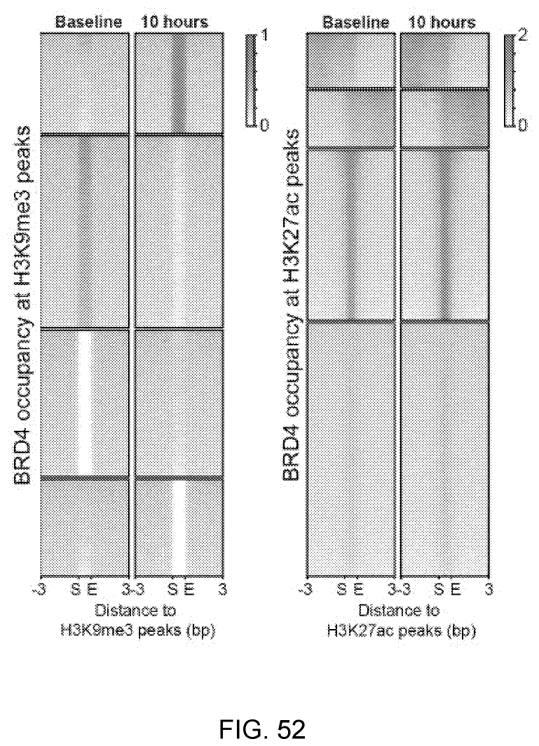

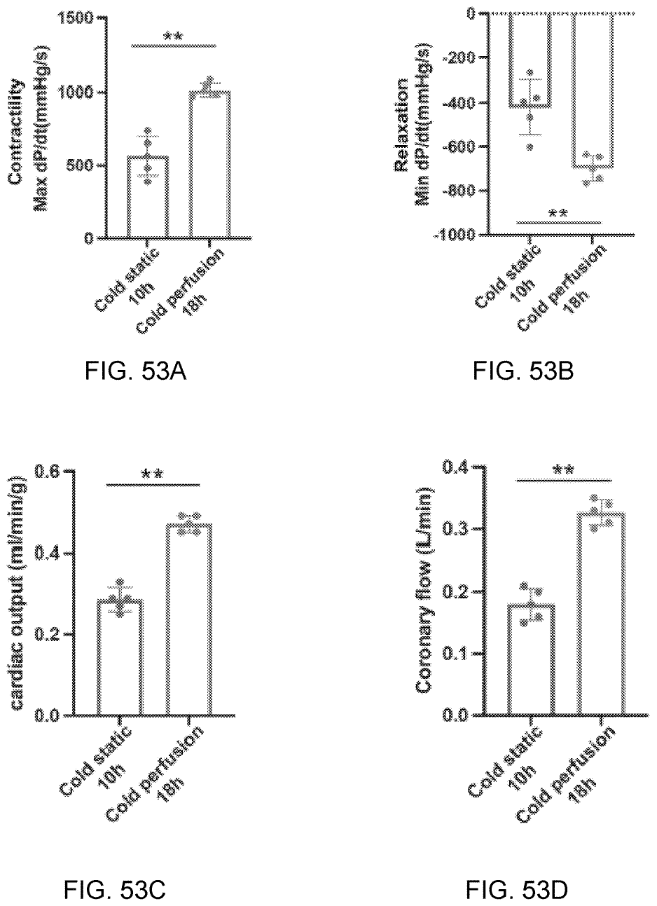

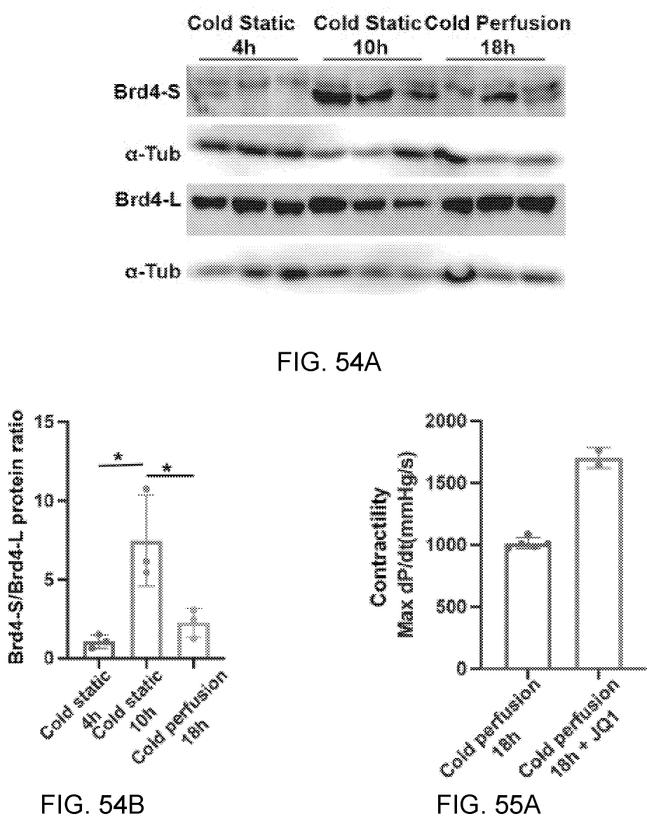

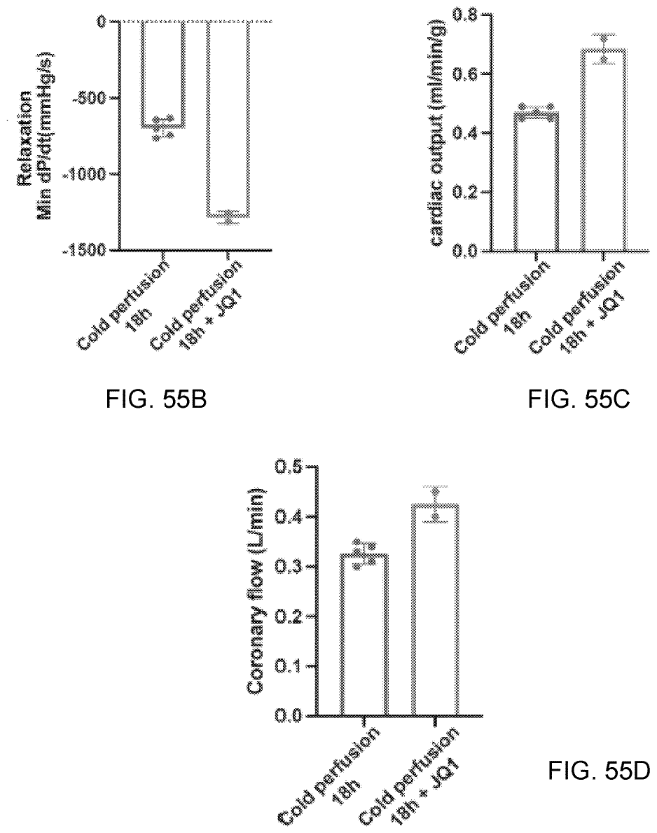

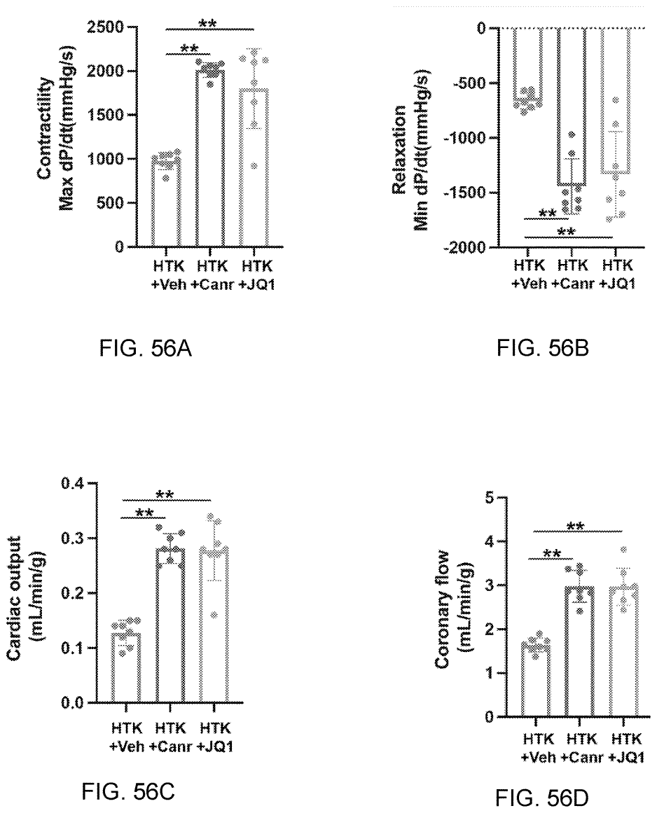

Given the known role of MR activation in mediating cardiac dysfunction, MR protein expression was evaluated, and it showed that it increased over time during cold preservation of human hearts and also increased in ex-vivo perfused murine hearts following prolonged preservation (FIGS. 10A and 10B). MR's role in donor heart dysfunction was evaluated using a transgenic murine model where MR deficiency is induced in Myh6⁺ cardiomyocytes using tamoxifen as confirmed on immunohistochemistry (Myh6^{CreERT2}; MR^{f/f}, FIG. 10C). Cardiomyocyte-specific MR deletion improved cardiac contractility and relaxation in both ex-vivo and syngeneic heterotopic transplant models (FIGS. 1D, 1E, 1F, and 1G). MR deletion donor hearts had less oxidative stress and cell death after ex-vivo perfusion (FIGS. 1H and 1I). Consistent with reduced cardiac injury, transplanted Myh6^{CreERT2}; MR^{f/f} donor hearts following 16 hours of preservation had reduced cytokine expression (IL-1β, IL-6, CXCL9, CXCL10, FIG. 10D). Recipients of MR deficient hearts also had less circulating cTnI and TNF-α (FIGS. 1J and 1K) as well as reduced donor heart infiltration with CD45⁺ leukocytes and Ly6C⁺ macrophages (FIGS. 10E and 10F).

### Preservation Induces Dynamic MR LLPS

Prolonged preservation of murine (FIG. 2A) and human (FIG. 2B) donor hearts was observed to be associated with increasing localization of MR as “punctate” nuclear structures. This was reminiscent of phase separation and nuclear condensate formation by other steroid receptors (e.g., androgen, estrogen, progesterone, and glucocorticoid receptors) for the purpose of transcriptional regulation. Interestingly, MR nuclear translocation and puncta formation in cardiomyocytes only occurred in the setting of hypoxia while bathed in cold (4° C.) HTK preservation solution. No MR puncta formation was observed under conditions of normoxia while cells were cultured in 37° C. culture media (FIG. 2C).

Using the Predictor of Natural Disordered region (PONDR, pondr.com) online software, it was confirmed that a positively charged N-terminal domain (NTD) with IDR properties based on a PONDR score >0.5 using both VLXT and VSL2 meta-predictor models as described previously by others (FIG. 2D). LLPS phenomena is potentiated by increases in local molecular concentrations above a certain threshold as well as by other physicochemical conditions (e.g., temperature, pH). Under these settings, it becomes thermodynamically more favorable for key molecular components to interact through coalescence followed by de-mixing until the free energy of the medium stabilizes. It was evaluated that green fluorescent protein (GFP) tagged MR displays a concentration threshold at about 10 μM for condensate formation as quantified by turbidity studies as well as direct visualization of fluorescence within test tubes (FIGS. 2E and 2F). Round MR condensates are also appreciated on fluorescence microscopy (FIG. 2G). Its dynamic nature is demonstrated by the capabilities of condensate fusion (FIG. 2H) and fluorescence recovery after photobleaching (FRAP, FIG. 2I). FRAP uses a laser to bleach a portion of the condensate but recovers as unbleached molecules moves dynamically into the previously bleached area. GFP-MR missing the NTD (GFP-MRΔIDR) was cloned and confirmed drastically reduced ability for LLPS by direct visualization and quantitative turbidity analysis (FIGS. 2J and 2K).

To interrogate for the phenomenon of MR LLPS within living cells, fluorescence recovery was confirmed using FRAP of MR nuclear condensates within cardiomyocytes exposed to cold hypoxic preservation (FIG. 1IA). Protein chimera (optoDrop28) was generated by fusing MR with the mCherry red fluorescence protein and the Arabidopsis cytochrome 2 (Cry2) protein which is then expressed in Human Embryonic Kidney (HEK293) cells (FIG. 1IB). MR-Cry2 fusion promotes Cry2-Cry2 homo-oligomerization upon blue light (450 nm) exposure but only if there is an intrinsic propensity for MR to phase separate. Light exposure confirmed a strong propensity for full length MR to form red condensates but not if the NTD is deleted (FIG. 1IC). MR clusters are verified to represent phase transition upon FRAP testing (FIG. 1ID).

### Disruption of MR LLPS Improves Donor Heart Function

Adeno-associated virus 9 (AAV9) was used to express full length MR (AAV-MR) and MR missing the IDR (MRΔIDR) to reconstitute MR in the hearts of mice with tamoxifen induced MR deficiency in cardiomyocytes (Myh6^{CreERT2}; MR^{f/f}, FIG. 3A) with verification of construct expression by transcript and protein levels (FIGS. 3B and 3C). Mutant MRΔIDR (40 KDa) was detected in the murine hearts infected with AAV9-MRΔIDR. In ex-vivo perfused murine hearts after 16 hours of preservation, hearts expressing MRΔIDR had much less MR condensate formation on visual inspection and quantification (FIGS. 3C, 3D, and 3E) than AAV-MR hearts thus confirming the importance of the IDR for MR phase separation in-vivo. Importantly, AAV-MRΔIDR hearts had much improved contractility and relaxation compared to AAV-MR hearts. AAV-MRΔIDR cardiac function was not different from AAV-Luc control hearts (FIGS. 3F and 3G). This is consistent with higher cleaved caspase 3 and Bax abundance indicating more cell death in AAV-MR hearts compared with AAV-MRΔIDR hearts (FIGS. 3H and 3I). Nongenomic MR effects of mitogen-activated protein kinases (MAPK) signaling via JNK and Erk2 were not different between the groups suggesting MR phase separation does not influence MR related MAPK signaling events (FIGS. 3J and 3K). MR with IDR deletion also experienced less oxidative stress after ex-vivo perfusion as evidenced by the 8-OHDG staining (FIGS. 3J and 3K). AAV9-MRΔLBD was used to express MRΔLBD (mutant MR with ligand binding domain deletion from a.a. 726-984) in Myh6^{CreERT2}; MR^{f/f} murine heart following tamoxifen administration. Construct protein expression was confirmed (FIG. 12A) with western blot. Ex-vivo cardiac perfusion showed that expression of MRΔLBD, which is unable to respond to ligand, does not protect the heart during cold preservation (FIG. 12B). This confirms that the harmful effect of MR signaling during cold preservation is ligand-independent. MRΔLBD is also able to phase separate (FIG. 12C) as well as induce the expression of well-known MR target genes such as ZFP219, CAMK2D, and PER1 (FIG. 12D).

### Drug Inhibition of MR Improves Donor Heart Function

To determine the therapeutic role of pharmacological MR inhibition on donor heart preservation, the drug canrenone was administered to donor hearts. Canrenone is the water-soluble active metabolite of spironolactone which itself is poorly water soluble and not suitable for intravascular administration. Canrenone is clinically utilized as a mineralocorticoid receptor antagonist for atrial fibrillation therapy, and to treat chronic heart failure. Following canrenone dose-response titrations (FIG. 13A), canrenone (50 μM) versus vehicle control was added to HTK solution to preserve murine hearts and titrated the cold storage duration. It was confirmed that canrenone steadily improved cardiac function as preservation duration increased out to 16 hours (FIGS. 13B and 13C). Cardiac functional improvement was again demonstrated in the murine syngeneic transplant model which was accompanied by reduced circulating cardiac troponin I indicating reduced cardiac injury with canrenone administration (FIGS. 13D,13E, and 13F)

To further assess clinical translational potential, canrenone was shown to have improved the ex-vivo contractility and relaxation of pig hearts preserved for 10 hours with 300% improvement from baseline (FIGS. 4A and 4B). Canrenone also increased cardiac output, improved coronary blood flow and reduced circulating cTnI (FIGS. 4C, 4D, and 4E). After 4 hours of porcine heart preservation, canrenone similarly improved cardiac contractility and relaxation by about 17 (FIGS. 14A and 14, ). Cardiac output and coronary blood flow were also improved while TnI levels in the perfusate was lower (FIGS. 14C, 14D, and 14E, Table 1). In porcine hearts treated with canrenone, staining for 8-OHDG confirmed reduced oxidative stress (FIGS. 4F and 4G) while TUNEL staining showed reduced cell death (FIGS. 4H and 4I). In human hearts preserved for 10 hours, canrenone also greatly improved ex-vivo cardiac function (FIGS. 4J and 4K) while accompanied by increased cardiac output, coronary blood flow and reduced circulating cTnI suggesting greater cardiac viability (FIG. 4L, 4M, 4N, and Table 2). There is also consistent with reduced Cleaved CASPASE 3 and BAX abundance in the human donor with canrenone treatment (FIGS. 14F and 14G).

TABLE 1
Pig heart hemodynamic data from ex-vivo perfusion experiments

| Pig donor | | | | | | |
|---|---|---|---|---|---|---|
| heart | HTK 4 | HTK + Canr 4 | | HTK 10 | HTK + Canr | |
| groups | hours | hours | P value | hours | 10 hours | P-value |
| Heart Rate | 109.6 ± 26.4 | 130.7 ± 39.8 | n.s. | 114.3 ± 34.0 | 93.3 ± 16.7 | n.s. |
| (bpm) | | | | | | |
| LV | 91.5 ± 22.3 | 118.6 ± 28.2 | n.s. | 52.9 ± 27.6 | 127.0 ± 21.8 | <0.01 |
| Systolic | | | | | | |
| Pressure | | | | | | |
| (mmHg) | | | | | | |
| LV | 5.0 ± 5.4 | 10.0 ± 9.8 | n.s. | 9.8 ± 8.5 | 11.6 ± 11.3 | n.s. |
| Diastolic | | | | | | |
| Pressure | | | | | | |
| (mmHg) | | | | | | |
| Heart | 264.8 ± 48.1 | 267.2 ± 31.1 | n.s. | 249.6 ± 17.6 | 250.6 ± 25.7 | n.s. |
| Weight | | | | | | |
| before (g) | | | | | | |
| Heart | 282.9 ± 41.6 | 278.1 ± 28.8 | n.s. | 261.9 ± 20.7 | 267.9 ± 5.0 | n.s. |
| Weigh | | | | | | |
| after (g) | | | | | | |

TABLE 2
Human heart hemodynamic data from
ex-vivo perfusion experiments

| Human Donor heart | HTK 10 hours | HTK + Canr 10 hours | |
|---|---|---|---|
| Groups | (n = 5) | (n = 4) | P-value |
| Heart Rate (bpm) | 75.0 ± 14.2 | 76.4 ± 9.5 | n.s. |
| LV Systolic Pressure | 35.0 ± 21.5 | 78.6 ± 9.8 | <0.01 |
| (mmHg) | | | |
| LV Diastolic Pressure | 8.0 ± 3.8 | 5.0 ± 2.8 | n.s. |
| (mmHg) | | | |
| Heart weight before | 504.4 ± 53.8 | 484.0 ± 95.4 | n.s. |
| (g) | | | |
| Heart weight after (g) | 576.4 ± 71.5 | 559.2 ± 102.7 | n.s. |

Canrenone reversed the transcriptomic alterations associated with cold preservation in multiple individual human cardiac cell types including cardiomyocytes as determined by single-cell transcriptome sequencing. Pathway genes associated with the negative impact of cold preservation which were reversed by canrenone treatment include those related to mitochondrial energetics, cardiac contractility, cell death, and inflammatory mediators (FIGS. 15A-15B, FIGS. 16A-16B, FIGS. 17A-17B, FIGS. 18A-18B, FIGS. 19A-19B, and FIGS. 20A-20B). Pseudo-time analysis of the density distribution of differentially expressed genes also confirmed the ability of canrenone to mitigate the cold preservation associated with cellular transcript expression and trajectory patterns related to muscle contraction and inflammation within human donor hearts (FIGS. 21A, 21B, and 21C). Besides MR, canrenone can bind androgen, estrogen, and progesterone receptors which may lead to off-target effects. However, GSEA of preserved human hearts showed that canrenone treatment did not impact the expression of downstream targets of androgen, estrogen, or progesterone receptors (FIG. 22, FIG. 23, and FIG. 24).

### Inhibiting MR Alters the Genome Landscape

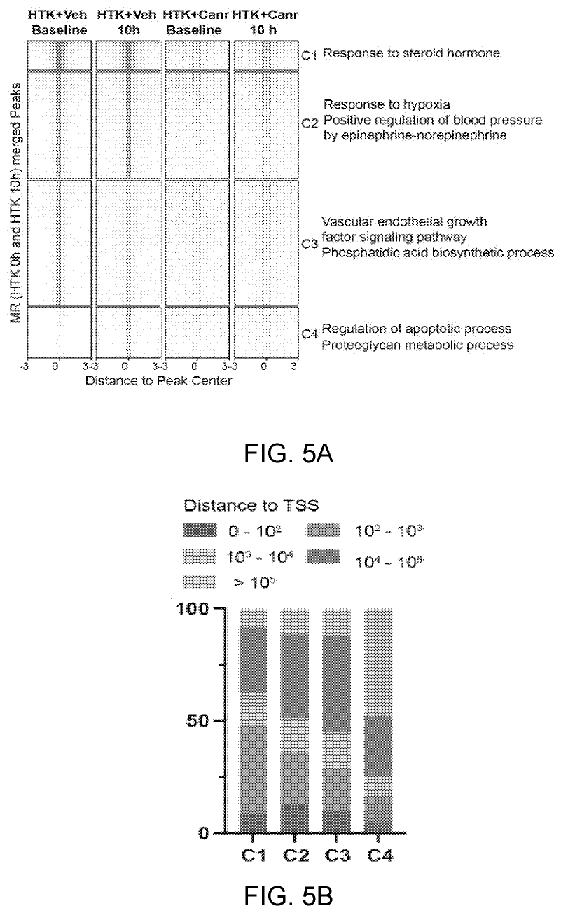

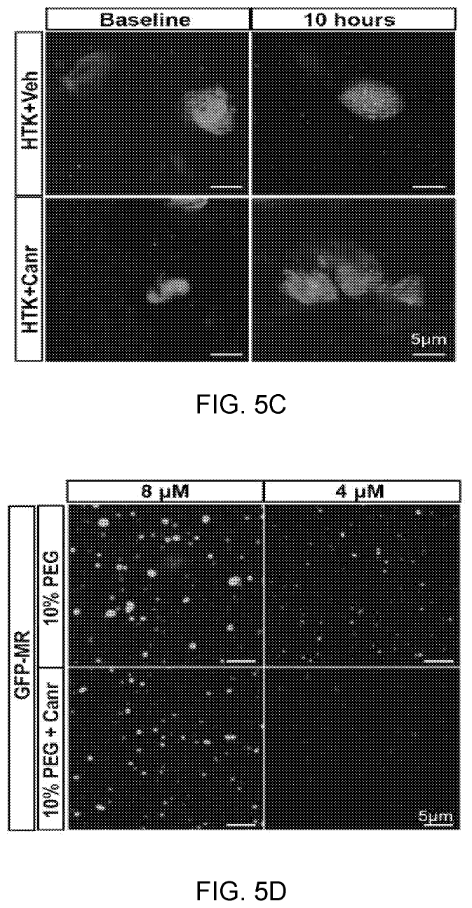

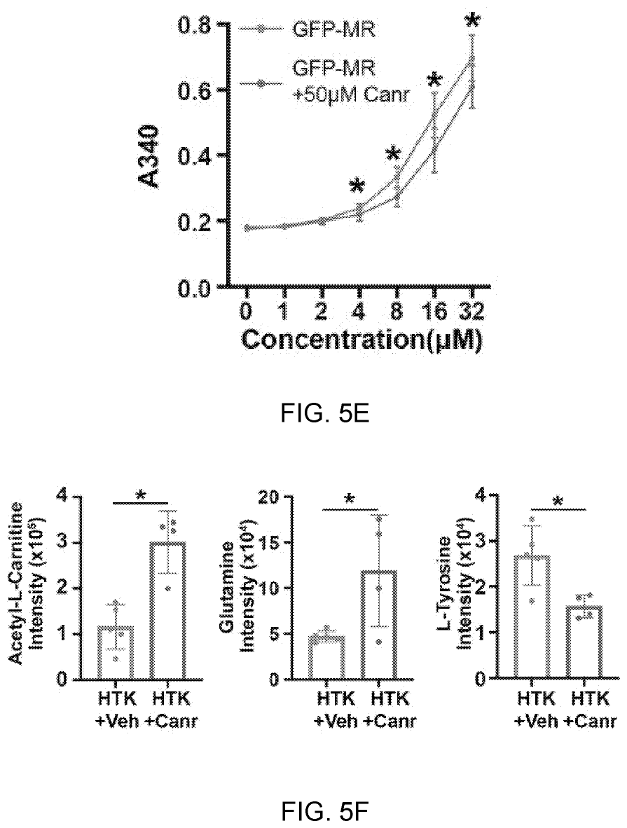

CUT&RUN was performed to determine MR binding sites to the DNA regions that correspond to downstream gene expression in human hearts (FIG. 5A). K means clustering revealed 4 major groupings of gene sets that correlate with preservation duration and response to canrenone treatment in human donor hearts during cold static preservation. By 10 hours with HTK preservation alone compared with baseline, there was increased MR binding to gene sites related to hypoxia and catecholamine responses (in cluster (C) 2) as well as apoptosis (C4) but a reduction in binding to vascular endothelial growth factor gene sites (C3). Bearing in mind that the donor heart is already exposed to canrenone for about 20 minutes at the baseline time point given procurement logistics, it was already shown that a reduction of binding to genes related to response to steroid hormone (C1) as expected, response to hypoxia (C2), and vascular endothelial growth factor signaling (C3). While binding to these genes did increase by 10 hours of preservation with canrenone, the frequency is overall less than with HTK preservation alone. MR binding gene target related to apoptosis (C4) with canrenone treatment at 10 hours was much lower than HTK alone (FIG. 5A).

The peaks in C3 and C4 have the longest DNA distances from MR binding site to the transcriptional start site (TSS) suggesting greater activation of enhancer elements in addition to promoter binding in the expression of mediators of vascular endothelial growth factor signaling, apoptotic and metabolic processes (FIG. 5B). These changes in genome architecture reflect altered MR binding patterns to DNA and correlate with reduced MR phase separation induced by canrenone treatment during cold preservation of human hearts (FIG. 5C). In-vitro droplet assay confirms that MR antagonism with canrenone increases the concentration threshold needed for MR phase separation as shown by imaging (FIG. 5D) and turbidity quantification (FIG. 5E).

### MR Inhibition Improves Heart Metabolism.

Canrenone treatment increased the abundance of metabolic substrates for energy production such as acetyl-L-carnitine which is a precursor to acetyl-CoA. Glutamine was also increased with canrenone treatment, and this was reported to be cardioprotective for ischemia-reperfusion by increasing flux through the hexosamine biosynthesis pathway and by increasing protein O-GlcNAc levels. Conversely, canrenone reduced the abundance of harmful L-tyrosine which has known direct cardiac effects of reducing heart rate and contractile force (FIG. 5F).

### LLPS is a Theme for Organ Preservation

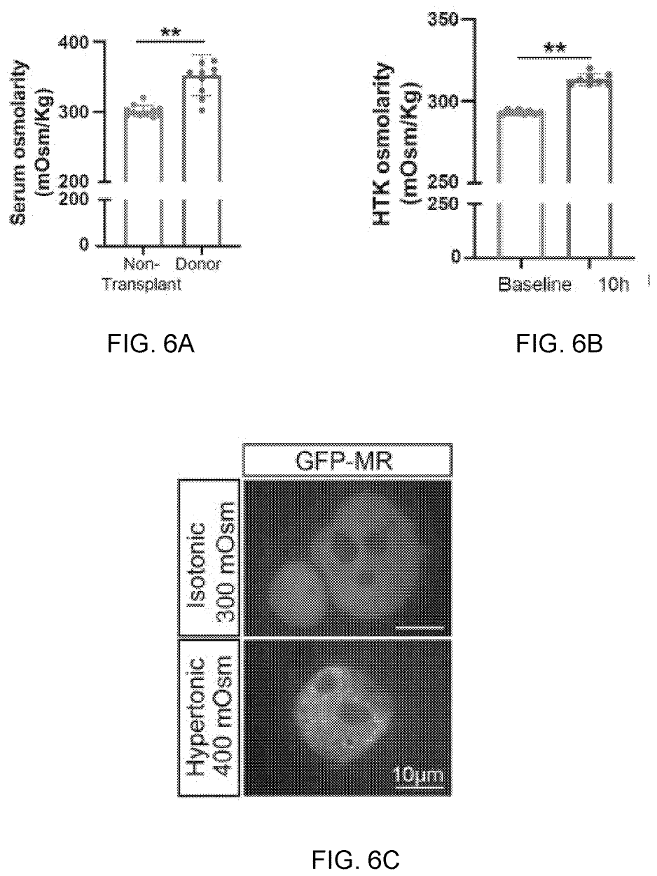

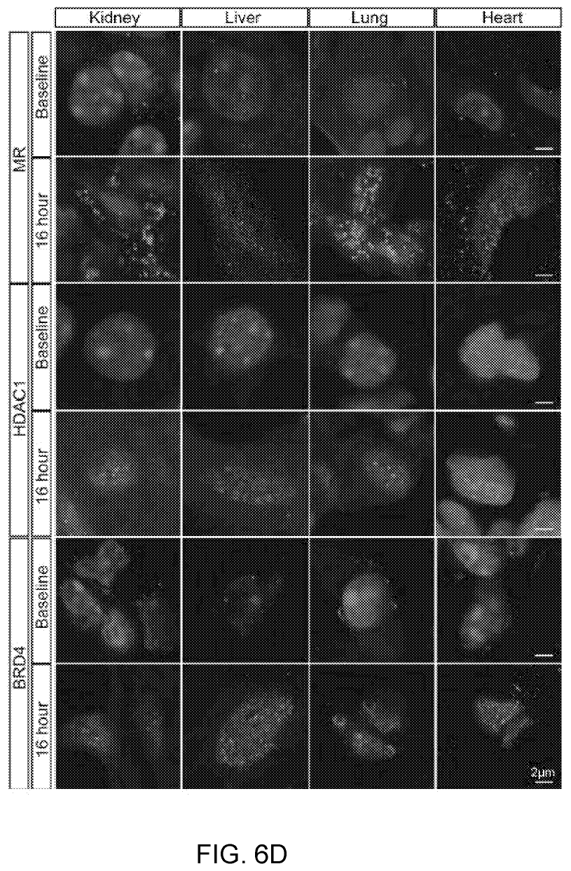

Increased osmolality is known to reduce the threshold for LLPS through the promotion of molecular crowding. Condensate formation is also recognized as a mechanism for responding to cellular stress. Comparing the serum osmolality from living human individuals to that of organ donors, it was noted that there was significantly elevated serum osmolality in organ donors (301.18±8.23 vs. 352.27±20 23.31 mOsmol/kg, P=0.001, FIG. 6A). Preservation solution also underwent a modest osmolality increase while human donor hearts are under cold static storage (293.25±1.28 vs. 313.25±3.89, P<0.001, FIG. 6B). To test the physiological relevance of these increases in osmolality, it was confirmed that an increase of 100 mOsm above physiological levels was sufficient to induce robust MR LLPS in cardiomyocytes (FIG. 6C). Condensate formation was evaluated in a variety of murine organs to determine if molecular LLPS is a shared theme in organ preservation biology. Indeed, MR condensate formation during preservation was also demonstrated for kidney, lungs, and hearts, but not in the liver (FIG. 6D). Phase separation for other transcriptional mediators also occurred in an organ specific manner. Increased HDAC1 condensates were seen in kidney, liver, and lungs but not in hearts. Interestingly, a preservation-related increase in BRD4 phase separation was appreciated in all organs examined (FIG. 6D). The biological significance of other type of molecular condensates have yet to be determined.

Cardiomyocyte-Specific Brd4 Heterozygous Deletion Improves Ex-Vivo Donor Heart Function after Preservation.

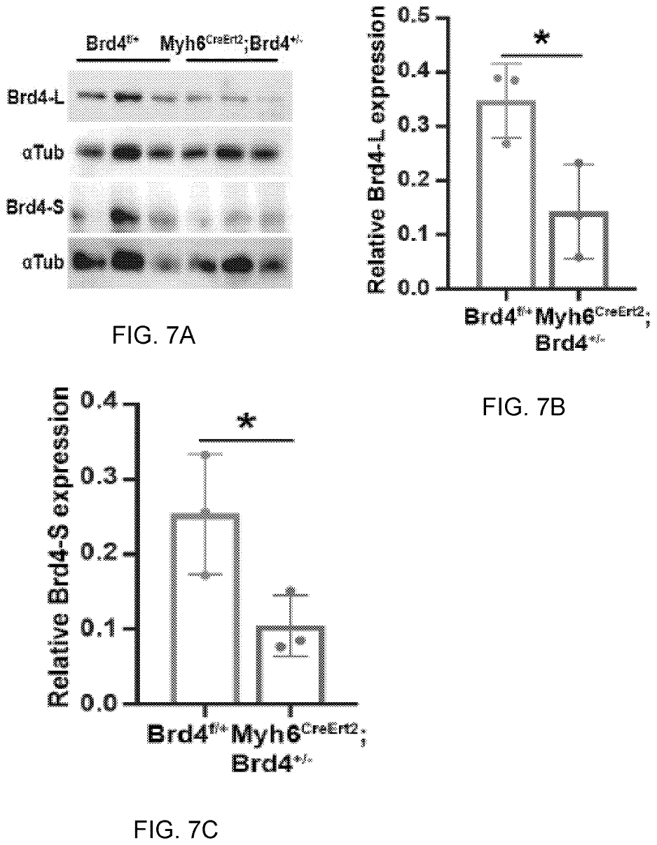

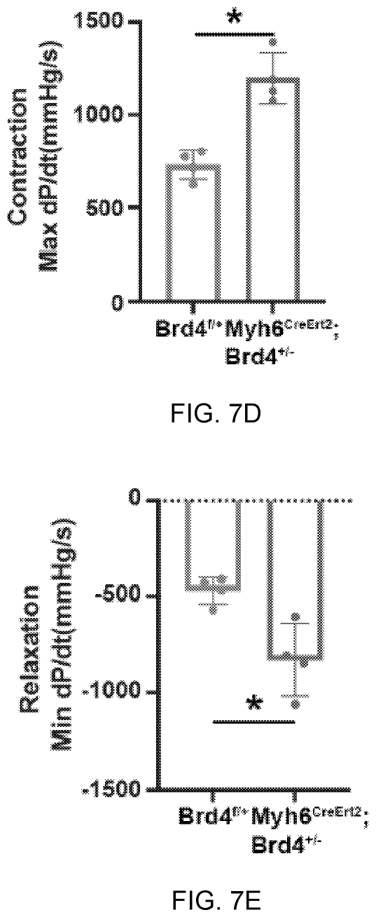

Myh6^{CreErt2}; Brd4^{f/+} mice were cross bread with Brd4^{f/+} mice to generate inducible cardiomyocyte-specific Brd4 heterozygous deletion mice (Myh6^{CreErt2}; Brd4^{+/-}). Western blot confirmed reduced Brd4-S and Brd4-L protein expression in Myh6^{CreErt2}; Brd4^{+/-} hearts (FIG. 7A, 7B, and 7C). Myh6^{CreErt2}; Brd4^{+/-} hearts had improved cardiac function (FIGS. 7D and 7E). The preliminary data showed that Brd4-S is preferentially increased during preservation. These results support the hypothesis that reducing Brd4-S during preservation is beneficial.

Cold Preservation-Perfusion of Human Donor Hearts is Associated with Altered Chromatin Folding at BRD4 Sites.

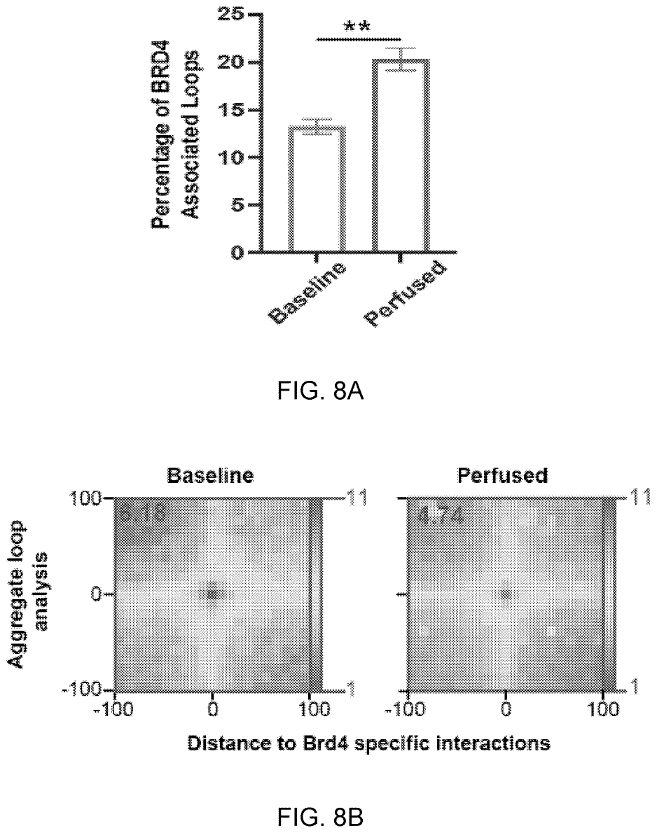

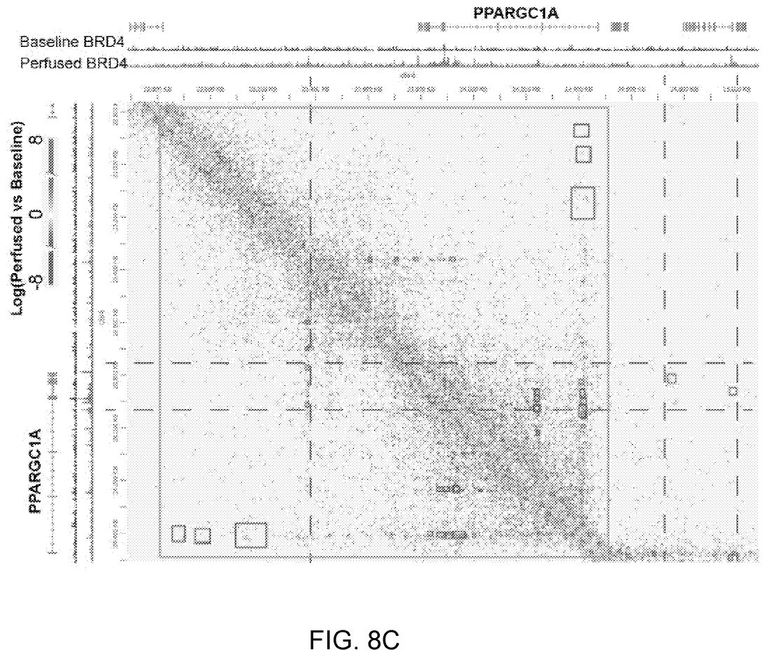

Hi-C sequencing for 3D chromatin structure was performed on the LV of human donor hearts at baseline and after perfusion following 10 hours of cold static preservation as previously described. About 2.4 billion pair-end reads per group were sequenced, which yielded 724 million and 652 million validated contacts from baseline and perfused samples respectively, indicating technical Hi-C success. cLoops2 were used to identify chromatin loops which are focal areas of high spatial interaction frequency between two linearly distant genomic regions forming a “3-dimensional loop”. About 16 thousand chromatin loops were identified in each sample. By analyzing the overlaps of the loop anchors (i.e., interaction sites) and BRD4 binding sites at baseline, it was found that about 14% of loops are associated with BRD4 binding. The cold-preservation-reperfusion process significantly increased the number of BRD4-associated loops (FIG. 8A), indicating a potential role for BRD4 in modulating chromatin looping formation. However, Aggregate Peak Analysis (APA), which averages the chromatin interaction signals of BRD4-associated loops, showed that the altered BRD4-associated loop conformation in perfused hearts have less chromatin interaction strength or frequency compared to BRD4-associated loops at the baseline condition (FIG. 8B). It is possible that the weaker BRD4-associated loops will be more responsive to drug interventions. Decreased mitochondrial turnover was observed in BRD4-S knockdown hearts, the PPARGC1A locus (a mitochondrial biogenesis regulator) was selected to examine potential alterations in chromatin architecture in response to cold preservation-reperfusion. Following reperfusion, the anchor locus of gained chromatin loops (red rectangles) demonstrated increased BRD4 occupancy (red peak) (FIG. 8C). The proposed studies are supported by these preliminary data suggesting that cardiac preservation quality may be determined by altered 3D chromatin architecture associated with changes in BRD4-S chromatin binding.

### Example 2. Epigenetic Regulation and Pharmacological Strategies for Enhancing Preservation of Aged Donor Hearts in Transplantation

Aim 1: To Determine the Mechanism by which Brd4 Modulates the Epigenetic Landscape of Old Donor Hearts During Preservation (FIG. 25A).

Rationale: Epigenetic dysregulation is an important mechanism leading to cardiovascular disease (CVD) during aging. Most current studies focus on how a specific disease process (e.g., atherosclerosis, heart failure) is influenced by certain epigenetic modifiers. However, the mechanisms by which the natural aging process contributes to ischemia-reperfusion injury are less well studied. The modifying effects of aging on disease are very important since old human donor hearts are more vulnerable to cardiac preservation and are usually passed over for transplantation. Brd4 was identified as an important injury susceptibility factor for old donor heart preservation. This was shown through pharmacological Brd4 inhibition and by murine genetic Brd4 knockdown models. The analysis of the 3D chromatin structure showed an increase in BRD4-associated chromatin loops in old human donor hearts compared to younger hearts at baseline. BRD4-associated looping further increased following preservation-reperfusion suggesting that BRD4 likely plays an important role in determining chromatin structure during preservation and this has important implication for differential gene expression after reperfusion. Chromatin structural changes that may be impacted by Brd4 in the setting of aging include resetting the 3D chromatin boundary of (A) “open or active, euchromatin” and (B) “closed, heterochromatin” compartments. The boundary of topological associating domains (TAD) within the compartment may also be rearranged by Brd4 binding leading to changes in promoter-enhancer looping. The age-related 3D chromatin reorganization may prime older donor hearts to be more susceptible to cold preservation injury. These chromatin remodeling events may alter cellular responses during the organ preservation timeframe since histone modification and chromatin loops can occur from minutes to a couple of hours leading to altered gene expression. Brd4 hyperactivation will be evaluated to determine if it induces a chromatin architecture that characterizes greater biological age in older donor hearts which sensitizes them to ischemic injury.

1. Old Murine Donor Hearts have Reduced Ex-Vivo Function after Cold Preservation.

Young and old murine hearts were isolated and preserved in cold (4° C.) HTK for 4 or 20 hours. Subsequent ex-vivo reperfusion of old hearts showed decreased contraction (FIG. 26A) and relaxation (FIG. 26B) compared to young hearts (FIG. 2).

### 2. Upregulation of Brd4 in Old Human Hearts.

Single nuclei-RNA seq (snRNA-seq) analysis using LV of human donor hearts showed that BRD4 mRNA expressions were upregulated in the fibroblasts and cardiomyocytes of old human donor hearts (FIG. 27A). Cleavage Under Targets and Release Using Nuclease (CUT&RUN) analysis showed that BRD4 genomic occupancy increased in old hearts compared to young at BRD4 peaks (FIG. 27B). Thus, the BRD4 mediated-epigenetic remodeling is likely increased in old donor hearts.

3. Old Donor Hearts have Increased Chromatin Accessibility.

Single nuclei Assay for Transposase-Accessible Chromatin (snATAC-seq) showed slightly increased chromatin accessibility at the transcription start site (TSS) regions of cardiomyocytes in old donor hearts compared to young (FIG. 28A). An example of increased chromatin accessibility was shown at the enhancer region for the senescent gene CDKN1 Å (FIG. 28B).

4. Old Donor Heart is Associated with Altered Chromatin Folding at BRD4 Sites.

Increased chromatin accessibility is generally associated with gained chromatin loops since loops are needed to expose genes for transcription. To assess the chromatin architectural changes during cardiac aging, Hi-C sequencing for 3D chromatin structure was performed on the LV of young and old human donor hearts. ~1.2 billion pair-end reads per condition were sequenced, which respectively yielded 392 million and 300 million validated contacts from young and old hearts affirming a successful Hi-C experiment. cLoops2 was then used to identify chromatin loops, which are focal areas of high spatial interaction frequency between two linearly distant genomic regions. ~16 thousand chromatin loops were identified in each sample. By overlapping analysis of the loop anchors (i.e., interaction sites) and corroborating with BRD4 binding sites, it was found that about 10% of loops are associated with BRD4 binding in the young donor hearts compared to 14% in old human hearts (FIG. 29A), indicating a potential role for BRD4 in modulating chromatin looping formation. In addition, Aggregate Peak Analysis (APA), which averages the chromatin interaction signals of BRD4-associated loops, showed that the altered BRD4- associated loop conformation in old hearts have more chromatin interaction strength or frequency compared to BRD4-associated loops at the young heart (FIG. 29B). To explore the effects of chromatin changes, the 3D chromatin structure at the genomic regions of the senescence protein marker is examined (CDKN1A, p21). During aging, two long-range interaction loops at CDKN1 Å locus (light blue rectangle) were specifically identified in the old heart (FIG. 29C). The CDKN1A anchor of the newly formed loop is associated with increased BRD4 binding, again suggesting a potential role of BRD4 in altering chromatin looping.

### 5. Cold Preservation-Reperfusion Amplified Aged-Induced Epigenomic Changes.

CUT&RUN analysis showed that BRD4 genomic occupancy increased in old hearts at baseline compared to young, and BRD4 occupancy further increased after 10 hours of cold preservation followed by blood reperfusion in old donor hearts (FIG. 30A). To assess the potential impact of increased BRD4 binding on the chromatin loops, the overlap of the BRD4 binding sites and anchors of chromatin loops were examined. The BRD4-associated chromatin loops are significantly increased in the old donor hearts followed by cold preservation-reperfusion (FIG. 30B). Aggregate Peak Analysis (APA) was used, which averages the interaction signals at the selected genome position (i.e., chromatin anchor binding strength). This showed that although BRD4-associated loop numbers are increased after preservation-reperfusion, the chromatin anchor interaction strength at BRD4 binding sites is decreased compared to the baseline condition (FIG. 30C). The weaker chromatin interaction strength suggests that BRD4-associated chromatin loop changes occurring after preservation-reperfusion may be particularly susceptible drug targets for restoring the cardiac chromatin to its baseline conformation.

### 6. JQ1 Targets Brd4 to Improve Both Young and Aged Donor Heart Preservation.

To examine whether JQ1 targets donor heart Brd4 during cold preservation, biotin was attached to the JQ1 and the JQ1- biotin was added to the HTK preservation solution. The preserved hearts were double stained with biotin and Brd4 antibody. A colocalization of JQ1 and Brd4 staining was found, suggesting JQ1 could target Brd4 in a cold cardiac preservation setting (FIGS. 31A and 31B). JQ1 improved both young and old heart ex-vivo function after 20 hours of cold preservation. Notably, JQ1 also restored post-preservation cardiac function in old hearts to levels comparable to young hearts (FIG. 3IC-31D).

### 7. Cardiomyocyte-Specific Brd4 Heterozygous Deletion Improves Young Donor Heart Preservation.

Myh6^{CreErt2}; Brd4^{f/+} mice were cross bred with Brd4^{f/+} mice to generate inducible cardiomyocyte-specific Brd4 heterozygous deletion (Myh6^{CreErt2}; Brd4^{+/-}) mice. Western blot confirmed reduced Brd4 protein expression in Myh6^{CreEr2}; Brd4^{+/-} hearts (FIGS. 32A and 32B). Myh6^{CreErt2} hearts showed improved cardiac function after preservation-reperfusion (FIGS. 32C and 32D).

### 8. Brd4 Knockdown Improves Aged Donor Heart Preservation.

To further confirm Brd4's role in modulating cardiac preservation quality, a miR30-based AAV9 delivery system was used to reduce cardiomyocyte-specificBrd4 expression in aged donor hearts. 5×10 vg AAV9 virus was injected into the tail vein of 24-month-old mice (FIG. 33A). After four weeks, Brd4 knockdown was validated by qPCR (FIG. 33B). Brd4 knockdown greatly improved old donor heart function after 20 hours of prolonged cold static preservation (FIGS. 33C and 33D). Brd4 knockdown also led to increased average conduction velocity and favored an organized rhythm (FIGS. 33E and 33F).

### 9. Brd4 Knockdown Reduced Mitochondria Turnover Following Cold Static Preservation-Reperfusion.

The α-MHC MitoTimer mice have a cardiac-specific expression of mutated dsRed protein (dsRed1-E5) which is mitochondria-targeted. The baseline green color of the protein is converted to a red color when oxidized. The green signal represents the newly synthesized mitochondrial protein, while the red signal indicates older mitochondrial proteins. The sheGFP or shBrd4 AAV9 viral constructs were administered to the α-MHC MitoTimer mice for Brd4 knockdown. Compared to freshly procured baseline hearts, a reduced red-to-green signal is noted in mice hearts infected with sheGFP (control) suggesting increased mitochondrial turnover. Conversely, hearts infected with shBrd4 had relatively increased red-to-green signal intensity, indicating reduced mitochondrial turnover (FIGS. 34A and 34B). This is consistent with prior reports showing that suppressing mitochondrial turnover protects against injury from myocardial infarction.

10. BRD4 Interacts with Known Epigenetic Cofactors that Mediate Histone Modifications to Impact Chromatin Architecture.

BRD4 interacts with G9a (a lysine methyltransferase) and NIBPL (a major subunit of the cohesin loading complex) (FIG. 35) in AC16 cardiomyocytes. Given the known roles of Brd4 in gene suppression and genome folding, these results suggest that BRD4 may recruit specific co-regulators to govern histone modification and chromatin architecture in old donor heart preservation.

### Description of Preservation and Reperfusion Methods in Aim 1

### A. Murine Donor Heart Isolation, Preservation and Ex-Vivo Perfusion.

Briefly, hearts are preserved with clinically utilized HTK solution infused into the aorta. After excision, the heart will be immersed in cold (0° C.) HTK bath for 20 hours as the time threshold determined from prior experiments. Hearts are then recovered for ex-vivo perfusion. The dose-response relationships between preservation time and LV function were previously determined. It was found that that functional impairment is marked at 20 hours of storage, but the heart remains reliably contractile with a sinus rhythm, as corroborated by other groups. After 30 min of reperfusion, the function is assessed via a balloon inside LV cavity. After 1 hour of reperfusion, donor hearts will be examined by electrical systems (Mapping Lab, U.K.)

### B. Murine Heterotopic Heart Transplantation.

Donor hearts from donor mice on a C57BL/6J background are transplanted into the cervical region of gender-matched syngeneic wild-type C57BL/6J mice as recipients as was previously done. The right external jugular vein and common carotid artery are divided, with the ends passed through a polyethylene cuff. The donor's pulmonary artery is pulled over the recipient's vein cuff. Anastomosis of the donor's ascending aorta and the recipient's artery are similarly performed. The donor heart is reperfused, and hemodynamics are assessed in vivo after 24 hours using a conductance catheter placed inside the LV The 24-hour time was chosen as there will still be functional deficits from ischemic injury. The heart is more pristine at this time, with minimal scarring or inflammation of local tissue, which may confound the analysis.

### Aim 1.1. To Determine how Brd4 Impacts Donor Heart Preservation in the Setting of Cardiac Aging.

### 1.1.1. To Examine if Brd4 Inhibition by JQ1 Improves Old Donor Heart Preservation in the Transplant Setting.

Young (3 months old) and old (24 months old) C57B6 mice will be preserved in cold HTK±JQ1 (1 μM) for 20 hours and reperfused by syngeneic heterotopic transplantation (n=10/group) thus incorporating recipient responses. These transplant models will corroborate with prior JQ1 treatment studies using ex-vivo perfusion. The following will be evaluated: 1) Cardiac function using a conductance catheter; 2) Cardiac conduction pattern using an electrical mapping system; 3) Brd4 expression; 4) Cell death (Terminal deoxynucleotidyl transferase dUTP nick end labeling (TUNEL) stains and western blot for cleaved Caspase-3, Bax, and Bcl-2 expression); and 5) Mitochondrial metabolite analysis as was done before. For recipient responses, both 1) Leukocyte infiltration by staining for leukocytes (CD45⁺), macrophages (F4/80⁺), T cells (CD3⁺), B cells (CD19⁺) and 2) Circulating markers of cardiac injury (Troponin I, mitochondrial DNA) will be assessed.

### 1.1.2. To Examine if Cardiomyocyte Brd4 Heterozygous Deletion Improves Old Donor Heart Preservation Quality.

Inducible cardiomyocyte-specific Brd4^{+/-} mice will be generated by crossing Myh6^{CreErt2}; Brd4^{f/+} and Brf4^{f/+} mice as was described in the preliminary data. Since these studies were only previously performed in young mice, Brd4 heterozygous deletion will be induced in old mice by daily tamoxifen injections over 3 days. The hearts will be isolated and preserved in a cold HTK for hours. The impact of reduced Brd4 expression on old heart function compared to old wildtype littermates will be assessed by ex-vivo perfusion and heterotopic transplantation (n=10/group). The cardiac preservation quality will be determined as per Aim 1.1.1.

### 1.1.3. To Examine if Brd4 Overexpression in Young Hearts Recapitulates the Age-Associated Phenotype of Reduced Ischemic Tolerance During Cold Preservation.

The inducement of cardiac-specific overexpression of BRD4 or GFP in 3-month old mice will be accomplished using AAV9 containing Brd4 or eGFP control driven by cTnT promoters, as was done previously. Donor hearts are procured four weeks after AAV9 injection, subjected to hours of cold preservation followed by reperfused with an ex-vivo system and heterotopic transplantation (n=10/group). Cardiac hemodynamics, cardiac electrical conduction, cell death and mitochondrial metabolism will be assessed as described in 1.1.1.

Aim 1.2. To Determine the Epigenetic Mechanism by which Brd4 Mediates the Vulnerability of Old Donor Hearts to Preservation.

### 1.2.1. To Define the Co-Factors of Brd4 in the Donor Hearts During Aging.

Young (3 months) and old (24 months) hearts will be collected immediately after procurement (baseline) or following preservation-reperfusion. Co-immunoprecipitation (Co-IP) using Brd4 antibody will be performed on the LV. Mass spectrometry of eluded co-IP proteins will be performed to identify differential cofactor association with Brd4 between old and young hearts. It is expected that aging-specific cofactors that partner with Brd4 to mediate the observed old heart phenotype, as well as related epigenetic and 3D genomic landscape, will be identified.

1.2.2. To Determine the Brd4 Genomic Targets that Sensitize Old Donor Hearts to Preservation.

Inducible cardiomyocyte-specific Brd4^{+/-} mice will be generated as described in 1.1.2. Donor hearts will be stored in cold HTK for 20 hours followed by 1 hour of ex-vivo perfusion. Single nuclei RNA-seq will be performed using isolated LV tissue to compare the single nuclei transcriptome between the WT and Brd4^{+/-} mice at different ages (n=3/group) as was done in the preliminary results. LV tissue (n=3/group) will also be examined using CUT&RUN-seq with Brd4 antibodies to study the chromatin targets of Brd4. Specifically, β-gal and DNA damage markers such as γH2Ax will be stained for to verify the effects of Brd4 heterozygous deletion on cellular senescence. Another focus will be on the downstream genes related to mitochondrial integrity including TFAM, PGC-1α and Drp1.

### 1.2.3. To Define if Reduced Brd4 Expression or Inhibition During Old Heart Preservation can Restore the Baseline Chromatin Configuration at the Time of Cardiac Procurement.

WT, Brd4^{+/-} and JQ1-treated old hearts will be isolated as described previously. To determine the effect of the JQ1 drug and Brd4 heterozygous deletion on the preservation-related changes in cardiac chromatin configuration, CUT&RUN- seq experiments will be performed using antibodies for H3K9me3 and H4K16ac as well as other co-factors of interest identified in 1.2.1. Single nuclei ATAC-sequencing will also be performed to determine chromatin accessibility in these hearts as shown in the preliminary data. Chromatin co-occupancy of Brd4 with identified epigenetic modifying cofactors specific for aging (defined in Aim 1.2.1) will support the role of Brd4 in modulating chromatin accessibility in old hearts by specific epigenetic cofactor recruitment. HiChIP studies will also be performed to examine Brd4-mediated chromosomal architecture changes related to aging and therefore contribute to old heart-specific cold preservation responses. HiChIP is a variant of Hi-C experiments with an additional ChIP step to enrich for chromatin looping mediated by the protein of interest (i.e., Brd4). This will define the direct effects of JQ1 and Brd4^{+/-} on restoring the baseline epigenetic and 3D chromatin architecture at the time of cardiac procurement.

### Aim 2. To Determine Whether Increased Brd4 Recruitment to the Genome of Old Donor Hearts is Mediated by Increased Histone Acetylation Due to Changes in NAD⁺ Availability (FIG. 25B).

Rationale: It is proposed that metabolic stress which influences NAD⁺ availability plays an important role in epigenetic and 3D chromosomal conformational changes in the setting of cardiac preservation. Brd4 inhibition with JQ1 drug reduces Brd4 interaction with acetylated histone through the antagonism of Brd4's bromodomain. The preliminary data showed that JQ1 could improve old donor heart function after cold preservation. This suggests that reduced Brd4 binding to the lower levels of acetylated histone is beneficial for old donor heart preservation quality. Conversely, Brd4 is able to interact more frequently with acetylated histone if more of these are available. This can occur when there is reduced histone deacetylase activity. It is proposed that this occurs in the setting of metabolic stress with lower NAD⁺ levels leading to reduced deacetylase activity of Sirt proteins. Indeed, the studies showed that preserved old human donor hearts have increased H4K16ac, a known target for Sirt6 deacetylation. The finding that NAD⁺ is similarly reduced in the old human hearts compared to young hearts also suggests a reduction in Sirt6 deacetylase activity. Thus, the preliminary data leads to the hypothesis that the Brd4 bromodomain senses cellular stress through NAD⁺ induced changes in histone acetylation status and thereby mediates changes in 3D chromatin architecture, gene expression and vulnerability to ischemia in older donor hearts. 1. The decline of NAD⁺ is associated with Increasing aging and cold preservation in human donor hearts.

It was found that human LV collected at baseline shows reduced NAD⁺ abundance with increasing donor age (FIG. 36A). This is a trend previously reported for many other aging organs. Interestingly, NAD⁺ levels are further decreased following cold preservation of human donor hearts (FIG. 36B). An increase in acetylated histones (H4K16ac) was observed in old hearts at baseline (FIG. 36C). Given lower NAD⁺ levels in old hearts, increased H4K16ac can be explained by Sirt's dependence on NAD⁺ for deacetylase activity.

### 2. Chemically Induced Reduction of NAD⁺ Levels Impairs Ex-Vivo Donor Heart Function.

FK866 treatment can reduce NAD⁺ levels in the heart by inhibiting nicotinamide phosphoribosyltransferase (Nampt), an enzyme that mediates NAD⁺ production 100. Young C57B6 mice were treated with FK866 to induce a reduction in cardiac NAD⁺ levels. Subsequent ex-vivo perfusion significantly reduced cardiac function after prolonged cold preservation (FIGS. 37A and 37B). Accordingly, H4K16ac was increased in the FK866-treated hearts, a Sirt6 deacetylase target (FIG. 37C).

3. Old Donor Hearts have Increased BRD4 Genome Occupancy at SIRT6 Target Sites after Preservation-Reperfusion.

To determine if the NAD⁺-SIRT6 has a direct effect on BRD4 genomic recruitment, an examination of BRD4 occupancy at human donor hearts found an increase of BRD4 binding in the SIRT6 peaks of old donor heart after 10 hours of cold storage followed by reperfusion (FIGS. 38A and 38B).

### Aim 2.1. To Determine if NAD⁺ Availability Impacts Brd4- Mediated Epigenetic and Chromatin Architectural Remodeling to Influence Donor Heart Preservation Quality in the Context of Aging Phenotypes.

2.1.1. To Examine if a Genetic Model that Reduces NAD⁺ Abundance in Young Donor Hearts can Phenocopy the Sensitivity of Old Donor Hearts to Preservation Injury and Define its Impact on Brd4 and Sirt6 Genomic Recruitment.

Previously, a murine Nampt^{-/-} model is shown to reduce NAD⁺ abundance in tissues. These mice are known to survive to adulthood since other sources of NAD⁺ do exist. To test whether this model will affect Brd4 and Sirt6 binding to the genomic targets through aforementioned mechanisms, a tamoxifen-inducible cardiomyocyte-specific Nampt^{-/-} mice (Myh6^{CreErt2}; Nampt if) will be generated by crossing the Nampt f with Myh6^{CreErt2} mice resulting in a model with reduced NAD⁺ abundance in cardiomyocytes. Tamoxifen will be injected into 3-month-old Myh6^{CreErt2}; Nampt^{f} mice to remove endogenous cardiomyocyte Nampt and reduce NAD⁺ levels in heart. The hearts are preserved in cold HTK for 20 hours and reperfused with an ex-vivo system or heterotopic transplantation (n=10/group). Cardiac preservation quality will be determined by assessing hemodynamics, electrical conduction, cell death and metabolism as described in Aim 1.1.1. The effects of reduced NAD⁺ levels on the genomic recruitment of Brd4 and Sirt6 by CUT&RUN analysis will also be determined.

### 2.1.2. To Examine if Sirt6 Deletion in Young Mice Recapitulates Old Donor Heart Vulnerability to Preservation Injury and Impacts Brd4-Mediated Chromatin Remodeling.

Sirt6^{f/f} (017334) will be crossed Myh6^{CreEr2} to generate Myh6^{CreE2}; Sirt^{f/f} mice. In young mice (3 months old), tamoxifen will be injected for 3 days to remove endogenous cardiomyocyte Sirt6 expression. The hearts will be isolated and preserved in cold HTK for 20 hours and reperfused with an ex-vivo system and heterotopic transplantation (n=10/group). Cardiac preservation quality will be determined as per Aim 1.1.1. The effects of Sirt6 knockout on Brd4 genomic occupancy by CUT&RUN and Brd4-associated 3D chromatin conformation changes by HiChIP, as described in Aim 1.2.3, will also be determined.

### Aim 2.2. To Define if the Bromodomain of Brd4 is an Effective Therapeutic Target for Reducing the Vulnerability of Old Donor Hearts to Preservation Injury.

To examine if preventing the Brd4 bromodomain from recognizing the acetylated lysine on histones can protect older donor hearts from excess preservation injury. This will necessitate the generation of cTnT promoter-driven AAV9 containing wild-type Brd4 or mutant Brd4 which harbors the Y139A and Y433A mutation. These mutations prevent the bromodomain from recognizing and binding to acetyl-lysine. Four weeks after AAV9 mediated expression of aforementioned Brd4 constructs in the hearts of old Myh6^{CreErt2}; Brd4^{f/f} donor mice as was done before tamoxifen will be administered to remove endogenous cardiomyocyte Brd4 to generate mice expressing WT or mutant Brd4. Hearts will be isolated and preserved in cold HTK for 20 hours and reperfused with an ex-vivo system or heterotopic transplantation (n=10/group). Cardiac hemodynamics, cardiac electrical conduction, cell death and metabolism will be assessed as described in 1.1.1. Young donor hearts will be included as control for the epigenetic landscape references. To determine if the bromodomain of Brd4 is required for the Brd4-induced epigenetic and 3D chromatin architectural restructuring in old donor hearts. CUT&RUN-seq, ATAC-seq and HiChIP experiments will be performed comparing the epigenetic and 3D chromatin landscape for ex-vivo perfused young hearts as well as wild-type and Brd4 mutant old donor hearts. The effect of Brd4 bromodomain mutants on the recruitment of Brd4 cofactors identified in 1.2.1. will also be examined.

### Aim 3: To Determine if Pharmacological BRD4 Inhibition Improves Old Human Donor Heart Preservation Quality (FIG. 25C).

Rationale: JQ1 is a well-known BRD4 antagonist from which many analogs have been developed and evaluated in cancer clinical trials. Given the ongoing clinical evaluation of BRD4 inhibitors, the goal is to corroborate the murine findings with effectiveness in human hearts to verify clinical relevance. Pigs are used since their size and anatomy are very similar to humans. Healthy pig hearts are readily available to determine optimal JQ1 dosage. Evaluating the efficacy of JQ1 for improving human heart preservation will provide valuable data that is directly clinically relevant. It is recognized that human hearts made available for research likely have unfavorable features (e.g., old age, cardiac hypertrophy) that preclude transplantation. These old human donor hearts are suitable for obtaining human proof-of-concept results, which are essential for understanding the clinical response to Brd4 inhibition of old human donor heart.

JQ1 Treatment May Improve Pig Donor Heart Resilience to Preservation Injury after 18 Hours of Cold Perfusion Preservation.

Given advances in cardiac preservation technology towards cold perfusion, the studies of molecular therapies have been accordingly moved into this context. As cold preservation on ice for 10 hours leads to severe donor heart dysfunction. It was also confirmed that cold perfusion with HTK greatly improved cardiac preservation quality. Importantly, pig donor hearts were treated with JQ1 (5 μM, n=4/group) and preserved with the cold perfusion protocol for 18 hours followed by normothermic ex-vivo perfusion with donor blood. Comparing cold perfusion with HTK only vs. cold perfusion with HTK+JQ1, addition of JQ1 greatly increased contractility, improved relaxation, increased cardiac output and promoted coronary flow (FIGS. 39A, 39B, 39C, and 39D). While encouraging, more studies for dosage optimization are needed to validate the initial impressions.

### Description of Surgical Techniques and Protocols Used in Aim 3

### A. Porcine Donor Heart Isolation, Preservation and Ex-Vivo Perfusion.

A large animal ex-vivo heart perfusion system was established in the lab. Blood (1 liter) for ex-vivo perfusion is collected during cardiac procurement from 40-50 kg Yorkshire pigs. The ascending aorta is clamped then cold 4° C. HTK solution (1 liter, without drugs added) is infused into the aortic root at 80 mmHg to stop the heart. The heart is excised and a further 2 liters of HTK solution only, or HTK solution+JQ1 (5 μM) is infused at the back table in order to avoid exposure of other transplantable organs (e.g., lungs, liver) to study drugs in a procedure mimicking a clinical trial. The heart will then be immersed in a cold (6° C.) HTK bath and perfused with cold (6° C.) HTK at 10 mmHg for 18 hours as the time threshold determined from the prior experiments. Prior studies have identified the optimal temperature for cardiac preservation without ice formation at around 6° C. Cold perfusate samples are collected at the beginning and at completion (18 hours) of cold perfusion. Afterwards, hearts are retrieved for ex-vivo perfusion for 3 hours with donor blood. Hemodynamics are assessed using a conductance catheter in a load-independent “rest” mode and a load-dependent “working” mode by loading the left atrium at 6-10 mmHg as is done routinely in the lab. Blood samples are collected from the arterial perfusate and coronary sinus for analysis. Arterial and venous pO₂ are measured hourly. Electrolytes (K⁺, Na⁺, Ca⁺) and pH are maintained in normal range by providing insulin, glucose, CaCl₂, and HCO₃.

### B. Human Donor Heart Isolation, Preservation and Ex-Vivo Perfusion.

Human research hearts that are not used for clinical transplantation have been received from the “LifeSource” organ procurement facility (support letter provided). This is located within St. Mary Hospital (Mayo Clinic) with no additional travel needed from the laboratory. Donor hearts are procured using standard clinical protocols. Hearts available for research are not transplanted due to concerns such as advanced age, hypertrophy, and coronary disease. Study inclusion criteria are >50% LV ejection fraction and coronary disease involving <1 vessel. About hearts meeting these criteria can be accessed.

### 3.1 to Determine the Optimal JQ1 Dose in Improving Porcine Donor Heart Preservation.

Pig donor hearts will be used to optimize the JQ1 dosage for treatment of scarce human donor hearts. Unfortunately, it is unfeasible to obtain old pigs at a comparable chronological age relevant to humans. Therefore, dosage studies are based on pigs weighing 45-50 kg. Porcine donor hearts will be preserved with cold perfusion for 18 hours using HTK+JQ1 at varying dosages (1 μM, 5 μM, and 10 μM) versus HTK alone and the ex-vivo hemodynamics (e.g., dP/dt, cardiac output LV pressure) will be compared following reanimation. Each comparison group will have 8-10 donor hearts based on previously outlined statistics. LV samples obtained after perfusion for 3 hours will be assessed for cell death, inflammatory mediator expression, antioxidant protein expression, and leukocyte infiltration as outlined in aim 1.1.1. Ex-vivo circuit arterial perfusate and coronary sinus drainage will be analyzed for inflammation (e.g., IL-6, TNF-α, IL-1β), cardiac injury (e.g., troponin I, mitochondrial DNA), and lactate levels.

### 3.2. Determine the Efficacy of JQ1 in Improving Old Human Donor Heart Preservation Quality.

Young (age <35 years) and old (age >65 years) donor hearts will be used for these studies. Old human hearts will be preserved with cold perfusion using HTK only or HTK+JQ1 for 18 hours. JQ1 dosage for human hearts will be as determined in Aim 3.1. Young human hearts will be cold perfused with HTK only as a young reference control group. Hemodynamic evaluation and biochemical analysis of ex-vivo human donor hearts (n=8-10) will be completed as outlined in Aim 3.1. Due to the scarcity of human hearts, only the optimal dosage of JQ1 as determined in Aim 3.1 pig studies will be tested. Therapeutic drug dosages in adult pigs are expected to be similar to adult humans.

3.3. To Determine Whether Donor Hearts with High NAD⁺ Levels at the Time of Cardiac Procurement have Better Preservation Quality and Decreased BRD4 Recruitment to the Genome.

The donor serum and LV tissue will be collected at the time of human donor heart procurement at the donation facility (baseline). The NAD⁺ and other metabolites in the serum and LV tissues will be quantified using mass spectrometry as was done previously. By correlating with cardiac functional outcomes in 3.1, a linear progression analysis will be performed to test if increased NAD⁺ levels in serum or LV are correlated with improved donor heart preservation quality and/or reduced BRD4 genome occupancy by methods outlined previously. Determining NAD⁺ levels has important clinical relevance as point-of-care NAD measurement is likely to become available in the future.

### 3.4 Determine the Transcriptomic and Epigenetic Response of BRD4 Inhibition in Young and Old Human Hearts During Cold Preservation.

Single-nuclei RNA sequencing (snRNA-seq), ATAC-Seq, CUT&RUN-seq and HiChIP will be performed on young and old human hearts with or without JQ1 treatment as outlined in Aim 3.2. In addition, LV tissue obtained at different time points from the same heart will be used to examine for the progression of genomic changes during the organ preservation process. LV biopsies will be obtained 1) at baseline immediately after cardiac procurement; 2) at the end of 18 hours of cold perfusion preservation (without reperfusion); 3) after 3 hours of ex-vivo blood reperfusion. Chromosomal rearrangements and modifications induced by cold perfusion preservation and reperfusion will be assessed. snRNA-seq and snATAC-seq on these LV tissues will be performed as was done in preliminary studies. The combined snRNA-seq and snATAC-seq of the human left ventricle will: 1) Determine if there are differential human cardiac cell responses during the process of cold perfusion preservation and following reperfusion; 2) Define the specific cell types that targeted by JQ1 to reduce harmful gene expression; 3) Define the dynamics of BRD4 targets that occurs in young and old human hearts during cold perfused preservation and reanimation. The effects of JQ1 on histone modifications by CUT&RUN seq using H3K9me3 and H4K16ac on these hearts will also be determined. HiChIP will be performed to determine JQ1-induced 3D chromatin structure changes as previously described in aim 1.2.

### Example 3: Evaluation of Tissue Quality after Preservation with Brd4 Modulation

### Aim 1. To Determine the Mechanisms for Divergent Brd4 Isoform Expression Induced by Increased Ambient Osmolality and Cold Perfusion of Donor Hearts (FIG. 40A).

Rationale: The studies showed a clear increase in myocardial Brd4-S isoform expression in patients with chronic heart failure and during cold preservation of donor hearts. Genetic knockdown of Brd4-S significantly improved ex-vivo donor heart function. Preliminary results also showed that increased ambient osmolarity contributes to Brd4-S upregulation. A preservation system was developed that infused cold histidine-tryptophan-ketoglutarate (HTK) solution into donor hearts at a constant rate. This system significantly reduced the magnitude of Brd4-S expression and was associated with greatly improved donor heart function. HTK solution is a standard preservation solution used for clinical cold preservation of human donor hearts for transplantation. It is hypothesized that cold static preservation of donor hearts triggers an accelerated switch to prefer Brd4-S expression and thus contributes to cardiac injury.

### 1. BRD4-S was Upregulated in Human Failing Hearts.

Global RNA-seq of the LV showed that BRD4-S isoform is upregulated while BRD4-L is downregulated in human failing hearts compared to donor hearts with normal ventricular function (FIG. 4IA). There were no observed quantitative changes in total expression of BRD2, BRD3, BRD4, and BRDT (FIG. 4I).

### 2. BRD4-S was Upregulated in Human Donor Hearts During Cold Static Preservation.

The ratio of BRD4-S over BRD4-L mRNA expression in the LV gradually increased with progressively longer cold preservation duration (FIG. 42A). At the protein level, increased BRD4-S and reduced BRD4-L during cold preservation were also confirmed (FIGS. 42B and 42C). It is hypothesized that BRD4-S isoform is likely to mediate inflammation, oxidative stress and cell death in this setting.

3. JQ1, a Competitive Brd4 Inhibitor, Preferentially Colocalized with Brd4-S and Greatly Improved Murine Donor Heart Function after Prolonged Preservation Followed by Ex-Vivo Perfusion or Heterotopic Transplantation.

JQ1 is a Brd4 inhibitor targeting the bromodomain of Brd4-S and Brd4-L isoforms. To examine for preferential action of JQ1 on specific Brd4 isoforms, biotin was attached to the JQ1 drug and added into the HTK preservation solution. After preserving the heart for 16 hours, biotinylated-JQ1 and either Brd4-S or Brd4-L isoforms were double immunostained. It was found that JQ1 and Brd4-S staining colocalized mainly in the perinuclear region. Much less overlap was seen between JQ1 and Brd4-L staining. This suggests that JQ1 preferentially targets Brd4-S in the setting of donor heart preservation (FIGS. 43A-43B). Indeed, JQ1 improved cardiac function in both the ex-vivo (FIGS. 43C-43D) and heterotopic transplant settings (FIGS. 43E-43F).

4. Single-Nuclei RNA Analysis of Human Donor Hearts Showed Decreased Expression of RNA Splicing Factors in Cardiomyocytes During Storage. Reduced Expression of RNA Splicing Factors (e.g., RBFOX1, RBFOX2, RBM20, CELE1, TIA1, and SRSF1) Associated with Cold Preservation were Most Prominent in Cardiomyocytes Compared to Other Cell Types (FIGS. 44A-44F).

This suggests that switching to BRD4-S expression with cold preservation plausibly occurs in cardiomyocytes since changes in splicing factor abundance can influence relative isoform expression.

5. Efficient Knockdown of Cardiomyocyte-Specific BRD4 Isoforms using AAV9 Virus Containing miR30 Mediated shRNA. A miR30-based AAV9 Delivery System was Developed to Genetically Determine the Role of Cardiomyocyte-Specific BRD4 Isoforms in Modulating Cardiac Preservation Quality.

shRNA sequences targeting eGFP, the 3′ UTR of Brd4-S (shBrd4-S), specific C-terminal of Brd4-L (shBrd4-L), as well as common N-terminal of Brd4-S and Brd4-L (shBrd4-N) were cloned into the miR30 cassette of AAV9 vector which is driven by a cTnT promoter (FIG. 45A). 5×10¹¹ vg AAV9 virus was injected into the tail vein of 8-week-old mice. After four weeks, mice hearts were procured to quantitate the expression of Brd4 isoforms by qRT-PCR. It is shown that AAV9 virus containing miR30-mediated shRNA can specifically knockdown the mRNA expression of targeted Brd4 isoforms (FIGS. 45B, 45C, and 45D).

6. Cardiomyocyte-Specific Brd4-S Knockdown Improved Ex-Vivo Donor Heart Function after Prolonged Preservation.

Brd4-S knockdown greatly improved donor heart function after prolonged preservation (FIGS. 46A and 46B). Brd4-S knockdown also led to increased average conduction velocity and favored an organized rhythm. Electrical activation maps from these hearts showed a sequential activation pattern, beginning with a localized activation in one region followed by successive unidirectional spread to the remaining areas. In contrast, a disordered activation pattern was seen in control (enhanced-green fluorescent protein (eGFP) knockdown), total Brd4 knockdown and Brd4-L knockdown hearts (FIGS. 46C and 46D).

### 7. Higher Osmolality can Induce BRD4-S Upregulation.

While human donor hearts were in cold static storage, it was found that the osmolality of the preservation solution increased with progressively longer preservation times (FIG. 47A). Previous reports have shown that osmotic stress can induce alternative splicing events. The studies also show that a 100 mOsm increase in ambient osmolality was sufficient to induce BRD4-S upregulation in cardiomyocytes (FIGS. 47B, 47C, and 47D).

8. Continuous Perfusion with Cold HTK Solution Improves Ex-Vivo Murine Donor Heart Function after Prolonged Preservation.

Cold HTK perfusion for 16 hours significantly improved ex-vivo donor heart contractility and relaxation (FIGS. 48A and 48B). Interestingly, cold-perfused donor hearts had a significantly lower Brd4-S to Brd4-L protein ratio compared to cold static preservation (FIGS. 48C and 48D).

### 9. Brd4-S Knockdown Reduced Mitochondria Turnover During Cold Static Preservation.

The α-MHC MitoTimer mice have a cardiac-specific expression of mutated dsRed protein (dsRed1-E5) which is mitochondria-targeted. The baseline green color of the protein is converted to a red color when oxidized. The green signal represents the newly synthesized mitochondrial protein, while the red signal indicates older mitochondrial proteins. The aforementioned AAV9 viral constructs were administered to the α-MHC MitoTimer mice. Compared to freshly procured baseline hearts, a reduced red-to-green signal is noted in mice hearts with sheGFP (control), shBrd4-L and shBrd4-N suggesting increased mitochondrial turnover. Conversely, hearts with shBrd4-S had an increased red-to-green signal intensity comparable to hearts with sheGFP, indicating a reduced mitochondrial turnover (FIGS. 49A and 49B). This is consistent with prior reports showing that suppressing mitochondrial turnover protects against myocardial infarction.

### Description of Preservation and Reperfusion Methods in Aim 1

### A. Murine Donor Heart Isolation, Preservation and Ex-Vivo Perfusion.

The murine ex-vivo cardiac perfusion method had previously been published. Briefly, hearts are preserved with clinically utilized HTK solution infused into the aorta. After excision, the heart will be either immersed in a cold (0° C.) HTK bath or perfused with cold (6° C.) HTK at 0.01 mL/minutes or the indicated flow rate for 16 hours as the time threshold determined from prior experiments. Hearts are then recovered for analysis or ex-vivo perfusion. The dose-response relationships between preservation time and LV function were previously determined. It was found that functional impairment is marked at 16 hours of storage, but the heart remains reliably contractile with a sinus rhythm, as corroborated by other groups. After 30 minutes of perfusion, the function is assessed via a balloon inside the LV cavity. After 1 hour of reperfusion, donor hearts will be examined by electrical mapping systems (Mapping Lab, U.K.).

### B. Murine Heterotopic Heart Transplantation.

Donor hearts from transgenic mice on a C57BL/6J background are transplanted into the cervical region of gender-matched syngeneic wild-type C57BL/6J mice as recipients. The right external jugular vein and common carotid artery are divided, with the ends passed through a polyethylene cuff. The donor's pulmonary artery is pulled over the recipient's vein cuff. Anastomosis of donor's ascending aorta and the recipient's artery are similarly performed. The donor heart is reperfused and hemodynamics are assessed in-vivo after 24 hours using a conductance catheter placed inside the LV. The 24-hour time was chosen as there will still be functional deficits from ischemic injury. The heart is more pristine at this time, with minimal scarring or inflammation of local tissue, which may confound the analysis.

Aim 1.1. To Determine the Mechanism of BRD4-S Upregulation Associated with Increasing Cold Preservation Duration of Donor Hearts.

### 1.1.1. To Examine the Effects of Brd4 KO and Brd4 Isoforms in Donor Heart Preservation.

Inducible cardiomyocyte-specific Brd4^{-/-} mice (Myh6^{CreErt2}; Brd4^{f/f}) were already generated using Brd4^{f/f} mice. The AAV9 containing the coding sequence of eGFP, Brd4-S, and Brd4-L driven by cTnT promoter will be injected into Myh6^{CreErt2} Brd4^{f/f} mice, as was done before. After 4 weeks, tamoxifen will be injected into these mice to remove endogenous cardiomyocyte Brd4 resulting in mice expressing eGFP, Brd4-S and Brd4-L specific expression delivered through AAV9. These hearts will be preserved in a cold HTK for 16 hours and reperfused with an ex-vivo system or heterotopic transplantation (n=10/group). Ex-vivo hearts are perfused with Krebs electrolyte buffer which permits the study of native cardiac cellular responses, whereas syngeneic heterotopic transplantation incorporates recipient inflammatory cellular responses. For both ex-vivo reperfusion and transplant models, the following will be evaluated: 1) Cardiac function using a conductance catheter; 2) Cardiac conduction pattern using an electrical mapping system; 3) Brd4-S and Brd4-L expression; 4) Cell death (Terminal deoxynucleotidyl transferase dUTP nick end labeling (TUNEL) stains and western blot for cleaved Caspase-3, Bax, and Bcl-2 expression); 5) Mitochondrial turnover by quantifying TFAM, PGC-1α and Drp1 protein expression. For murine heart transplants, 1) Leukocyte infiltration by staining for leukocytes (CD45⁺), macrophages (F4/80⁺), T cells (CD3⁺), B cells (CD19⁺); 2) Circulating markers of cardiac injury (Troponin I, mitochondrial DNA) will also be assessed.

### 1.1.2. To Determine the Mechanism of Brd4-S Upregulation Induced by Hyperosmotic Stress in Cultured Cardiomyocytes and Donor Hearts.

With-No-Lysine (K)) (WNK) kinases are proteins that can sense ambient osmolality and can also modulate splicing factor expression. The neonatal murine cardiomyocytes (NMCMs) will be isolated, as was done previously. WNK activation/phosphorylation in NMCMs exposed to hyperosmotic stress induced by sorbitol during cold preservation (bathed in HTK) will also be examined for. This will be correlated with the expression of splicing factors found to be reduced in human hearts as described in the preliminary results. To test if hyper-osmosis induced Brd4-S upregulation is mediated by these regulatory cascades, adenovirus packaged shRNA targeting WNK or splicing factors (e.g., RBFOX2) will be used to overexpress or knockdown these proteins in cultured cardiomyocytes. Their effects on Brd4 isoform expression at the transcript and protein level will then be determined. Based on in-vitro study results, the relevance of the WNK pathway for Brd4 isoform expression in vivo will be examined. The AAV system will be used to up or downregulate WNK and splicing factor expression in murine donor hearts. These hearts will then be cold static preserved for 16 hours followed by quantification of Brd4 isoform expression.

Aim 1.2 to Determine if Continuous Cold Perfusion with HTK Improves Donor Heart Function Through Reducing BRD4-S Isoform Expression.

### 1.2.1. To Determine if Cold HTK Perfusion Flow Rate Modulates Brd4-S Expression Levels and Donor Heart Preservation Quality.

A murine heart hypothermic perfusion model for preservation has been developed as outlined in FIG. 9. This has enabled the scaling of the studies to test the effect of different cold cardiac perfusion conditions. Donor hearts from 12-week-old C57/B6 mice are cold perfused with HTK at different flow rates including 0.005 mL/minute, 0.01 mL/minute, 0.02 mL/minute, 0.04 ml/minute and 0.08 ml/minute (n=10/group). The prior studies used an HTK perfusion rate of 0.01 ml/minute, which was associated with reduced Brd4-S expression and better cardiac function. However, it is unclear if different perfusion rates would also modulate the expression of Brd4-S or better impact donor heart function. After 16 hours of perfusion, hearts are collected to determine the level of Brd4-S versus Brd4-L expression at the transcript and protein levels. Separate studies will also be performed where hearts undergo ex-vivo perfusion to determine the impact of different cold perfusion flow rates on cardiac function (n=10/group) and this will be correlated with Brd4 isoform expression. Once optimal cold perfusion flow rate associated with optimal ex-vivo cardiac graft function has been identified, this cold perfusion protocol will be used to perform syngeneic murine heterotopic heart transplants (n=10/group) to confirm efficacy with the incorporation of recipient cellular responses. Cardiac hemodynamics, cardiac electrical conduction, cell death, and mitochondrial turnover will be studied as described in 1.1.1.

### 1.2.2. To Determine if Brd4-S Downregulation is Required for the Cardiac Protective Effect of Cold-Perfused Preservation of Donor Heart.

The optimized cold HTK perfusion rate that is associated with the highest magnitude of Brd4-S decrease and cardiac functional improvement as determined in aim 1.2.1 will be used. AAV9-mediated expression of Brd4-S and eGFP control driven by cTnT promoters will be utilized, as before, to generate cardiac-specific Brd4-S and GFP overexpressing mice. Donor hearts are procured four weeks after AAV9 injection to undergo cold perfusion at an optimized flow rate for 16 hours and then reperfused with an ex-vivo system or heterotopic transplantation (n=10/group). Cardiac hemodynamics, cardiac electrical conduction, cell death, and mitochondrial turnover will be assessed as described in 1.1.1.

### Aim 2. To Define the Modifications in Genome Architecture Induced by BRD4 Isoforms During Donor Heart Preservation (FIG. 40B).

Rationale: Brd4 is known to play a key role in the pathogenesis of cardiac diseases through epigenetic regulation. Brd4-S competes with Brd4-L for acetyl histone binding and regulates the epigenetic landscape mediating tumor growth, DNA damage, and mitophagy. Importantly, the bromodomains in Brd4-S and Brd4-L interact with acetyl histones to promote phase separation. Moreover, Brd4 condensate formation in tumor cells is mainly driven by Brd4-S and not by Brd4-L. It is recognized that protein organization into condensates enables rapid response to environmental stressors. The preliminary results show that under significant stresses induced by preservation conditions, Brd4-S recruits several transcriptional and epigenetic cofactors. Furthermore, Brd4 isoforms were observed to undergo phase separation and condensate formation during cold preservation of human donor hearts. It is therefore proposed that Brd4-S reorganizes the chromatin architecture during preservation to prime a transcriptome pattern that tends to impair cardiac function. While several key histone-modifying proteins have been identified that bind to Brd4 based on literature search, Aim 2.1 will use an unsupervised mass spectrometry screen to identify a more comprehensive representation of the Brd4 interactome. Genetic models of Brd4 isoform expression or knockdown both in-vivo and in-vitro will be used to identify the role of Brd4 phase separation on cofactor recruitment. This will provide mechanistic insight into the role of chromatin architectural patterns on donor heart preservation quality. Aim 2.2 aims to examine the highly likely possibility that genome architecture and accessibility dictates the ischemic tolerance of donor hearts based on transcriptional accessibility to cardioprotective mediators and concealment of genes with harmful effects. Preliminary findings that support this hypothesis include: 1) The preliminary studies showed that Brd4-S is upregulated during cold storage preservation, and Brd4-S increased interactions with epigenetic modifiers (e.g., G9a, NIBPL). 2) Genomic colocalization of Brd4 with H3K9me3 sites suggests G9α-mediated methylation at this site to modulate gene expression. There is also the intriguing possibility that the impressive cardioprotective effect of cold-perfusion preservation can be mediated through reduced Brd4-S expression for a given preservation duration compared with cold static preservation. It is possible that by recapitulating the molecular events mediated through cold perfusion, therapeutics can be developed to improve cardiac preservation quality.

### Preliminary Data

1. Increasing Cardiac Preservation Duration is Associated with Increased BRD4-S Condensate Formation Accompanied by Broader Nuclear Distribution.
At baseline, BRD4-S condensates were perinuclear while BRD4-L condensates were widely distributed across the nuclei. After 10 hours of cold static storage, there was a significant increase in BRD4-S puncta formation that is observed to be broadly distributed in the nucleus, while the number of BRD4-L condensates decreased (FIGS. 50A-50C).
2. BRD4-S Recruits Specific Epigenetic Cofactors which are Associated with a Distinct Pattern of Histone. BRD4-S had Greater Interactions with G9a (a Lysine Methyltransferase) and NIBPL (a Major Subunit of the Cohesin Loading Complex) Compared to BRD4-L (FIGS. 51A and 51B) Thus Showing Differential Recruitment of Epigenetic Regulators.

Consistent with increased interactions between G9a and BRD4-S, H3K9 trimethylation (H3K9me3) showed increased interaction with BRD4-S (FIGS. 51A and 51B). These findings, combined with known roles for Brd4 in gene suppression and genome folding suggest the possibility that BRD4-S could selectively recruit specific co-regulators to govern histone modification and chromatin architecture during cardiac preservation.

### 3. Cold Static Storage of Human Donor Hearts Alters BRD4 Chromatin Targeting on H3K9Me3 but not H3K27Ac Regions.

To determine the effects of cold static storage on BRD4 binding to DNA targets, total BRD4 antibodies were used to perform CUT&RUN (cleavage under targets and release using nuclease) experiments using human LV at baseline and after 10 hours of cold storage. Interestingly, cold preservation altered the landscape of BRD4 chromatin binding on H3K9me3 sites but not H3K27ac sites (site information is obtained from Encode database) (FIG. 52). Given that cold preservation upregulates BRD4-S, and BRD4-S selectively recruits the lysine methyltransferase G9a, this suggests that BRD4-S can mediate H3K9 methylation through G9a. This highlights a likely mechanism for the differential effects of BRD4 isoforms on chromatin remodeling during cold cardiac preservation.

### Aim 2.1. To Determine if Brd4 Isoform Regulates its Co-Factors Via Phase Separation.

### 2.1.1. To Define the Co-Factors for Brd4-S and Brd4-L During Preservation.

AAV9-mediated cardiomyocyte-specific Brd4-S or Brd4-L expression will be performed in murine Brd4^{-/-} donor hearts as previously described in 1.1.1. These hearts will be cold preserved for 16 hours followed by ex-vivo perfusion for 1 hour. Co-IP (co-immunoprecipitation) will be performed on the LV using Brd4 or Flag antibody. To identify the cofactors of Brd4-S and Brd4-L, the eluded co-IP proteins will then be subjected to Mass spectrometry analysis.

### 2.1.2. To Examine if Differential Cofactor Recruitment to Brd4 Due to Brd4-S Phase Separation and Condensate Formation in Cardiomyocytes.

Double staining will be used to determine if the cofactors identified by mass spectrometry in 2.1.1 colocalize with Brd4-S in condensates identified during donor heart preservation. Protein colocalization in-vivo however does not establish the dynamic nature of molecular phase separation. To convincingly demonstrate phase separation of Brd4-S and its recruited cofactors, GFP-Brd4-S and mCherry-tagged cofactors will be overexpressed in cells. Fluorescence recovery after photobleaching (FRAP) will be used to visualize phase separation in the co-localized foci within living cultured cells. FRAP is where a laser is used to bleach fluorescent condensates. If dynamic phase separation is present, there will be subsequent recovery of fluorescence as surrounding fluorescent proteins are recruited back into the cluster.

While it is expected to identify novel cofactors from mass spectrometry studies in aim 2.1.1., the preliminary studies have already identified G9a and NIBPL as likely candidates. To promote Brd4 phase separation, adenovirus will be used to mediate overexpression of GFP-Brd4-S in tamoxifen-inducible cardiomyocyte-specific Brd4^{-/-} neonatal murine cardiomyocytes (NMCMs) isolated from Myh6^{CreErt2}; Brd4^{f/f} pups as was done before. For scientific rigor, it will be determined whether fusion with GFP impacts Brd4 recruitment of identified cofactors of interest. This is done by comparing cofactor binding to GFP-Brd4 versus Brd4 alone using co-IP with WB characterization. To determine if Brd4-S phase separation influences Brd4-L condensate formation, the abundance of Brd4-L condensates under the conditions described above will be examined.

### Aim 2.2. To Determine Whether Preferential Brd4-S Expression and Condensate Formation During Donor Heart Preservation Induce Specific Genomic Architectural Configurations.

### 2.2.1. To Define the Genomic Targets Shaped by Relative Brd4-S and Brd4-L Expression During Donor Heart Preservation.

AAV9 delivering cardiac-specific shRNA targeting eGFP transgenic control will be generated as well as shRNA-Brd4-S and shRNA-Brd4-L for isoform-specific knockdown in wild-type mice as outlined in the preliminary results (FIG. 6). Donor hearts will be stored in cold static HTK for 16 hours followed by 1 hour of ex-vivo perfusion. RNA-seq will be performed using isolated LV tissue to compare the transcriptome amongst the 3 groups of genetically modified hearts. The LV tissues from eGFP control and Brd4-S and Brd4-L knockdown hearts will be examined using CUT&RUN-Seq with Brd4-S and Brd4-L specific antibodies. Key Brd4-S and Brd4-L targets will be identified by corroborating the chromatin binding targets and DEGs from Brd4 isoform-specific knockdown studies.

### 2.2.2. To Determine the Specific Effects of Brd4-S and Brd4-L on Chromatin Structural Remodeling During Donor Heart Cold Static Preservation.

Mice will be generated with donor hearts that underwent cardiomyocyte-specific knockdown of eGFP control, Brd4-S or Brd4-L, using AAV9 delivery of miR30 mediated shRNA in wild-type mice as described above. Hearts will be preserved in cold static HTK solution for 16 hours, followed by ex-vivo perfusion for 1 hour. To determine the contribution of Brd4 isoforms to chromatin remodeling during donor heart preservation CUT&RUN-seq experiments will be performed comparing the LV tissue at baseline versus 16 hours of preservation with antibodies against NIBPL, G9a, and H3K9me3 as well as any other co-factors of interest identified in 2.1.1. Assay for Transposase-Accessible Chromatin (ATAC)-sequencing will also be used to determine chromatin accessibility in these hearts under the 3 described conditions. By comparing the chromatin co-occupancy of Brd4-S or Brd4-L with respective cofactors known to colocalize to Brd4 condensates, their respective binding to open chromatin states will be associated. This will enhance the understanding of how the chromatin accessibility landscapes shaped by Brd4 isoforms correlate with and likely affect donor heart preservation quality. Additionally, Hi-C studies will be performed to examine the changes in chromosomal architecture induced by cold static preservation. This is performed by genome-wide proximity cross-linkage with formaldehyde followed by DNA fragment ligation and sequencing to identify alterations in chromatin looping and defined topologically associated domains (TAD). By combining the genome co-occupancy results of specific Brd4 isoforms and NIBPL (a subunit of the cohesion loading protein), the specific Brd4 isoform-induced chromatin looping events during donor heart preservation can be identified. This will permit the definition of chromatin structures and gene accessibility patterns that are favorable versus deleterious for donor hearts during cold preservation.

2.2.3. To Determine the Chromatin Architecture of Donor Hearts with Cold-Perfused Preservation.

The murine donor hearts will be preserved with cold continuous HTK perfusion at an optimized flow rate as described in preliminary results (FIG. 9). After 16 hours of cold perfusion, hearts will be ex-vivo perfused for 1 hour with functional assessment as was done previously. ATAC-seq and HiC-seq will be performed using hearts at baseline and 16 hours of cold perfusion-preserved hearts to determine the effect of cold perfusion preservation on chromatin architecture as outlined in 2.2.2.

Aim 3. To Determine if Drug Inhibition of Brd4 Improves the Preservation Quality of Pig and Human Hearts Using Cold Perfusion. This Will Yield Key Supporting Data for the Clinical Applicability of the Findings (FIG. 40C).

Rationale for determining the efficacy of Brd4 antagonism in pig and human hearts: JQ1 is the first Brd4 antagonist from which many analogues have been developed and evaluated in cancer clinical trials. Given the ongoing clinical evaluation of Brd4 inhibitors, the goal is to corroborate the murine findings with large animal/human hearts to confirm clinical relevance. Pigs are used since their size and anatomy are very similar to humans. Healthy pig hearts are readily available, and matching can be performed for age, gender and size. Evaluating the efficacy of JQ1 for improving human heart preservation will provide valuable data that is directly clinically relevant. It is important to note that the results show JQ1 preferentially colocalizes with the Brd4-S isoform (FIG. 4). It is recognized that human hearts made available for research likely have unfavorable features (e.g., older age, cardiac hypertrophy) thus precluding clinical transplantation. However, obtaining human proof-of-concept results is essential for understanding clinical cardiac responses to Brd4 antagonism.

### Preliminary Data

1. Cold (4° C.) Perfusion with HTK for Preservation Greatly Improves Donor Heart Function Compared to Cold Static Preservation.

Given current advances in cardiac preservation technology towards cold perfusion, the studies of molecular therapies have been moved to this context. It was confirmed that cold perfusion with HTK greatly improved cardiac preservation quality. Cold preservation on ice for hours leads to severe donor heart dysfunction as expected. Through time course studies, 18 hours of cold HTK perfusion has been identified as an ideal time point for observing potential improvements through therapeutic intervention. At a very long cold cardiac perfusion time of 18 hours, the function is better than static cold preservation for just 10 hours (FIGS. 14A-14D).

### 2. Cold Perfusion Preservation of Pig Donor Hearts Reduced the Upregulation of Brd4-S Observed in Cold Static Storage.

Brd4-S and Brd4-L expression in reperfused pig donor hearts was examined after 4 hours or 10 hours of cold static storage or 18 hours of cold perfusion storage by WB. Consistent with findings in murine hearts, Brd4-S was significantly increased in the pig hearts with prolonged cold static storage.

However, cold perfusion significantly reduced Brd4-S upregulation. Cold perfusion preservation had a significantly lower Brd4-S/Brd4-L protein ratio compared with prolonged cold static storage (FIGS. 54A-54B).

3. Initial Data Suggests that JQ1 Treatment May Improve Donor Heart Function after 18 Hours of Cold Perfusion Preservation.

Pig donor hearts were treated with JQ1 (5 μM, n=2/group) and preserved with the cold perfusion protocol for 18 hours followed by normothermic ex-vivo perfusion with donor blood. Comparing cold perfusion only vs. cold perfusion+JQ1, addition of JQ1 increased contractility (max dP/dt, 1010 vs. 1704 mmHg/s), improved relaxation (minutes dP/dt, −701 vs. −1284 mmHg/s), increased cardiac output (0.47 vs. 0.69 ml/minutes/g), and increased coronary flow (0.33 vs. 0.43 L/min). While encouraging, more studies for statistical analysis are needed to validate the initial impressions (FIGS. 55A-55D).

### Description of Surgical Techniques and Protocols Used in Aim 3

### A. Porcine Donor Heart Isolation, Preservation and Ex-Vivo Perfusion.

A large animal ex-vivo heart perfusion system is owned and readily available Blood (1 liter) for ex-vivo perfusion is collected during cardiac procurement from 40-50 kg Yorkshire pigs. The ascending aorta is clamped then cold 4° C. HTK solution (1 liter, without drugs added) is infused into the aortic root at 80 mmHg to stop the heart. The heart is excised and a further 2 liters of HTK solution only, or HTK solution+JQ1 (5 μM) is infused at the back table in order to avoid exposure of other transplantable organs (e.g., lungs, liver) to study drugs in a procedure mimicking a clinical trial. The heart will then be immersed in cold (6° C.) HTK bath and perfused with cold (6° C.) HTK at 10 mmHg for 18 hours as the time threshold determined from the prior experiments. Prior studies have identified the optimal temperature for cardiac preservation without ice formation at around 6° C. Cold perfusate samples are collected at the beginning and at completion (18 h) of cold perfusion. Afterward, hearts are retrieved for ex-vivo perfusion for 3 hours with donor blood. Hemodynamics are assessed using a conductance catheter in a load-independent “rest” mode and a load-dependent “working” mode by loading the left atrium at 6-mmHg as is done routinely in the lab. Blood samples are collected from the arterial perfusate and coronary sinus for analysis. Arterial and venous pO2 are measured hourly. Electrolytes (K, Na, Ca) and pH are maintained in normal range by providing insulin, glucose, CaCl₂), and HCO3.

### B. Human Donor Heart Isolation, Preservation and Ex-Vivo Perfusion.

Human research hearts that are not used for clinical transplantation have been received from the “LifeSource” organ procurement facility (support letter provided). This is located within St. Mary Hospital (Mayo Clinic) with no additional travel needed from the laboratory. Donor hearts are procured using standard clinical protocols. Hearts available for research are not transplanted due to concerns such as advanced age, hypertrophy, and coronary disease. Study inclusion criteria are >50% LV ejection fraction, coronary disease involving <1 vessel, and age >18 years or <70 years. About 25 hearts/year meeting these criteria can be accessed. Cardiac procurement is performed by two organ procurement surgeons at the Mayo Clinic.

### Aim 3.1 Examining the Efficacy of JQ1 in Improving Porcine Donor Heart Function Using Cold Perfusion Preservation:

Donor hearts will be cold perfused with HTK for 10 hours and 18 hours after treatment with JQ1 versus vehicle control and ex-vivo hemodynamics (e.g., dP/dt, cardiac output LV pressure) will be compared following reanimation. A 10-hour perfusion time is used to establish a clinically relevant time point for future trials. Each comparison group will have 8-10 donor hearts based on previously outlined statistics. LV samples obtained after perfusion for 3 hours will be assessed for cell death, inflammatory mediator expression, antioxidant protein expression, and leukocyte infiltration as outlined in aim 1.1.1. Ex-vivo circuit arterial perfusate and coronary sinus drainage will be analyzed for inflammation (e.g., IL-6, TNF-α, IL-lp)), cardiac injury (e.g., troponin I, mitochondrial DNA), and lactate levels. Cold preservation perfusate will be sampled at 0 and 18 hours to measure lactate, troponin and mitochondrial DNA levels which are correlated with ensuing cardiac performance.

### Aim 3.2 Determine the Efficacy of JQ1 in Improving Human Donor Heart Function Using Cold Perfusion Preservation:

Hemodynamic evaluation and biochemical analysis of human donor hearts (n=8-10) will be completed as outlined in aim 3.1 following treatment with HTK only versus HTK+JQ1. Due to the scarcity of human hearts, only the 18 hours of cold perfusion for both groups will be tested (HTK+JQ1 versus HTK control, n=6/group). Therapeutic drug dosages in adult pigs are expected to be similar to adult humans so the same dosage of JQ1 (5 DM) will be used.

### Aim 3.3 Determine the Transcriptomic Response and Chromatin Accessibility Changes of Human Hearts to Brd4 Inhibition Using Single-Nuclei RNA Sequencing as Well as ATAC-Seq and CUT&RUN Assay.

Single-nuclei RNA sequencing (snRNA-seq), ATAC-Seq, CUT&RUN-seq and Hi-C will be performed on human hearts that are 1) cold perfused for 18 hours under 2 separate conditions as follows (n=6/group): Preserved with HTK only versus HTK+JQ1; 2) Using tissues obtained from the same heart at different timepoints: At baseline immediately after cardiac procurement, at end of 18-hours cold perfusion preservation (without reperfusion), and after 3-hours of ex-vivo blood reperfusion. This will assess chromosomal rearrangements and modifications induced by cold perfusion and reperfusion. Single-nuclei transcriptomics of the human left ventricle will: 1) Determine if there are differential human cardiac cell responses during the process of cold perfusion preservation and following reperfusion; 2) Define the cell type that JQ1 acts upon to reduce harmful gene expression; 3) Define the dynamics of Brd4 isoform switch that occurs in human hearts during cold perfused preservation and reanimation. A small LV biopsy is obtained immediately after cardiac procurement (0 hour) and after 18 hours of cold perfusion preservation. Subsequently, the same heart is ex-vivo perfused for 3 hours and then the LV is biopsied again. snRNA-seq is carried out using single nucleus isolation via gradient centrifuge followed by bar-coding with the 10× Genomic platform. A snRNA-seq library prep is generated and sequenced with Illumina Novaseq 6000 at a depth of 50k reads/cell. Of particular interest are pathways involved in inflammation, cell death, mitochondrial turnover, and oxidative stress. To determine overall chromatin accessibility, single-nuclei ATAC-Seq will be performed using nucleus isolation and then using the Tn5 Transposase to insert sequencing adapters into open regions of the genome. This process of “tagmentation”, occurs by DNA cleavage followed by tagging with sequencing adaptors. These tagged DNA fragments are amplified and sequenced using next-generation sequencing. CUT&RUN, using antibodies selective for Brd4-S and -L isoforms, are used to mediate DNA cleavage by micrococcal nuclease at Brd4 binding sites. DNA binding sites for Brd4 are identified using massively parallel DNA sequencing. Hi-C will be performed as previously described in aim 2.2.2.

### Example 4: Cold Perfused Pig Heart Shows Improved Cardiac Function When Treated

The pig donor hearts were first flushed with 2 L of HTK, HTK with Canrenone (50 mM), HTK with JQ1 (5 mM), then preserved with continuous cold HTK perfusion for 18 hours followed by normothermic ex-vivo perfusion with donor blood. Comparing cold perfusion only vs. cold perfusion+Canr or cold perfusion+JQ1, the addition of Canrenone or JQ1 in initiate preservation step increased contractility improved relaxation, increased cardiac output and increased coronary flow.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for extending the viable preservation of a donor organ, the method comprising:
perfusing a donor organ with a first solution comprising one or more of a mineralocorticoid receptor antagonist (MRA) and a Brd4-targeting compound; and
perfusing the donor organ with a second solution for an amount of time prior to transplant to a recipient subject.

2. The method of claim 1, wherein the donor organ is one or more of a heart, a lung, a liver, a pancreas, a kidney, an intestine, an artery, a vein, or composite tissue.

3. The method of claim 2, wherein the donor organ is a heart.

4. The method of claim 1, wherein the MRA is one or more of spironolactone, canrenone, eplerenone, finerenone, esaxerenone, and balcinrenone.

5. The method of claim 1, wherein the MRA is canrenone.

6. The method of claim 1, wherein the Brd4-targeting compound is one or more of JQ1, apabetalone, AZD5153, ARV-825, and RNK05047.

7. The method of claim 6, wherein the Brd4-targeting compound is JQ1.

8. The method of claim 1, wherein the first solution comprises HTK perfusate and the one or more MRA and the Brd4-targeting compound.

9. The method of claim 1, wherein the second solution comprises HTK perfusate.

10. The method of claim 1, wherein the amount of time is about 0.5-48 hours.

11. A method of preserving a donor organ, the method comprising:
combining one or more of a mineralocorticoid receptor antagonist (MRA) and a Brd4-targeting compound with HTK solution to generate a first solution;
perfusing the donor organ with the first solution using cold perfusion techniques at a temperature of about 2° C. to about 15° C.;
perfusing the donor organ with a second solution, wherein the donor organ is continuously perfused with the second solution for an amount of time prior to transplant to a recipient subject; and
preparing the donor organ for transplantation to the recipient subject.

12. The method of claim 11, wherein the donor organ is one or more of a heart, a lung, a liver, a pancreas, a kidney, an intestine, an artery, a vein, or composite tissue.

13. The method of claim 11, wherein the MRA is one or more of spironolactone, canrenone, eplerenone, finerenone, esaxerenone, and balcinrenone.

14. The method of claim 11, wherein the Brd4-targeting compound is one or more of JQ1, apabetalone, AZD5153, ARV-825 and RNK05047.

15. The method of claim 11, wherein
the second solution is HTK perfusate, and
the one or more MRA and Brd4-targeting compound are combined with the HTK solution in a concentration of about 0.5 μM to about 300 μM.

16. A method of extending donor organ viability for transplantation to a recipient subject, the method comprising:
positioning a donor organ in a receptacle comprising a first solution comprising one or more of a mineralocorticoid receptor antagonist (MRA) and a Brd4-targeting compound;
perfusing the donor organ with the first solution for a first amount of time;
removing the first solution from the donor organ;
contacting the donor organ with a second solution for a second amount of time; and
preparing the donor organ for transplantation to the recipient subject after the second amount of time.

17. The method of claim 16, wherein the donor organ is one or more of a heart, a lung, a liver, a pancreas, a kidney, an intestine, an artery, a vein, or composite tissue.

18. The method of claim 17, wherein the IRA is one or more of spironolactone, canrenone, eplerenone, finerenone, esaxerenone, and balcinrenone.

19. The method of claim 17, wherein the Brd4-targeting compound is one or more of JQ1, apabetalone, AZD5153, ARV-825 and RNK05047.

20. The method of claim 16, wherein
the second solution is HTK perfusate,
the first amount of time is about 5-30 minutes, and
the second amount of time is about 0.5-48 hours.
